(19) United States
(12) Patent Application Publication
(10) Pub. No.: US 2010/0195712 A1
(43) Pub. Date: Aug. 5, 2010

(54) RESPONSE TO ATSC MOBILE/HANDHELD RFP A-VSB MCAST AND PHYSICAL LAYERS FOR ATSC-M/HH

(75) Inventors: Jung-Pil Yu, Suwon-si (KR); Hae-Joo Jeong, Seoul (KR); Joon-Soo Kim, Seoul (KR); Chan-Sub Park, Incheon (KR); Jung-Jin Kim, Seoul (KR); Yong-Sik Kwon, Seoul (KR); Eui-Jun Park, Seoul (KR); Kum-Ran Ji, Seoul (KR); Jong-Hun Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/666,908

(22) PCT Filed: Jun. 30, 2008
(86) PCT No.: PCT/IB08/01715

§ 371 Date: Dec. 28, 2009

Related U.S. Application Data
(60) Provisional application No. 60/946,851, filed on Jun. 28, 2007.
(60) Provisional application No. 60/948,234, filed on Jul. 6, 2007.

(51) Int. Cl. H04N 7/12

(52) U.S. Cl. 375/240.01; 375/E07.026

(57) ABSTRACT

The Mobile Broadcasting (A-VSB MCAST) design consists of transport and signaling opt imized for mobile and handheld services. Section 5 provides the overall A-VSB MCAST architecture. Section 6 specifies the physical and link layers. Section 7 specifies the trans port layer. And, Section 8 describes the frame slicing mechanism for burst transmission. Backwards compatibility is ensured by the careful design of the physical and link layers.

Field tests are well underway now, being overseen by ATSC TSG/S9.

### CROSS REFERENCE TO RELATED APPLICATIONS

This application is a National Stage of International Application No. PCT/IB2008/001715 filed Jun. 30, 2008 which claims priority to U.S. Provisional Patent Application No. 60/946,851 filed on Jun. 28, 2007, and U.S. Provisional Patent Application No. 60/948,234 filed on Jul. 6, 2007, in the United States Patent and Trademark Office, the disclosures of all of which are incorporated herein in their entirety by reference.

### BRIEF DESCRIPTION OF THE DRAWINGS

FIG. 1. Overall Architecture

FIG. 2. A-VSB System Architecture

FIG. 3. Deterministic and Non-deterministic Framing

FIG. 4. A-VSB Multiplexer and Exciter

FIG. 5. VFIP Packet Location in the Frame

FIG. 6. Byte-splitter and (12) TCM encoders.

FIG. 7. TCM Encoder with Deterministic Trellis Reset

FIG. 8 Packet Segmentation with Adaptation Field

FIG. 9 Packet Segmentation without Adaptation Field

FIG. 10 Packet Segmentation by Sectors

FIG. 11 Data Mapping Representation

FIG. 12 Data Mapping Example 1

FIG. 13 Data Mapping Example 2

FIG. 14 Data Mapping with SRS

FIG. 15. SRS featured ATSC Transmitter

FIG. 16. VSB Frame

FIG. 17. ATSC A-VSB Mulitplexor for SRS

FIG. 18. Normal TS Packet Sequence

FIG. 19. Normal TS packet Syntax with Adaptation Field

FIG. 20. SRS-placeholder-carrying TS Packet

FIG. 21. Transport Stream at A-VSB Transmission Adaptor Output

FIG. 22. VSB Sliver of DF Template for SRS

FIG. 23. SRS Stuffer

FIG. 24. MPEG Data Stream Carrying SRS Bytes.

FIG. 25. TCM Encoder Block with Parity Correction

FIG. 26 Advanced SRS Mapping in Track

FIG. 27 A-VSB Frame with Advanced SRS

FIG. 28 Advance SRS and Reserved Bytes for RS parity correction

FIG. 29. Functional Encoding Structure for Turbo Stream

FIG. 30 A-VSB Transmitter for Turbo Stream

FIG. 31 A-VSB Multiplexer

FIG. 32. Output of Transmission Adaptor in 1 package

FIG. 33. Turbo Stream Mapping into a Track

FIG. 34. MCAST Stream from MCAST Service Multiplexer

FIG. 35 Turbo Pre-processor

FIG. 36 Time interleaver

FIG. 37 Outer Encoding on a Byte Basis (L depends on the Turbo Stream mode)

FIG. 38. Outer Encoder

FIG. 39. 2/3-rate Encoding in Outer Encoder

FIG. 40. 1/2-rate Encoding in Outer Encoder

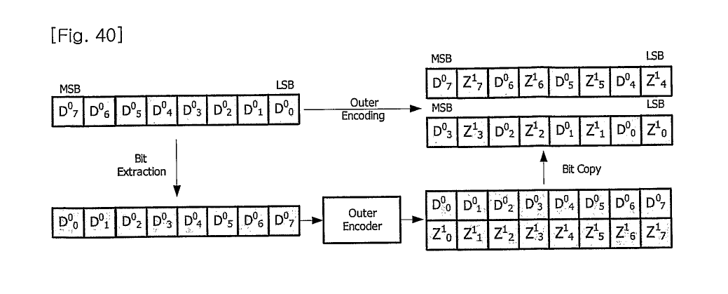

FIG. 41. 1/3-rate Encoding in Outer Encoder

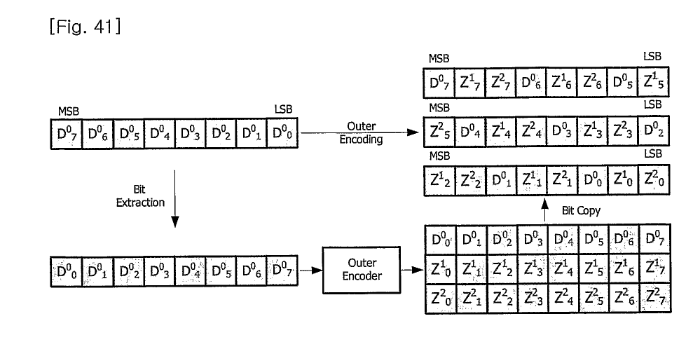

FIG. 42 1/4-rate Encoding in Outer Encoder

FIG. 43. Interleaving Rule 4 (2, 1, 3, 0)

FIG. 44 Multi-stream Data De-interleaver

FIG. 45. Turbo Stream Transmission Combined with SRS

FIG. 46 Multi-stream Data De-interleaver in New Transmission Mode

FIG. 47 Consecutive 104 Packet Position in VSB parcel

FIG. 48 Consecutive 104 Packet Bytes Spread in Field

FIG. 49 Field Sync at Even Field

FIG. 50 Field Sync at Odd Field

FIG. 51 Signaling bit structure for A-VSB

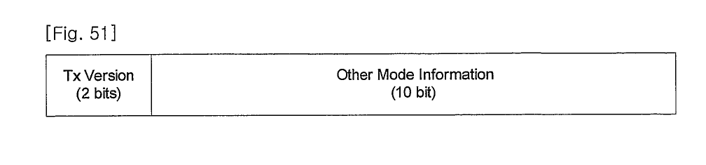

FIG. 52 Signaling bit structure for A-VSB at Tx Version 0

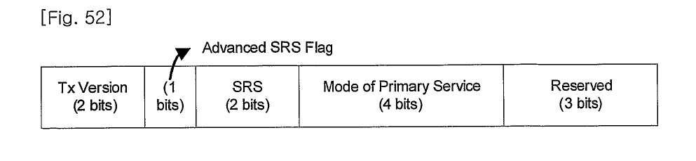

FIG. 53 Signaling bit structure for A-VSB at Tx Version 1

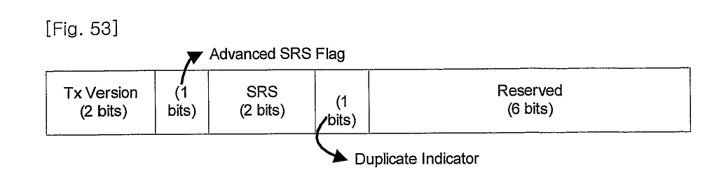

FIG. 54 Error Correction Coding for DFS

FIG. 55 Reed-Solomon (6,4) t=1 parity generator polynomial.

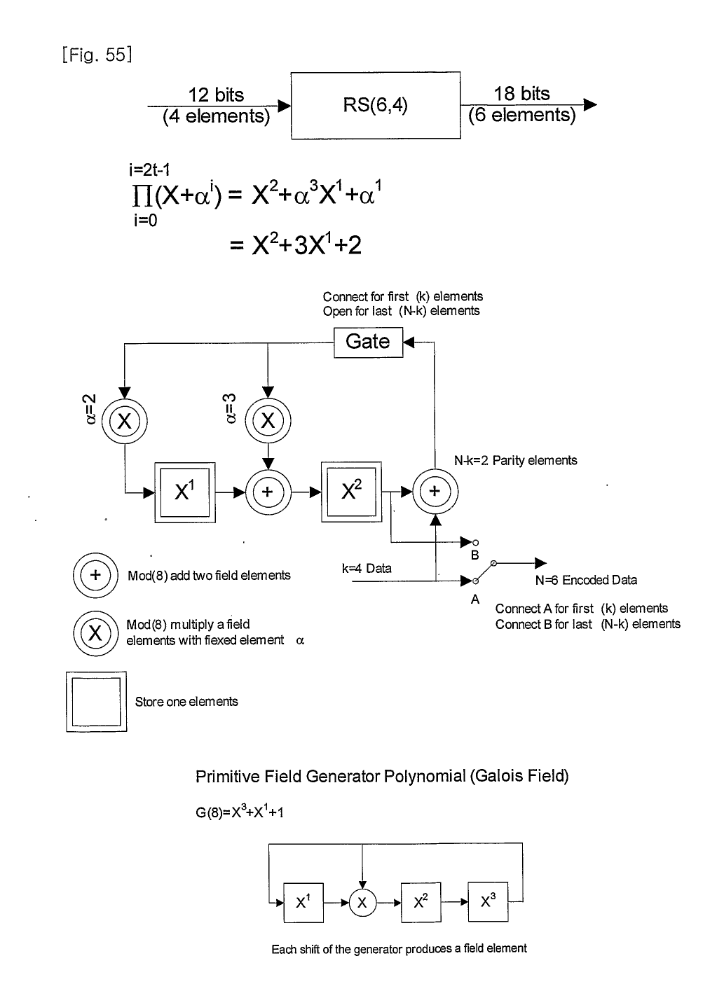

FIG. 56 1/7 rate Tail Biting Convolutional Encoder {37, 27, 25, 27, 33, 35, 37} octal number

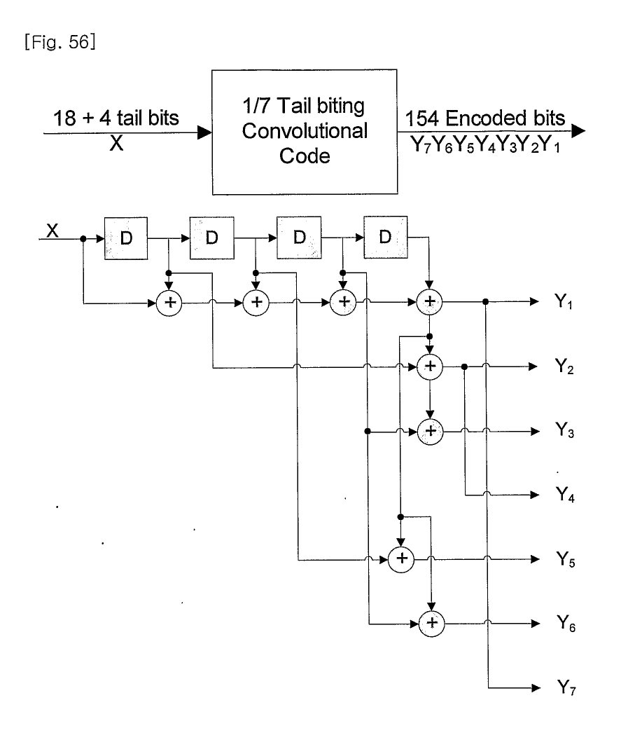

FIG. 57 Insertion of Signaling Information into DFS

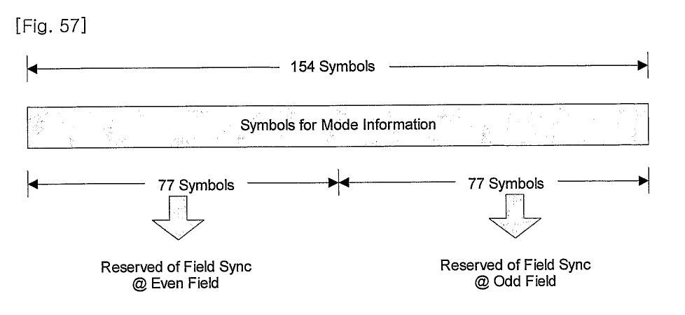

FIG. 58. Single Frequency Network (SFN)

FIG. 59. VFIP over Distribution Network

FIG. 60. VFIP SFN

FIG. 61. DTR Byte positions in ATSC interleaver

FIG. 62. Common Temporal Reference

FIG. 63. SFN Timing Diagram

FIG. 64. VFIP Error Detection and Correction

FIG. 65. Translators Supported in SFN

FIG. 66. MCAST Protocol Stack

FIG. 67. Comparison of Service Access Times

FIG. 68. Decoder Configuration Information

FIG. 69. Position of Turbo Channel in Frame

FIG. 70. Position and Structure Information of the LMT within an MCAST Parcel

FIG. 71. Position and Structure Information of the LIT within an MCAST Parcel

FIG. 72. Relationship Between Encapsulation Packet and Transport Packet

FIG. 73. Encapsulation Packet Structure for Signaling

FIG. 74. Structure for Encapsulation Packet of Real Time Data

FIG. 75. IP Encapsulation Packet

FIG. 76. Structure for Encapsulation Packet of Object Data

FIG. 77. Object Delivery Mode

FIG. 78. Base Header Field of the Transport Packet

FIG. 79. Padding Field of the Transport Packet

FIG. 80. LMT Field of the Transport Packet

FIG. 81. LIT Field of the Transport Packet

FIG. 82. Overall Concept of MCAST Frame Slicing

FIG. 83. Sector Distribution in Continuous Mode

FIG. 84. How Sector Distribution in Continuous Mode is Transmitted in Burst Mode

FIG. 85. Graph representing the Generator Matrix

FIG. 86. Support of scalable video coding & FEC

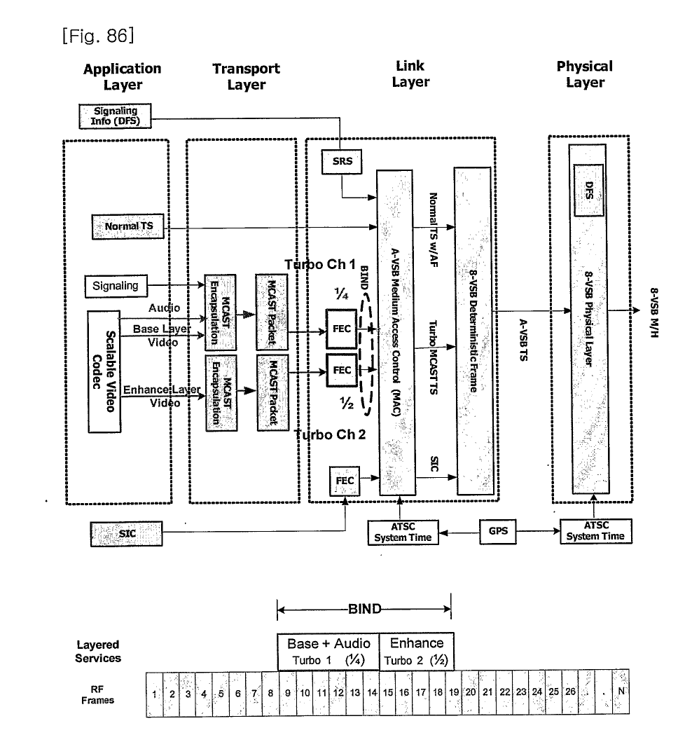

FIG. 87. Envisioned Future Statistical Multiplexing Functionality

FIG. 88. Adaptive Time Slicing

FIG. 89. Service Acquisition Flow

FIG. 90. Flow Diagram of LMT and LIT Procedure

FIG. 91. A-VSB System Architecture

FIG. 92. Deterministic and Non-deterministic Framing

FIG. 93. A-VSB Multiplexer and Exciter

FIG. 94. DF OMP Packet Location in the Frame

FIG. 95. Byte-splitter and (12) TCM encoders.

FIG. 96. TCM Encoder with Deterministic Trellis Reset

FIG. 97. SRS featured ATSC Transmitter

FIG. 98. VSB Frame

FIG. 99. ATSC Emission Mulitplexor for SRS

FIG. 100. Normal TS Packet Sequence

FIG. 101. Normal TS packet Syntax with Adaptation Field

FIG. 102. SRS-placeholder-carrying TS Packet

FIG. 103. Transport Stream at A-VSB Transmission Adaptor Output

FIG. 104. SRS Stuffer

FIG. 105. MPEG Data Stream Carrying SRS Bytes.

FIG. 106. VSB Sliver of DF Template for SRS

FIG. 107. TCM Encoder Block with Parity Correction

FIG. 108. Functional Encoding Structure for Turbo Stream

FIG. 109 A-VSB Transmitter for Turbo Stream

FIG. 110 A-VSB Multiplexer

FIG. 111. Output of Transmission Adaptor in 6 slivers

FIG. 112. Turbo Fragment Map in 4 packets

FIG. 113 TF map representation

FIG. 114 Example of TF map

FIG. 115. Turbo Stream TS from Service Multiplexer

FIG. 116 Turbo Pre-processor

FIG. 117 Time interleaver

FIG. 118. Outer Encoding on a Byte Basis (L depends on the Turbo Stream mode)

FIG. 119. Outer Encoder

FIG. 120. 2/3-rate Encoding in Outer Encoder

FIG. 121. 1/2-rate Encoding in Outer Encoder

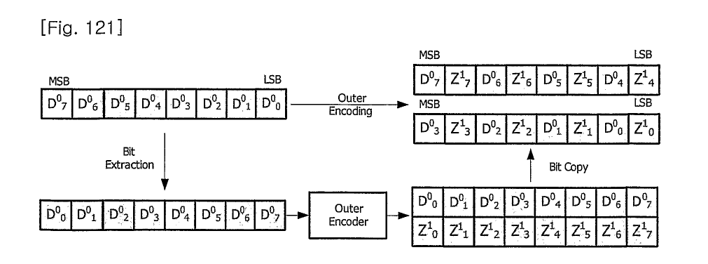

FIG. 122. 1/3-rate Encoding in Outer Encoder

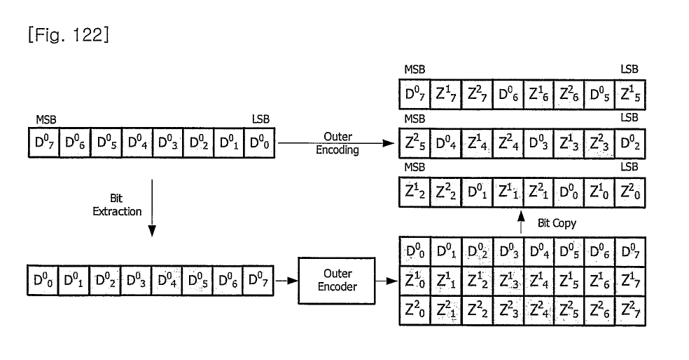

FIG. 123 1/4-rate Encoding in Outer Encoder

FIG. 124. Interleaving Rule 4 (2, 1, 3, 0)

FIG. 125 Multi-stream Data De-interleaver

FIG. 126. Turbo Stream Transmission Combined with SRS

FIG. 127 Field Sync at Even Field

FIG. 128 Field Sync at Odd Field

FIG. 129 Signaling bit structure for A-VSB

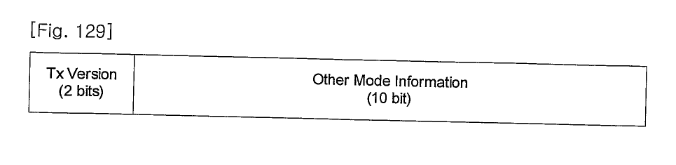

FIG. 130 Signaling bit structure for A-VSB at Tx Version 1

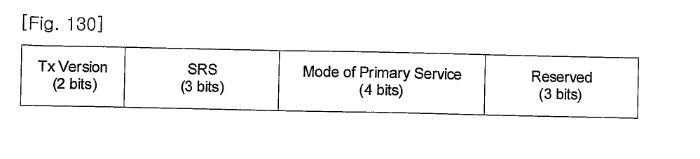

FIG. 131 Signaling bit structure for A-VSB at Tx Version 2

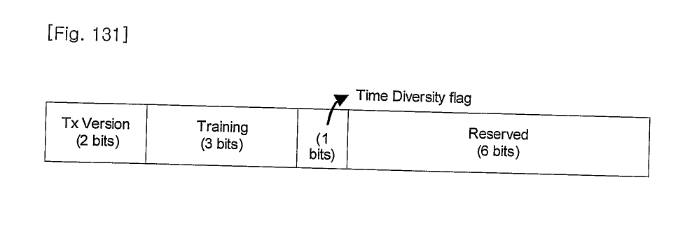

FIG. 132 Error Correction Coding for Mode Information

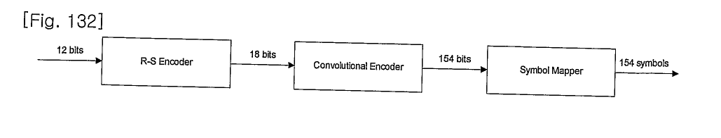

FIG. 133 Reed-Solomon (6,4) t=1 parity generator polynomial.

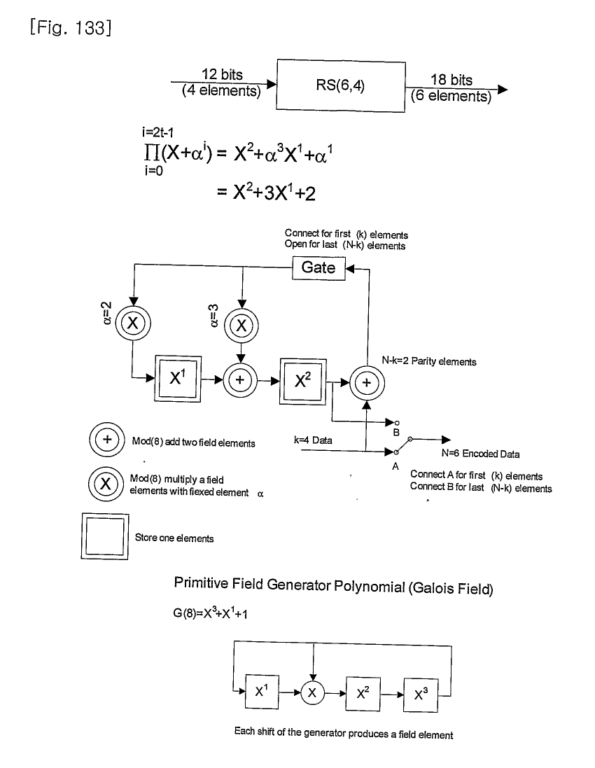

FIG. 134 1/7 rate Tail Biting Convolutional Encoder {37, 27, 25, 27, 33, 35, 37} octal number

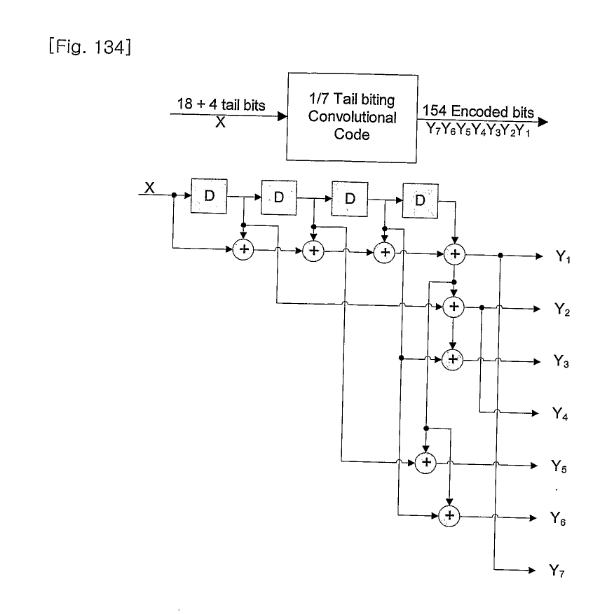

FIG. 135 Insertion of Signaling Information into DFS

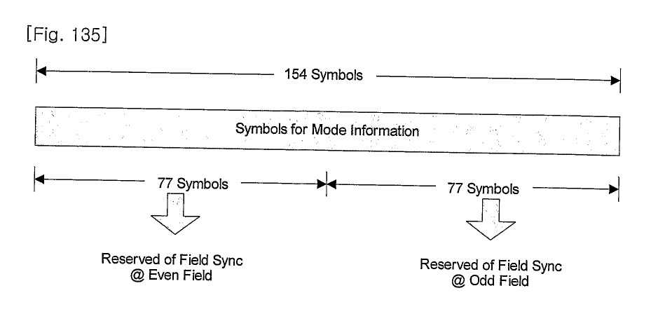

FIG. 136 VSB Sliver of DF Template for SRS

FIG. 137 VSB Sliver of DF Template for SRS

### DESCRIPTION OF THE EXEMPLARY EMBODIMENTS

### I. Response to ATSC Mobile/Handheld RFP A-VSB MCAST

### 1 Scope

This document provides the detailed response to the ATSC mobile/handheld request for proposals. This proposal builds on the A-VSB physical layer defined in S9-304 and ATSC standards.

### 2 References

1. ATSC TSG/S9-304r3, “Technical Disclosure, Advanced VSB System (A-VSB)”
2. ISO/IEC 14496-1:2004 Information technology—Coding of audio-visual objects—Part 1: Systems
3. ISO/IEC 13818-1:2000 Information technology—Generic Coding of moving pictures and associated audio information: Systems
4. ITU-T Recommendation H.264: “Advanced video coding for generic audiovisual services”/ISO/IEC 14496-10 (2005): “Information Technology—Coding of audio-visual object Part 10: Advanced Video Coding”.
5. ISO/IEC 14496-3: “Information technology—Generic coding of moving picture and associated audio information—Part 3: Audio” including ISO/IEC 14496-3/AMD-1 (2001): “Bandwidth extension” and ISO/IEC 14496-3 (2001) AMD-2 (2004): “Parametric Coding for High Quality Audio”.
6. ATSC A/72, Part 1, “AVC Coding Constraints . . . [TBD]”
7. ATSC A/53:2006: “ATSC Standard: Digital Television Standard (A/53), Parts 1 and 2”, Advanced Television Systems Committee, Washington, D.C.
8. ATSC A/110A: “Synchronization Standard for Distributed Transmission, Revision A”, Section 6.1, “Operations and Maintenance Packet Structure”, Advanced Television Systems Committee, Washington, D.C.
9. ETSI TS 101 191 V1.4.1 (2004-06), “Technical Specification Digital Video Broadcasting DVB); DVB mega-frame for Single Frequency Network (SFN) synchronization”, Annex A, “CRC Decoder Model”, ETS

### 3 Definition of Terms

### 3.1 Terms

Application layer—A/V streaming, IP, and NRT services

ATSC Epoch—Start of ATSC System Time (Jan. 6, 1980 00:00:00 UTC)

ATSC System Time—Number of Super Frames since ATSC Epoch

A-VSB Multiplexer—a special purpose ATSC multiplexer that is used at the studio facility and feeds directly an 8-VSB transmitter, or transmitters, each having an A-VSB exciter.

Cluster—a group of any number of sectors, where a Turbo fragment is placed

Cross Layer Design—an 8-VSB enhancement technique which places requirements/constraints on one system layer by another to gain an overall efficiency and or performance not intrinsically inherent from the 8-VSB system architecture while still maintaining backward compatibility

Data Frame—consists of two Data Fields, each containing 313 Data Segments. The first Data Segment of each Data Field is a unique synchronizing signal (Data Field Sync)

Exciter—receives the baseband signal (Transport Stream) performs the main functions of channel coding and modulation and produces RF Waveform at assigned frequency. Is capable of receiving external reference signals such as 10 MHz frequency and One Pulse per second (1PPS) and GPS Seconds Count from a GPS receiver.

Link layer—FEC encoding, partitioning and mapping between Turbo stream and clusters

Linkage Information Table (LIT)—A linkage information table between service components which is placed in first signal packet in MCAST parcel

Location Map Table (LMT)—A location information table which is placed first signal packet in MCAST parcel

MAC layer—FEC encoding, partitioning and mapping between Turbo stream and clusters

MCAST—Mobile-casting for A-VSB

MCAST parcel—a group of MCAST packets decoded after Turbo packets are extracted from a parcel

MCAST stream—a sequence of MCAST packets

MCAST Transport layer—Transport layer defined in ATSC-MCAST

MPEG data—sync byte-absent TS

MPEG data packet—sync byte-absent TS packet

NSRS—number of SRS bytes in AF in a TS or MPEG data packet

NTStream—number of Turbo fragment bytes in AF in a TS or MPEG data packet

Package—group of 312 TS or MPEG data packets

Parcel—group of 624 TS of MPEG data packets

Primary Service—First priority service the user watches when powered on. This is optional service to broadcaster.

Sector—8 bytes of reserved space in AF of a TS or MPEG data packet

Segment—in ATSC Normal/A53 exciter, MPEG data are interleaved by ATSC A/53 Byte Interleaver. Then, a data unit of consecutive 207 bytes is called a segment payload or just segment.

SIC—Signaling information channel for every turbo streams and which is itself turbo stream

Slice—group of 52 segments

Sliver—group of 52 TS or MPEG data packets

SRS-bytes—Pre-calculated bytes to generate SRS-symbols

SRS-symbols—SRS created with SRS-bytes through zero-state TCMs

Sub data channel—Physical space for A/V, IP and NRT data within a MCAST parcel. MCAST Packet—a Transport packet defined in MCAST packet.

Super Frame—one of a continuous grouping of twenty (20) consecutive VSB Frames which first started at ATSC Epoch

TCM Encoder—a set of the Pre-Coder, Trellis Encoder, and 8 level mapper

Track—group of 4 TS or MPEG data packets

Transport layer—Transport layer defined in ATSC-MCAST

Turbo channel—Physical space for MCAST stream, divided into several sub-data channel

Turbo Stream—Turbo coded Transport Stream

Turbo TS packet—Turbo coded Transport Stream packet

Sub-data channel—Physical space for A/V streaming, IP and NRT data. A part of Turbo channel

VFIP—Special OMP generated by a Emission Multiplexer (locked AST) which the appearance of in the ATSC Transport Stream signals the beginning of a Super Frame to the Exciter which results in placement of DFS with No PN 63 Inversion in VSB Frame

VSB Frame—626 segments consisting of 2 data field sync segments and 624 (data+FEC) segments

### 3.2 Abbreviations

The following abbreviations are used within this document,

### 1PPS One Pulse Per Second

### 1PPSF One Pulse Per Super Frame

### A-VSB Advanced VSB System

### AST ATSC System Time

### DC Decoder Configuration

### DCI Decoder Configuration Information

### DFS Data Field Sync

EC channel Elementary Component channel

### ES Elementary Stream

### F/L First/Last

### GPS Global Positioning System

### IPEP IP Encapsulation Packet

### LMT Location Map Table

### LIT Linkage Information Table

### MCAST Mobile Broadcasting

### OEP Object Encapsulation Packet

### PCR Program Clock Reference

### PSI Program Specific Information

### REP Real-time Encapsulation Packet

### SD-VFG Service Division in Variable Frame Group

### SEP Signaling Encapsulation Packet

### SF Super Frame

### SFN Single Frequency Network

### SIC Signaling Information Channel

### TCM Trellis Coded Modulation

TS A/53 defined Transport Stream

### PSI/PSIP Program Specific Information/Program Specific Information Protocol

### UTF Unit Turbo Fragment

### 4 Introduction

The Mobile Broadcasting (A-VSB MCAST) design consists of transport and signaling optimized for mobile and handheld services. Section 5 provides the overall A-VSB MCAST architecture. Section [200] specifies the physical and link layers. Section 7 specifies the transport layer. And, Section 8 describes the frame slicing mechanism for burst transmission.

Backwards compatibility is ensured by the careful design of the physical and link layers. Field tests are well underway now, being overseen by ATSC TSG/S9.

### 4.1 Compliance Form

Respondent Name

| Required Item | RFP Section | Response |
|---|---|---|
| Respondent Information Form | 4.1 | Yes No |
| Submitted | | |
| Overview of Proposal | 4.2 | Yes No |
| Submission | | |
| Detailed Proposal | 4.3 | Yes No |
| submission | | |
| Submission of statement | 6.1 | Yes No |
| regarding Bylaws and | | |
| Procedures Review and | | |
| agreement | | |
| Submission of statement | 6.2 | Yes No |
| indicating intent to | | |
| comply with the | | |
| ATSC Patent Policy | | |
| Submission of statement | 6.3 | Yes No |
| indicating intent to | | |
| comply with the | | |
| ATSC Copyright and | | |
| Reference Policy | | |
| Submission of statement | 7.0 | Yes No |
| Regarding Respondent | | |
| Resources | | |

### 5 A-VSB MCAST Architecture

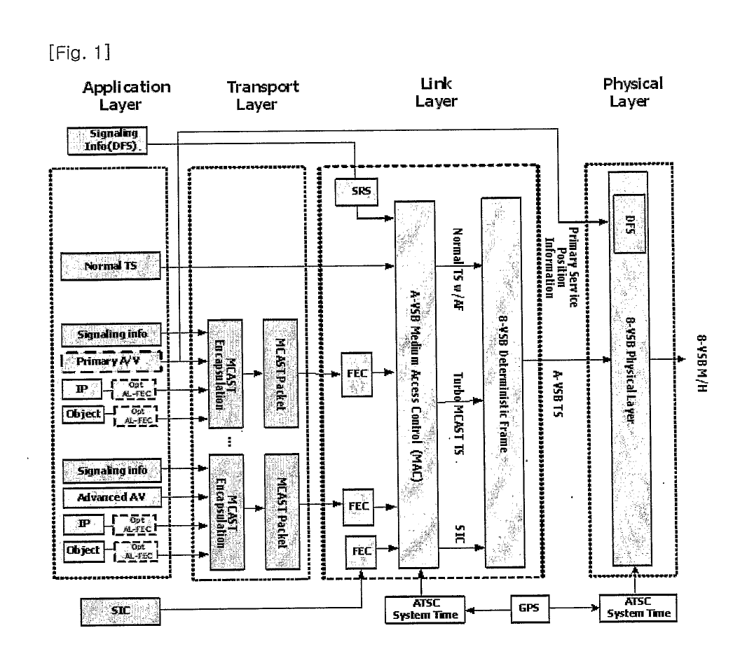

The overall architecture of A-VSB MCAST is shown in FIG. 1.

A-VSB MCAST is composed of 4 layers: application, transport, link, and physical. And it supports 3 types of application services: real time service, IP service and object service. These 3 types of services are multiplexed into an MCAST stream per turbo channel.

For fast initial service acquisition, A-VSB MCAST provides a primary service which is described in more detail in Section 7.3.1.

There are two sub layers in the transport which support four data types: real time A/V, IP, Object and Signaling.

Optional application layer FEC (AL-FEC) may be applied to either the IP or Object streams to improve quality of service for certain applications such as large file transfers.

The encapsulation and packetization layers, provide the application specific and fragmentation information for the application data. They also encapsulate the elementary data units with predefined, type-specific syntax. The application streams are encapsulated by type and multiplexed into fixed length packets called MCAST turbo streams in the Transport layer. These then form turbo channels.

The link layer receives the turbo channel streams and applies a specific FEC (code rate, etc) to each turbo channel. The signaling information in SIC will normally have the most robust FEC (turbo code rate) to ensure it can be received at a S/N above the application data it is signaling. The turbo channels w/FEC applied are then sent to the A-VSB MAC layer along with the Normal TS packets and the exciter signaling information is transported in SRS placeholder bytes from studio to transmitter. The A-VSB MAC layer is responsible for the sharing of the physical layer medium (8-VSB) between normal and robust data.

The A-VSB MAC layer uses adaptation fields (AF) in normal TS packets when needed. The A-VSB MAC Layer places constraints on how the physical layer is to be operated in a deterministic manner and how the physical layer is partitioned between normal and robust data. The robust data is mapped into a deterministic frame structure, then signaled and sent to the 8-VSB physical layer to achieve an overall gain in system efficiency and/or performance enhancement not found in the 8-VSB system, while still maintaining backward compatibility. The exciter at the Physical Layer also operates deterministically under control of the MAC Layer, and inserts signaling in the DFS.

### 6 Physical and Link Layers (A-VSB)

### 6.1 System Overview

The first objective of A-VSB is to improve reception issues of 8-VSB services in fixed or portable modes of operation. This document also describes A-VSB extensions to enable future Mobile and Hand Held services. This system is backward-compatible in that existing receiver designs are not adversely affected by the Advanced signal.

This document defines the following core techniques:
Deterministic Frame (DF)
Deterministic Trellis Reset (DTR)

And, this document defines the following “application tools”:
Supplementary Reference Sequence (SRS)
Turbo Stream
Single Frequency Network

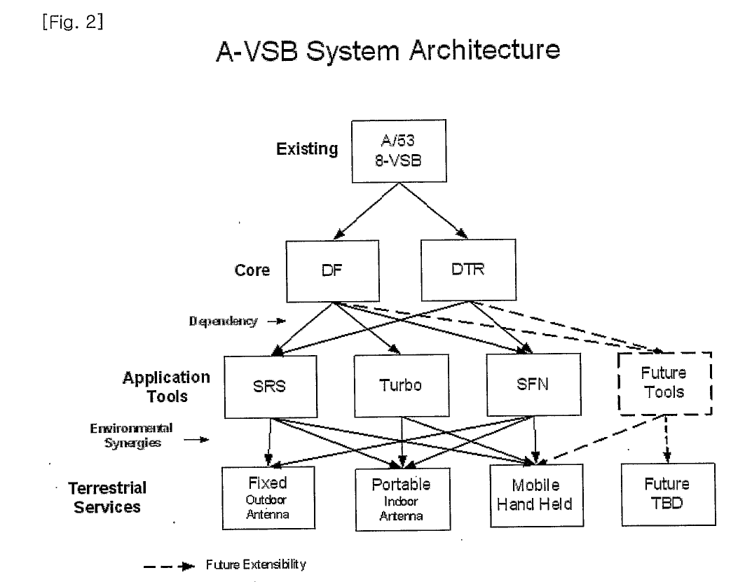

These core techniques and application tools can be combined as shown in FIG. 2. It shows the core techniques (DF, DTR) as the basis for all of the application tools defined here and potentially in the future. The solid green lines show this dependency. Certain tools are used to mitigate propagation channel environments expected for certain broadcast services. Again the green lines show this relationship. Tools can be combined together synergistically for certain terrestrial environments. The green lines demonstrate this synergy. The dash lines are for potential future tools not defined by this document.

The Deterministic Frame (DF) and Deterministic Trellis Reset (DTR) are backwardly compatible system constraints that prepare the 8-VSB system to be operated in a deterministic, or synchronous manner and enable a cross layer 8-VSB enhancement design. In the A-VSB System the A-VSB multiplexer has knowledge of and signals the start of the 8-VSB Frame to the A-VSB exciter. This a priori knowledge is an inherent feature of the A-VSB multiplexer which allows intelligent multiplexing (cross layer) to gain efficiency and or increase performance of the 8-VSB system.

The absence of frequent equalizer training signals has encouraged receiver designs with an over dependence on “blind equalization” techniques to mitigate dynamic multipath. The SRS is a cross layer technique that offers a system solution with frequent equalizer training signals to overcome this using the latest algorithmic advances in receiver design principles. The SRS application tool is backwards compatible with existing receiver designs (the information is ignored), but improves normal stream reception in SRS-designed receivers.

Turbo Stream provides an additional level of error protection capability. This brings robust reception in terms of lower SNR receiver threshold and improvements in multi-path environments. Like SRS, the Turbo Stream application tool is based on cross layer techniques and is backwards compatible with existing receiver designs (the information is ignored).

The application tool SFN leverages both core elements DF and DTR to enable an efficient cross layer Single Frequency Network (SFN) capability. An effective SFN design can enable a higher more uniform signal strength along with spatial diversity to deliver a higher quality of service (QOS) in mobile and handheld environments.

The tools such as SRS, Turbo Stream, and SFN can be used independently. There is no dependency among these application tools—any combination of them is possible. These tools also can be used together synergistically to improve the quality of service in many terrestrial environments.

### 6.2 Deterministic Frame (DF)

### 6.2.1 Introduction

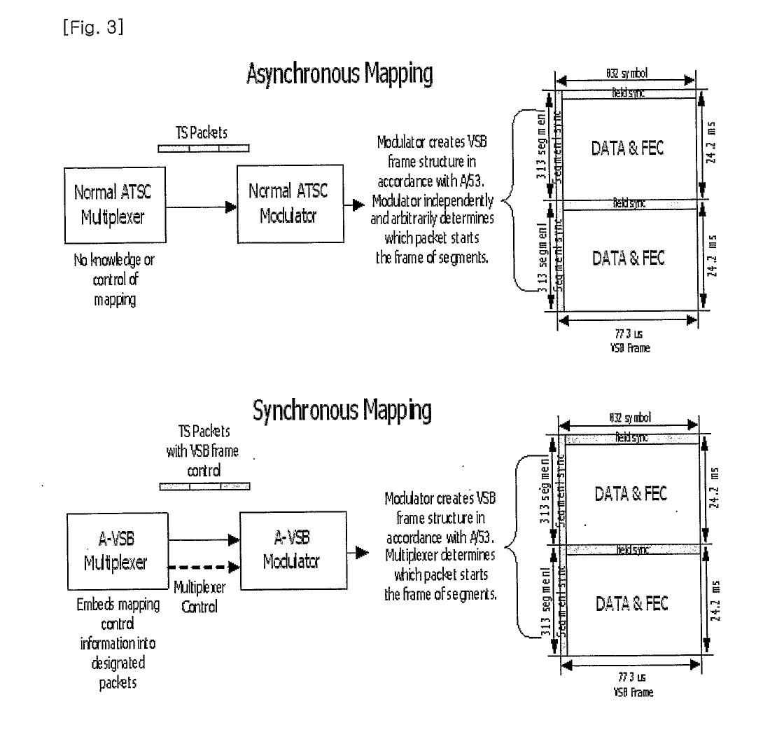

The first core technique of A-VSB is to make the mapping of ATSC Transport Stream packets a synchronous process (currently this is an asynchronous process). The current ATSC multiplexer produces a fixed rate Transport Stream with no knowledge of the 8-VSB physical layer frame structure or mapping of packets. This is depicted in the top of FIG. 3.

When powered on, the normal (8-VSB) ATSC exciter independently and arbitrarily determines which packet begins the frame of segments. Currently, no knowledge of this decision and hence the temporal position of any transport stream packet in the VSB frame is available to the current ATSC multiplexing system.

In the A-VSB system, the A-VSB multiplexer makes a selection for the first packet to begin an ATSC physical layer frame. This framing decision is then signaled to the A-VSB exciter, which is a slave to the A-VSB multiplexer for this framing decision.

In summary, the knowledge of the starting packet coupled with the fixed ATSC VSB Frame structure gives the A-VSB multiplexer insight into the position of every packet in the 8-VSB physical layer frame. This situation is shown in the bottom of FIG. 3. The knowledge of the DF structure (The a priori knowledge of where each and every byte in the TS will reside at a later point in time in the stages of ATSC exciter allows cross layer techniques to enhance the performance of the 8-VSB physical layer) ows pre-processing in an A-VSB multiplexer and synchronous post-processing in an A-VSB exciter.

### 6.2.2 A-VSB Multiplexer to Exciter Control

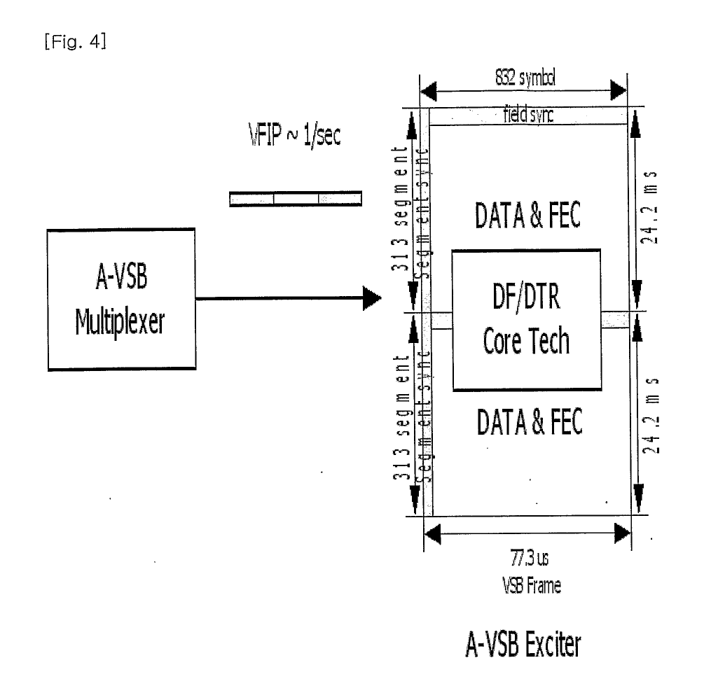

The emission multiplexer inserts a VFIP (The emission multiplexer VFIP cadence is aligned with the ATSC Epoch see ATSC System Time section 9.4) every 12,480 (This quantity of packets is equal to 20 VSB Frames and is termed a Super Frame.) packets. The VFIP signals the A-VSB modulator to insert a DFS with No PN 63 inversion into the VSB Frame. This periodic appearance of VFIP establishes and maintains the A-VSB Deterministic Frame structure which is a “Core” element of the A-VSB system architecture. This is shown in FIG. 4.

Additionally, the A-VSB multiplexer Transport Stream Clock and the Symbol Clock in the A-VSB Exciter must be locked to a common universally available frequency reference from a GPS receiver. Locking both the Symbol and Transport clocks to an external reference brings stability that assures the synchronous operation.

Note: In the normal A/53 ATSC Modulator the symbol clock is locked to the incoming SMPTE 310M and has a tolerance of +/−30 Hz. Locking both to a common external reference (Another benefit is the prevention of Symbol Clock Jitter which can be problematic for a receiver.) will prevent rate adaptation or stuffing by the Exciter in response to drift of the incoming SMPTE 310M+/−54 Hz tolerance. This helps maintain the Deterministic Frame once initialized. ASI is the preferred transport stream interface, however SMPTE 310M can still be used.

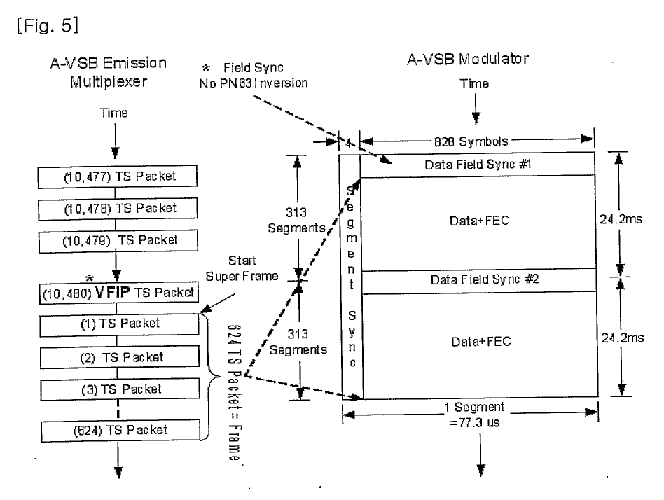

The Emission Multiplexer shall be the master and signals which transport stream packet shall be used as the first VSB Data segment in a VSB Frame. Since the system is operating with synchronous clocks it can be stated with 100 percent certainty which 624 Transport Stream packets make up a VSB Frame in the A-VSB Modulator. A counter (This counter is locked to 1PPSF as described in the section9.4 on ATSC System Time.) of (624x20) 10,480 TS packets is maintained in the Emission Multiplexer. The DF is achieved through the insertion of a VFIP as defined in Section 6.2.3. The VFIP shall be the last packet in group of 624 packets when it is inserted, as shown in FIG. 5.

### 6.2.3 VFIP Special Operations and Maintenance Packet

In addition to the common clock, a special Transport Stream packet is needed. This packet shall be an Operations and Maintenance Packet (OMP) as defined in ATSC A/110A, Section 6.1. The value of the OM_type shall be 0x30 (Note: a VFIP OM_type in the range of 0x31-0x3F shall be used for SFN operation see section 9 on SFN).

Note: This packet is on a reserved PID, 0x1FFA.

The emission multiplexer shall insert the VFIP into the transport stream once every 20 frames (10,480 TS Packets) which will signal the exciter to start a VSB frame which also demarcates the beginning of next super frame. The VFIP is inserted as the last, 624th packet in the frame this causes the A-VSB modulator to insert a Data Field Sync with No PN63 inversion of the middle PN63 after the last bit of the VFIP.

The complete packet syntax shall be as defined in Table 1.

TABLE 1
VFIP Packet Syntax

| | | |
|---|---|---|
| Syntax | # of Bits | mnemonic |

VFIP_omp_packet( ) {

| | | |
|---|---|---|
| transport_packet_header | 32 | bslbf |
| OM_type | 8 | bslbf |

| | | |
|---|---|---|
| reserved | 8 | uimsbf |
| private | 182*8 | uimsbf |

transport_packet_header—as defined and constrained by ATSC A/110A, Section 6.1.

OM_type—as defined in ATSC A/110A, Section 6.1 and set to 0x30.

private—to be defined by application tools.

### 6.3 Deterministic Trellis Reset (DTR)

### 6.3.1 Introduction

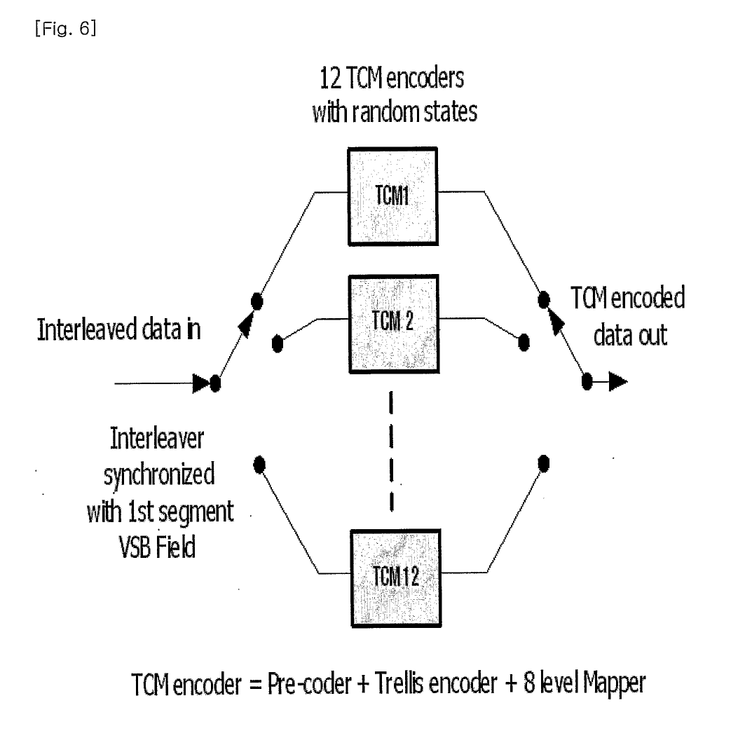

The second core element is the Deterministic Trellis Resetting (DTR) which resets the Trellis Coded Modulation (TCM) encoder states (the Pre-Coder and Trellis Encoder States) in the A-VSB exciter. The reset is triggered at selected temporal locations in the VSB Frame. FIG. 6 shows that the states of the (12) TCM Encoders in 8VSB are random. No external knowledge of the states can be known due to the random nature in the A/53 design. The DTR offers a new mechanism to force all TCM Encoders to zero state (a known deterministic state). The emission multiplexer (cross layer design) allows insertion of placeholder packets in calculated positions in TS which later will be post processed in the A-VSB exciter.

Note: This document refers to the intra-segment interleaver as a byte splitter as that is felt to be more precise term for the function.

### 6.3.2 Operation of State Reset

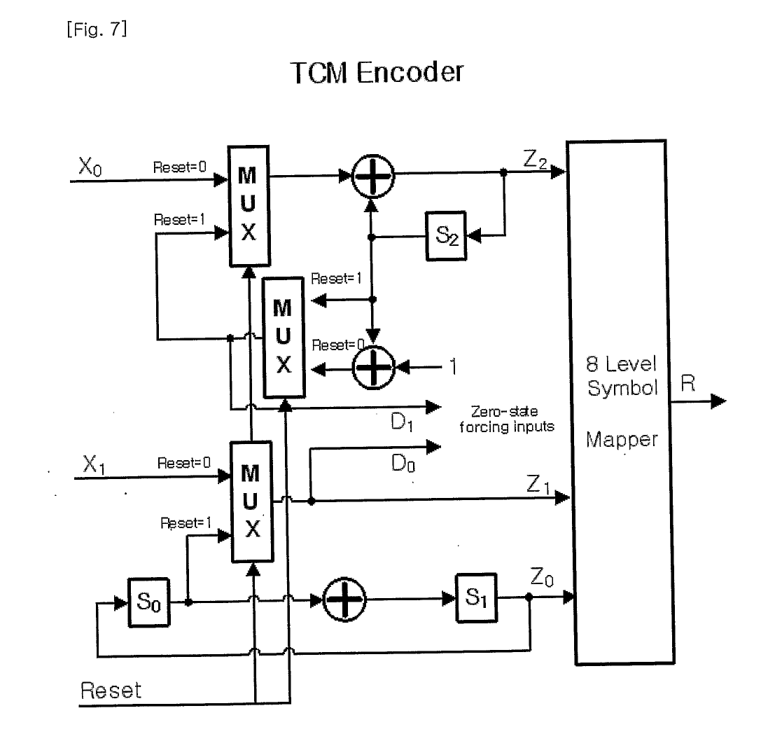

FIG. 7 shows (1 of 12) TCM Encoders used in Trellis Coded 8-VSB (8T-VSB). There are two new Multiplexer circuits added to existing logic gates in circuit shown. When the Reset is inactive (Reset=0) the circuit performs as a normal 8-VSB TCM encoder.

The truth table of an XOR gates states, “when both inputs are at like logic levels (either 1 or 0), the output of the XOR is always 0 (Zero).” Note that there are three D-Latches (S0, S1, S2), which form the memory. The latches can be in one of two possible states (0 or 1). Therefore as shown in Table 2, second column indicates eight (8) possible starting states of each TCM encoder. Table 2 shows the logical outcome when the Reset signal is held active (Reset=1) for two consecutive Symbol Clock periods. Independent of the starting state of the TCM, it is forced to a known Zero state (S0=S1=S2=0). This is shown in next to last column labeled Next State. Hence a Deterministic Trellis Reset (DTR) can be forced over two symbol clock periods. When the Reset is not active the circuit performs normally.

TABLE 2
Trellis Reset Truth Table

| | | | | | (S0 S1 | |
|---|---|---|---|---|---|---|
| | (S0 S1 | | (S0 S1 | | S2) Next | Output |
| Reset at | S2) at | (D0 D1) at | S2) at | (D0 D1) at | State at | (Z2 Z1 |
| t = 0 | t = 0 | t = 0 | t = 1 | t = 1 | t = 2 | Z0) |
| 1 | 0, 0, 0 | 0, 1 | 0, 0, 1 | 0, 1 | 0, 0, 0 | 000 |
| 1 | 0, 0, 1 | 0, 0 | 0, 0, 1 | 0, 1 | 0, 0, 0 | 000 |
| 1 | 0, 1, 0 | 0, 1 | 1, 0, 1 | 1, 1 | 0, 0, 0 | 000 |
| 1 | 0, 1, 1 | 0, 0 | 1, 0, 1 | 1, 1 | 0, 0, 0 | 000 |
| 1 | 1, 0, 0 | 1, 1 | 0, 0, 1 | 0, 1 | 0, 0, 0 | 000 |
| 1 | 1, 0, 1 | 1, 0 | 0, 0, 1 | 0, 1 | 0, 0, 0 | 000 |
| 1 | 1, 1, 0 | 1, 1 | 1, 0, 1 | 1, 1 | 0, 0, 0 | 000 |
| 1 | 1, 1, 1 | 1, 0 | 1, 0, 1 | 1, 1 | 0, 0, 0 | 000 |

Additionally, zero-state forcing inputs (D0, D1 in FIG. 7) are available. These are TCM Encoder inputs which forces Encoder state to be zero. During the 2 symbol clock periods, they are produced from the current TCM encoder state. At the instant to reset, the inputs of TCM Encoder are discarded and the zero-state forcing inputs are fed to a TCM Encoder over two symbol clock periods. Then the TCM Encoder state becomes zero. Since these zero-state forcing inputs (D0, D1) are used to correct parity errors induced by DTR, they should be made available to any application tools.

The actual point at which reset is performed is dependent on the application tool. See the Supplementary Reference Sequence (SRS) and SFN tools for examples.

### 6.4 Medium Access Control (MAC)

The A-VSB MAC layer is the protocol entity responsible for establishing the A-VSB “Core” Deterministic Frame structure under the control of ATSC System Time. This enables cross layer techniques to create tools such as A-SRS (see 6.6.5) or enable the efficiency of the A-VSB turbo encoder scheme (6.6.1). The MAC Layer sets the rules for sharing of the physical layer medium (8-VSB) between normal and robust data in the time domain. The MAC layer first defines an addressing scheme for locating robust data into the deterministic frame. The A-VSB track is first defined, which is then segmented into a grid of sectors, the sector is the smallest addressable robust unit of data. A group of sectors are assigned together to form a larger data container and this is called a cluster. The addressing scheme allows robust data to be mapped into the deterministic frame structure and this assignment (address) is signaled via the (SIC). The SIC is 1/6 outer turbo coded for added robustness in low S/N and place in known position (address) in every VSB frame. The MAC Layer also opens adaptation fields in the normal TS packets when needed.

### 6.4.1 Data Mapping in Track

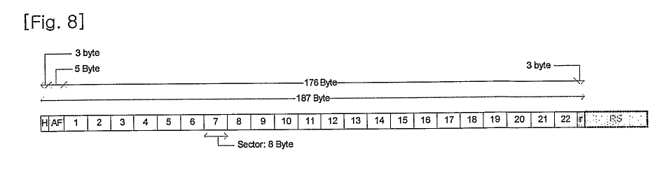

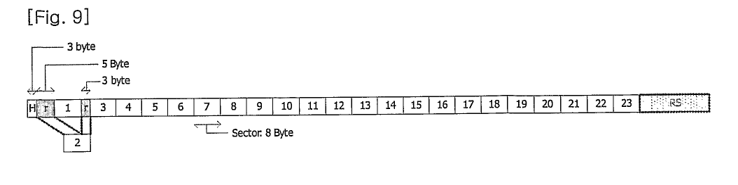

A VSB track is defined as 4 MPEG data packets. The reserved 8 byte space in AF for Turbo stream is called sector. A group of sectors is called a cluster. When data in this proposal (such as Turbo stream bytes and SRS) are delivered in MPEG data packets, the private data field in AF will be used. However, when a MPEG data packet is entirely dedicated for data (Turbo stream and SRS), a null packet, A/90 data packet, or a packet with a newly defined PID will be used to save 2 bytes of AF header and 3 bytes private field overhead. In this case, the saved 5 bytes affect packet segmentation. For example, FIG. 8 shows the case of packet segmentation by sectors with the AF header (2 bytes) and the private data field overhead (5 bytes). Since (187-8=) 176 bytes is not divided by 8 bytes, there remain 3 bytes at the end of 22th sectors. However, a packet without the Adaptation Field is segmented without any remaining bytes as is shown in FIG. 9. Here, the second sector in a packet is divided into two fragments. One is 5 bytes and the other is 3 bytes. The division of the second sector provides the fixed location to the first sector which is used by SIC.

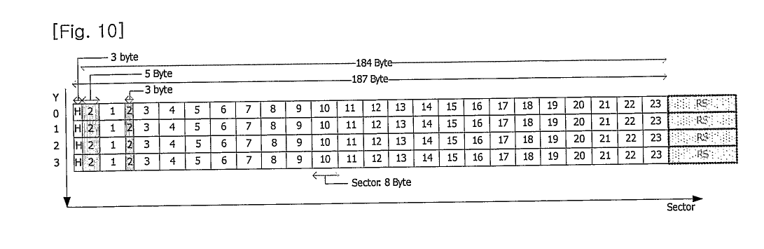

FIG. 10 shows the segmentation and partitioning of 4 packets by sectors (8 bytes). Since the data mapping into a cluster of sectors repeats every track in this proposal, it suffices to define the data mapping within a track. Each data occupies a cluster of some sectors. The cluster size determines the normal TS overhead.

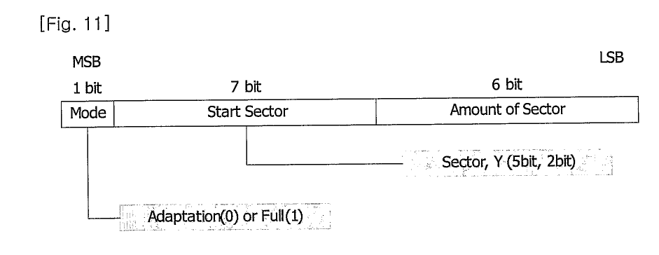

The data mapping is represented by 14 bits as shown in FIG. 11. The MSB means the existence of AF. The next 7 bits indicate the first sector in a cluster. The remaining 6 bits signify the cluster size as a number of sectors. The first sector in a cluster is located by a sector number in Y-th packet in a track FIG. 10. When the MSB set to 1, the packet containing the first sector has no AF and the sector number can be up to 23.

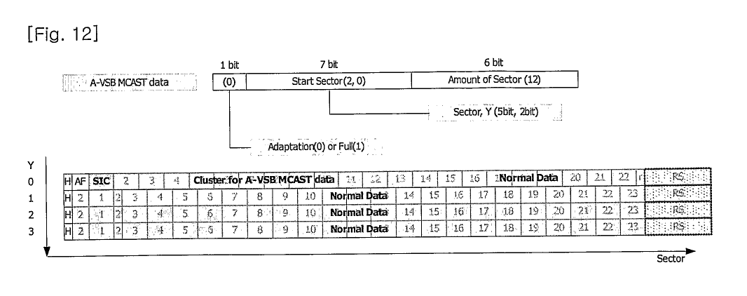

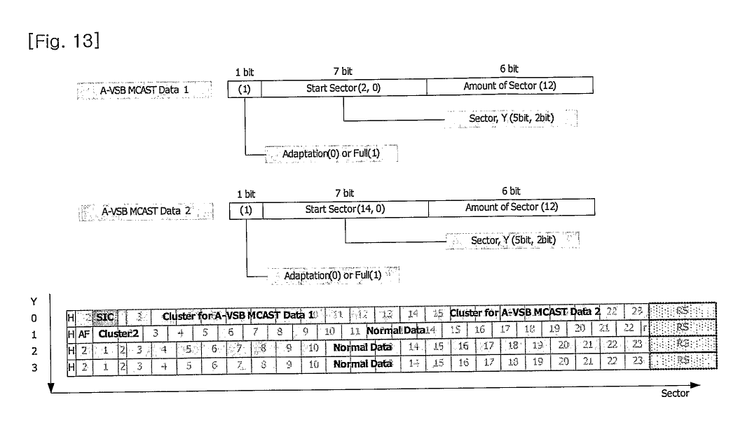

The data mapping example is shown in FIG. 12 and FIG. 13. When a packet is not enough to accommodate a specified number of sectors, the next packet provides the necessary room for the rest of sectors which is shown in FIG. 13. The 14 bits of mapping information for each A-VSB MCAST data is sent through the SIC. SIC will always be place at the 1st sector in the 1st packet.

6.4.2 Data Mapping with SRS

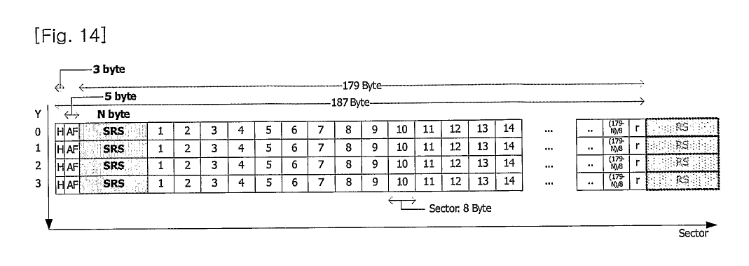

FIG. 14 shows how to segment a track by sectors when SRS is turned on. The last sector number reduces due to the SRS placeholders and depends on the SRS-N. The data mapping representation is the same as in the case of No-SRS.

### 6.4.3 Section on Multiplexing Robust Content

[TBD]

### 6.5 Supplementary Reference Sequence (SRS)

### 6.5.1 Introduction

The current ATSC 8-VSB system can be improved to provide reliable reception for fixed, indoor, and portable environments in the dynamic multi-path interference by making known symbol sequences frequently available. The basic principle of Supplementary Reference Sequence (SRS) is to periodically insert a special known sequence in a deterministic VSB frame in such a way that a receiver equalizer can utilize this known contiguous sequence to adapt itself to track a dynamically changing channel and thus mitigate dynamic multi-path and other adverse channel conditions.

### 6.5.2 System Overview

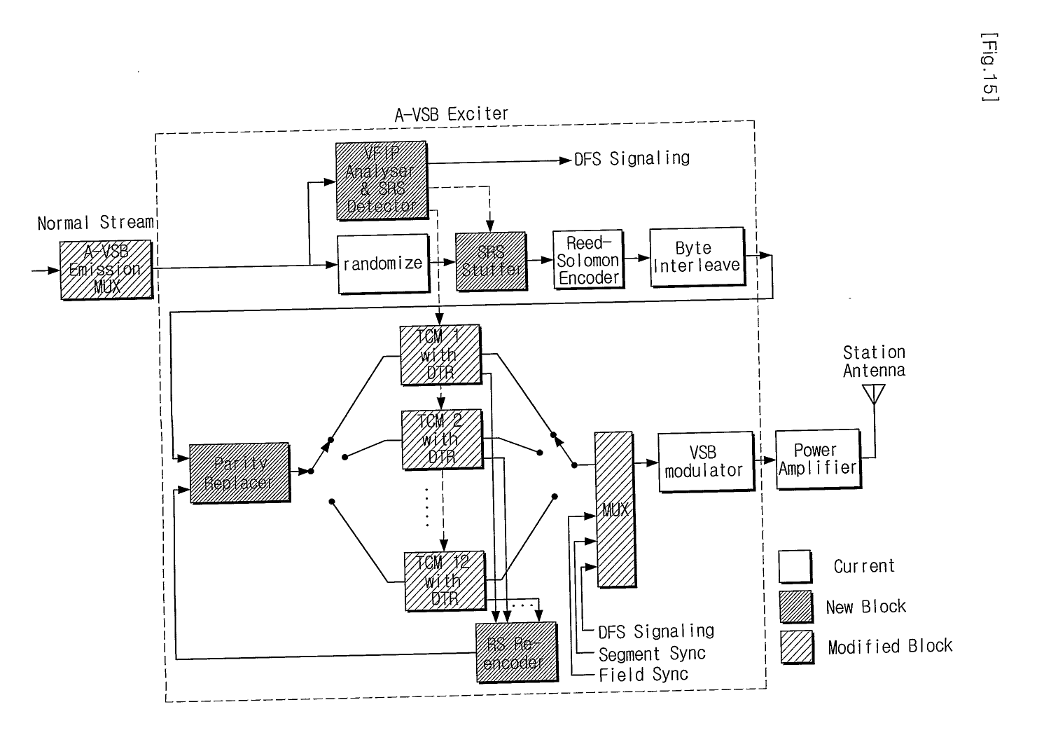

An SRS-enabled ATSC DTV Transmitter is shown in FIG. 15. The blocks modified for SRS processing are shown in pink (Multiplexer and TCM encoders block) while the newly introduced block (SRS stuffer) is shown in yellow. The other blocks are the current ATSC DTV blocks. The ATSC A-VSB Multiplexer takes into consideration a pre-defined deterministic frame template for SRS. The generated packets are prepared for the SRS post-processing in an A-VSB exciter.

The (Normal A/53) randomizer drops all sync bytes of incoming TS packets. The packets are then randomized. Then the SRS stuffer fills the stuffing area in the adaptation fields of packets with a pre-defined byte-sequence, (the SRS-bytes). The SRS-bytes-containing packets are then processed for forward error corrections with the (207, 187) Reed-Solomon code. In the byte Interleaver, bytes of RS-encoder output get interleaved. As a result of the byte Interleaving, the SRS-bytes are placed into contiguous 52 byte positions in 10, 15, or 20 segments. The segment (or the payload for a segment) is a unit of 207 bytes after byte Interleaving. These segments are encoded in (12) TCM encoders. At the beginning of each interleaver-re-arranged SRS-byte sequence, the Deterministic Trellis Reset (DTR) occurs to prepare the generation of known 8 level symbols. These generated symbols have specific properties of noise-like spectrum and zero dc-value which are SRS-byte design criteria.

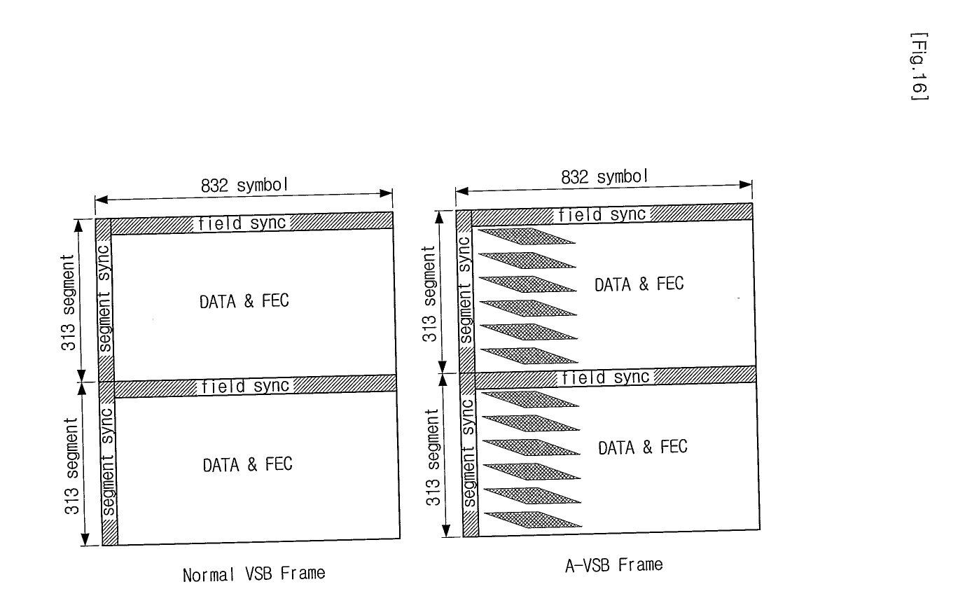

When the TCM encoder states are forced to a known deterministic state by DTR, a pre-determined known byte-sequence (SRS-bytes) inserted by the SRS Stuffer is then TCM encoded immediately. The resulting 8-level symbols at the TCM encoder output will appear as known contiguous 8-level symbol patterns in known locations in the VSB frame. This 8 level symbol-sequence is called SRS-symbols and is available to the receiver as additional equalizer training sequence. FIG. 16 shows the normal VSB frame on the left and an A-VSB frame on the right with SRS turned on. Each A-VSB frame has 12 groups of SRS 8-level symbols. Each group is in 10, 15, or 20 sequential data-segments depending on SRS-N. On MPEG-2 TS decoding, the SRS symbols appearing in the adaptation field will be ignored by a legacy receiver. Hence the backward compatibility is maintained.

FIG. 16 shows 12 (green) groups which have different composition depending on the number of SRS bytes. The actual SRS-bytes that are stuffed and the resulting group of SRS symbols are pre-determined and fixed.

Note that the normal 8-VSB standard has two DFS per frame, each with training sequences (PN-511 and PN-63s). In addition to those training sequences, the A-VSB provides 184 symbols of SRS tracking sequences per segment in group of 10, 15, or 20 segments. Number of such segments (with known 184 contiguous SRS symbols) available per frame will be 120, 180, and 240 for SRS-10, SRS-15, and SRS-20 respectively. These can help a new SRS receiver's equalizer track dynamic changing channel conditions when objects in the environment or the receiver itself is in motion

Since these changes (DTR and that altering SRS-bytes) occur after Reed-Solomon encoding, previously calculated RS parity bytes are no longer valid. In order to correct these erroneous parity bytes, they are re-calculated in the “RS Re-encoder” in FIG. 15. The old parity-bytes are replaced with re-calculated parity-bytes in the “Parity Replacer” block in FIG. 15. This process is expounded in Section 6.5.4.1.

The remaining blocks are the same as the standard ATSC VSB exciter. Each block in FIG. 15 is described in the following sections.

### 6.5.3 ATSC A-VSB Multiplexer for SRS

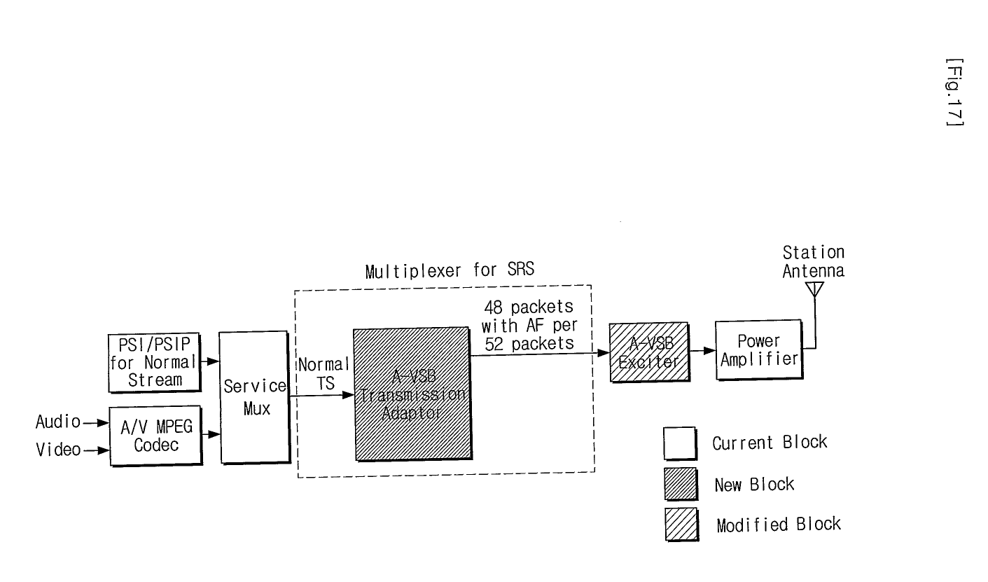

ATSC A-VSB Multiplexer for SRS is shown in FIG. 17. There is a new conceptual process block, Transmission Adaptor (TA). The Transmission Adaptor re-packetizes all elementary streams to properly set adaptation fields which serve as SRS-byte placeholders.

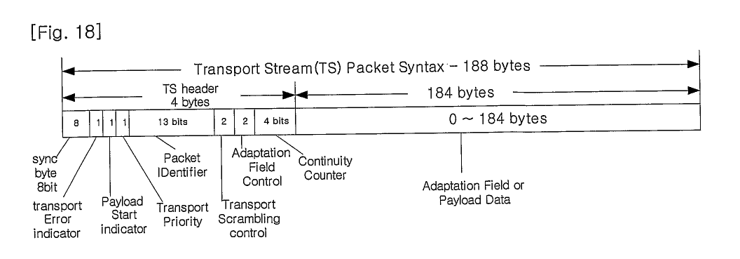

The normal MPEG-2 TS packet syntax is shown in FIG. 18. The adaptation field control in the TS header signals that an adaptation field is present.

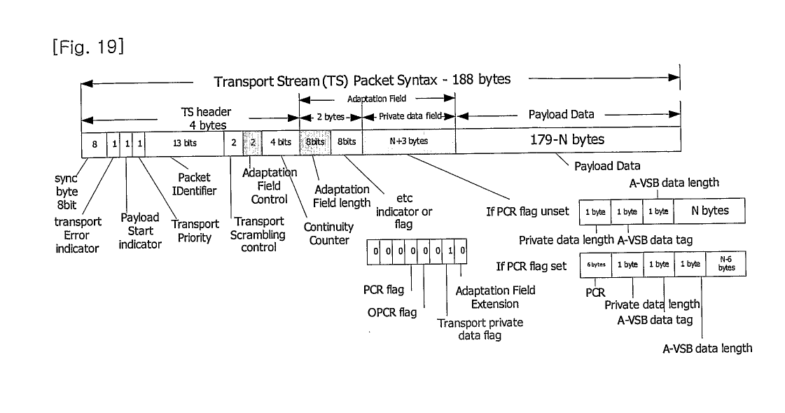

The normal transport packet syntax with an adaptation field is shown in FIG. 19. The “etc indicator” is a 1 byte field for various flags including PCR. See ISO 13818-1 for more details.

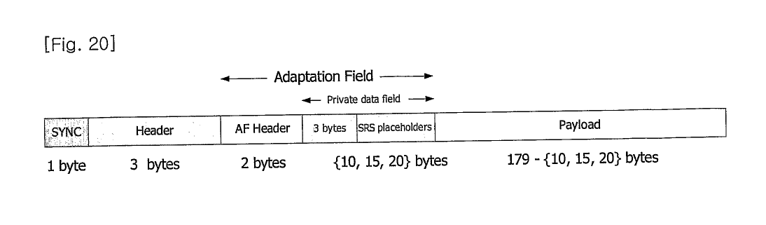

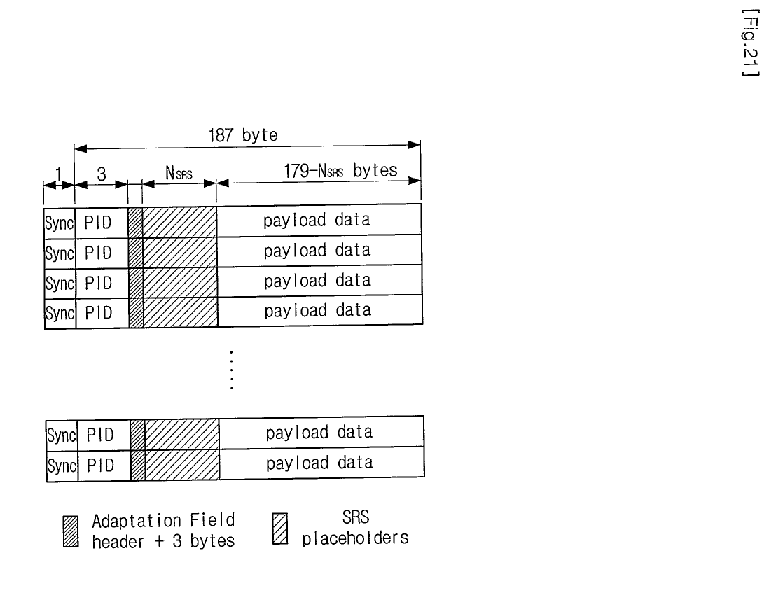

A typical SRS-placeholder-carrying packet is depicted in FIG. 20 and a transport stream with the SRS-placeholder-carrying packets is depicted in FIG. 21, which is the output of the A-VSB Multiplexer.

The actual transport stream at A-VSB transmission adaptor output has 4 packets with no SRS-bytes in every 52 packet.

### 6.5.3.1 Sliver Template for SRS

A VSB parcel, package, sliver, and track are defined as a group of 624, 312, 52, and 4 MPEG-2 data packets respectively. A VSB Frame is composed of 2 Data Fields, each data field having a Data Field Sync and 312 data segments. A slice is defined as a group of 52 data segments. So a VSB Frame has 12 slices. This 52 data segment granularity fits well with the special characteristics of the 52 segment VSB-Interleaver.

There are several pieces of information to be delivered through the adaptation field, along with the SRS Bytes to be compatible with A/53. These can be PCR, splice counter, private data and so on. From the ATSC perspective, the PCR (Program Clock Reference) and Splice counter must be also carried when needed along with the SRS. This imposes a constraint during the TS packet generation since the PCR is located at the first 6 SRS-bytes. This conflict is solved using the Deterministic Frame (DF). The DF enables {PCR, splice counter}-containing packet to be located in a known position of a slice. Thus an exciter designed for SRS can know the temporal position of the PCR and splice counter and accordingly fill the SRS-bytes, avoiding this other adaptation field information.

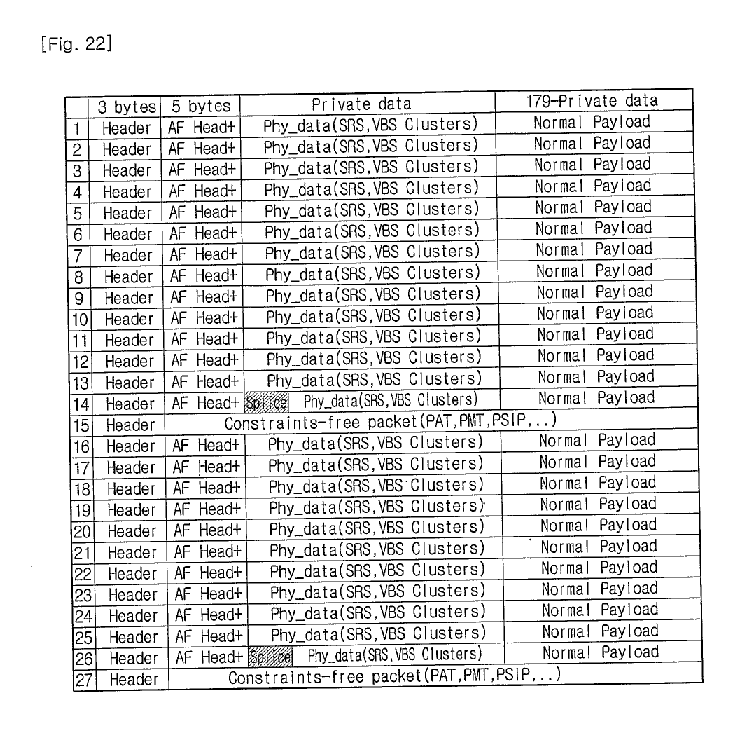

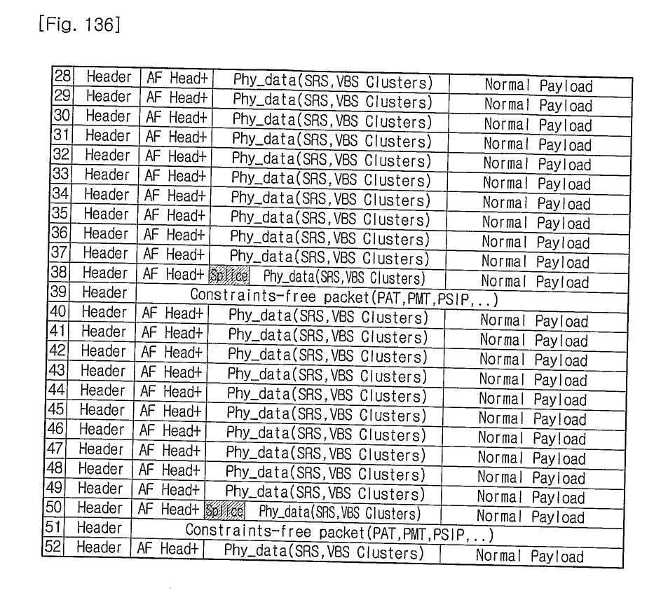

One sliver of SRS DF is shown in FIGS. 22, 136. The SRS DF template stipulates that the 7th, 19th, 31st, 43rd J (15th, 27th, 39th, and 51st) MPEG data packets in every VSB Sliver can be a Splice counter-carrying (constraint-free) packet. This set-up makes the PCR (and Splice counter) available at about 1 ms, which is well within the required frequency limit (minimum 40 ms) for PCR.

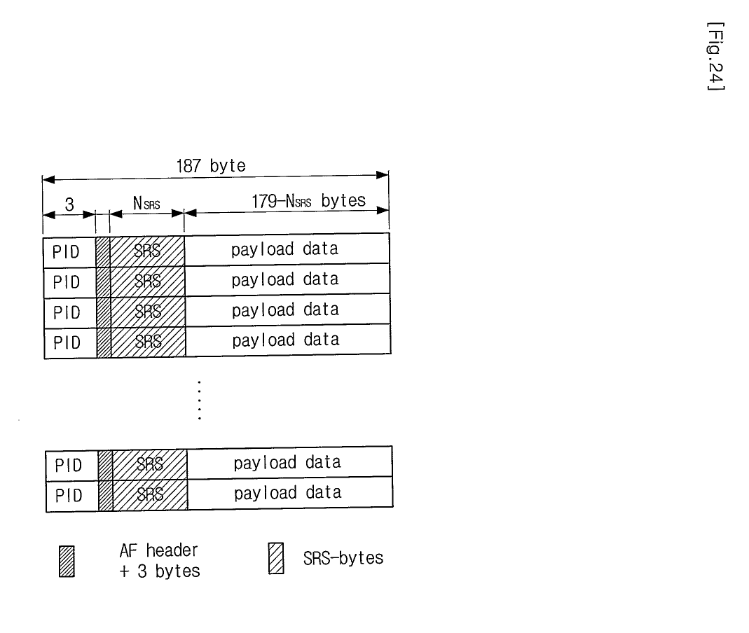

Obviously, a normal payload data rate with SRS will be reduced depending on SRS-N bytes in FIG. 24. The N can be 0 through 20, SRS-0 bytes being normal ATSC 8-VSB. The proposed values of SRS-N bytes are {10, 15, and 20} bytes listed in Table 3. he table gives the three SRS byte length candidates. SRS-byte length choices are signaled through the VFIP to the exciter from the A-VSB Multiplexer and also through DFS Reserved bytes from the exciter to the receiver.

Table 3 shows also the payload loss associated with each choice. Rough payload loss can be calculated as follows. Since 1 slice takes 4.03 ms, the payload loss due to SRS-10 bytes is (10+5) bytes*48packets/4.03 ms*8=1.43 Mbps (By assuming the sliver template shown in).

Similarly, a payload loss of SRS 15 and 20 bytes is 1.75 and 2.27 Mbps. The known SRS-symbols are used to update the Equalizer in the receiver. The degree of improvement achieved for a given SRS-N byte will depend on a particular Equalizer design.

TABLE 3
Recommended SRS-N bytes

| | | | |
|---|---|---|---|
| SRS Mode | Choice 1 | Choice 2 | Choice 3 |

| | | | | | | |
|---|---|---|---|---|---|---|
| SRS-bytes | 10 | bytes | 15 | bytes | 20 | bytes |
| Length N_{SRS} | | | | | | |
| Payload Loss | 1.43 | Mbps | 1.91 | Mbps | 2.38 | Mbps |

### 6.5.4 A-VSB Exciter

All TS packets issued by an Emission Multiplexer are assumed to have SRS placeholder bytes in adaptation fields for later SRS processing in the exciter. Before any processing in a exciter, all sync bytes of packets are eliminated.

It is very helpful to understand the detailed knowledge of the 8-VSB modulator components, and how they can be leveraged to make SRS work.

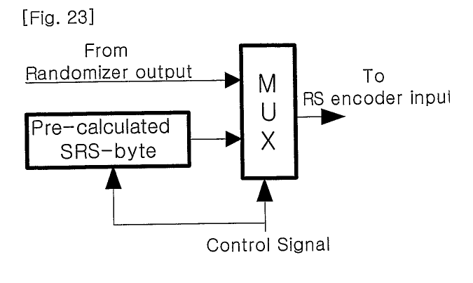

The basic operation of the SRS stuffer is to stuff the SRS bytes into the stuffing area of the adaptation field in each packet. In FIG. 23, the pre-defined fixed SRS-bytes are stuffed into the adaptation field of incoming packets by the control signal at SRS stuffing time. The control signal switches the output of the SRS stuffer to the pre-calculated SRS-bytes properly configured for insertion before the Interleaver. Note: Since the placeholders bytes serve no useful purpose between emission multiplexer and exciter and will be discarded and replaced by pre-calculated SRS bytes in exciter they will be used to create a high speed data channel to deliver A-VSB signaling and other data to the transmitter site. [TBD]

FIG. 24 depicts the packets carrying SRS-bytes in the adaptation field that previously contained the stuffing bytes (see FIG. 21)

The SRS stuffer needs to be careful not to overwrite a PCR or other standard adaptation field values when they are present in the adaptation field.

6.5.4.1 8-VSB Trellis Encoder Block with Parity Correction

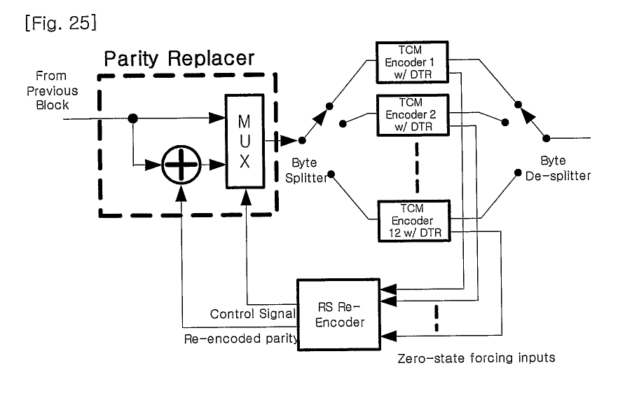

FIG. 25 shows the block diagram of the TCM encoder block with parity correction. The RS re-encoder receives zero-state forcing inputs from TCM encoders with DTR in FIG. 7. The message word for RS-re-encoding is synthesized by taking all zero-bit word except the bits replaced by zero-state forcing inputs. After synthesizing a message word in this way, RS re-encoder calculates the parity bytes. As RS codes are linear codes, any codeword given by the XOR operation of two valid codewords is also a valid codeword. When the parity bytes to be replaced arrive, genuine parity bytes are obtained by the XOR operation of the incoming parity bytes and the parity bytes computed from the synthesized message word. For example, assume that an original codeword by (7, 4) RS code is [M1 M2 M3 M4 P1 P2 P3] (Mi means a message byte and Pi means a parity byte). The deterministic trellis reset replaces the second message byte (M2) with M5 and so the genuine parity bytes must be computed by the message word [M1 M5 M3 M4]. However the RS re-encoder received only the zero-state forcing input (M5) and synthesizes the message word with [0 M5 0 0]. Suppose that the parity bytes computed from the synthesized message word [0 M5 0 0] by the RS re-encoder is [P4 P5 P6]. Then since the two RS codewords of [M1 M2 M3 M4 P1 P2 P3] and [0 M5 0 0 P4 P5 P6] are valid codewords, the parity bytes of the message word [M1 M2+M5 M3 M4] will be the bitwise XORed value of [P1 P2 P3] and [P4 P5 P6]. M2 is initially set to 0, so that the genuine parity bytes of the message word [M1 M5 M3 M4] are obtained by [P1+P4 P2+P5 P3+P6]. This procedure explains the operation of Parity Replacer in FIG. 25.

The 12-way byte splitter and 12-way byte de-splitter shown in FIG. 25, which are described in ATSC document A/53 Part2. The 12 trellis encoders have DTR functionality providing the zero-state forcing inputs.

### 6.5.4.2 Adaptation Field Contents (SRS Bytes)

Table 4 defines the pre-calculated SRS-byte values reconfigured for insertion before the Interleaver. TCM encoders are reset at the first SRS-byte and the adaptation fields shall contain the bytes of this table according to the algorithm here. The shaded values in Table 4, ranging from 0 to 15 (4 MSB bits are zeros) are the first byte to be fed to TCM encoders (the beginning SRS-bytes). The 12 shaded values in Table 6 rows, after the Interleaver, becomes first SRS-byte for related 12-segments. Since there are (12) TCM encoders, there are (12) bytes in shade in each column except the column 1-3. At DTR, the 4 MSB bits of these bytes are discarded and replaced with the zero-state forcing inputs from FIG. 7. Then the state of TCM encoders becomes zero and TCM encoders are ready to receive SRS-bytes to generate 8 level symbols (SRS-symbols) which serve as a training symbol sequence in a receiver. This training sequence (TCM encoder output) is 8 level symbols, +/−{1, 3, 5, 7}. The SRS-byte values are designed to give the SRS-symbols which have a white noise-like flat spectrum and almost zero DC value (the mathematical average of the SRS-symbols is almost zero.)

Depending on the selected SRS-N bytes, only a specific portion of the SRS-byte values in Table 4 is used. For example, in the case of SRS-10 bytes, SRS byte values from 1st to 10th column in Table 4 are used. In the case of SRS-20 bytes, the byte values from 1st to 20th column are used. Since the same SRS-bytes are repeated at every 52 packets (a sliver), the table in Table 4 has values for only 52 packets.

TABLE 4
Pre-calculated SRS Bytes to be stuffed into adaptation fields

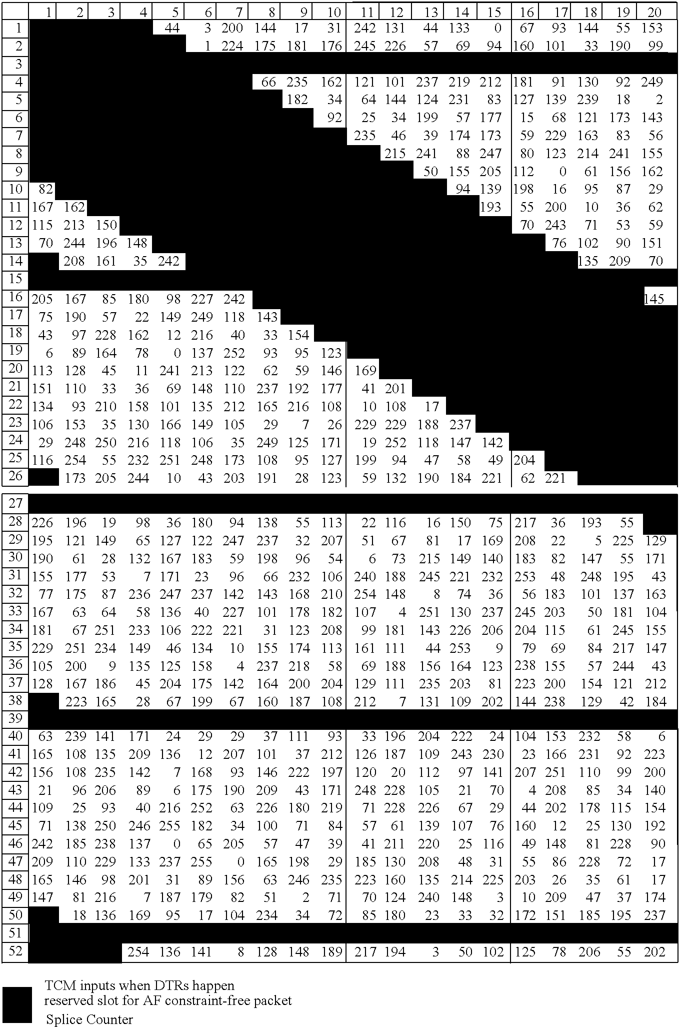

6.5.5 Advanced SRS—A variant of SRS

### 6.5.5.1 Description

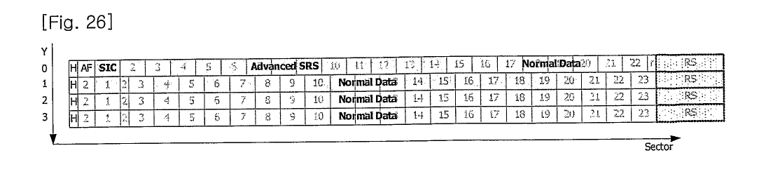

The basic idea of A-SRS is to more uniformly spread the equalizer reference sequence through the VSB frame. In order to do so, A-SRS-bytes are inserted into one packet per track and occupy a cluster of 13 sectors. FIG. 26 shows how the A-SRS-bytes are specifically placed in a track.

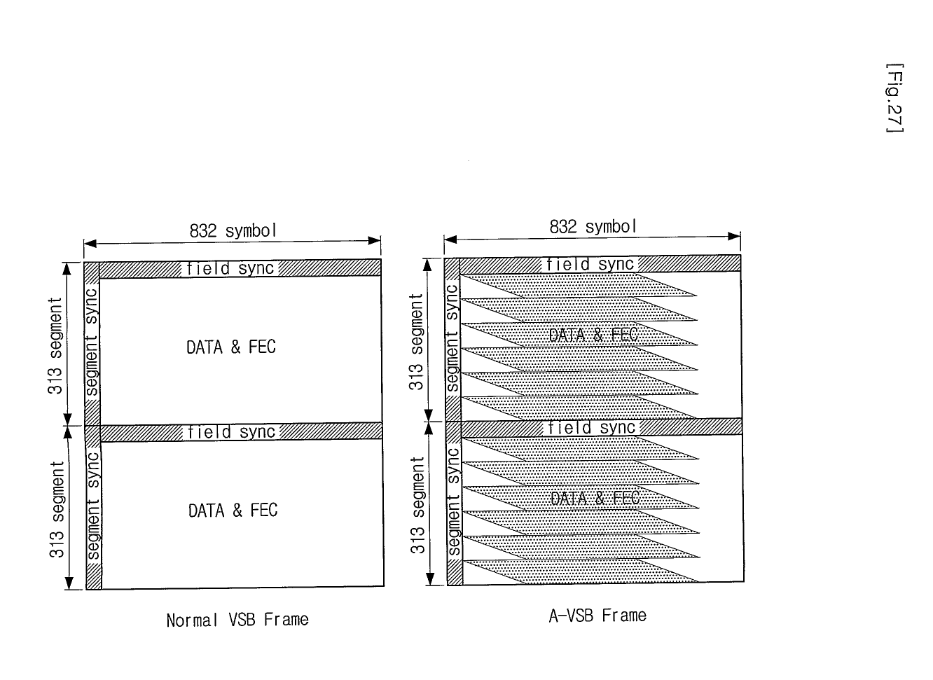

FIG. 27 shows the normal VSB frame on the left and an A-VSB frame on the right with A-SRS. Each A-VSB frame has 12 groups of SRS 8-level symbols. Each group is in 52 sequential data-segments. The 12 (green) groups stand for the A-SRS-symbols for the use of training sequence. Note that the A-SRS provides 150 symbols of tracking sequences for 8 segments and 98 symbols of that for 44 segments per slice. Number of such segments (with known 150 or 98 contiguous A-SRS symbols) available per frame will be 312. These tracking sequences are less dense than a conventional SRS but more uniformly spread. They help a new A-SRS receiver's equalizer track dynamic changing channel conditions when objects in the environment or the receiver itself are in motion.

### 6.5.5.2 Advanced SRS Parity Correction

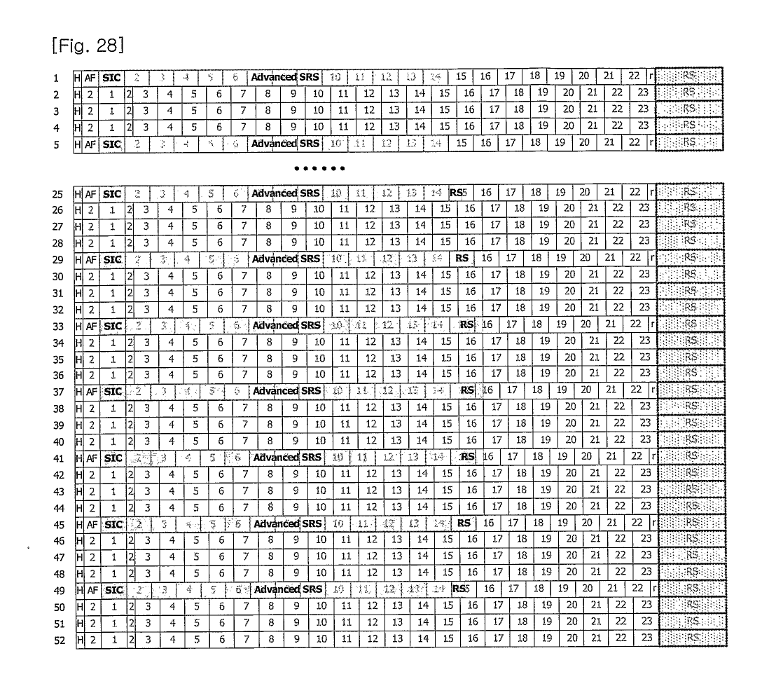

Since the DTR and that altering SRS-bytes occur after Reed-Solomon encoding in a exciter, previously calculated RS parity bytes are no longer valid. In order to correct these erroneous parity bytes, they are re-calculated and they replace the old parity-bytes. However, from the (A/53 Normal) byte-interleaving, all corresponding parity-bytes do not follow the DTR. Consequently, some bytes in 25th, 29th, 33th, 37th, and 41th packets are reserved for parity correction. FIG. 28 depicts a sliver template for A-SRS. The reserved bytes for RS parity correction are shown in the last packets.

### 6.5.5.3 Advanced SRS Choices

Similar to the case of SRS, there are three different A-SRS choices. First one is presented in the previous sections. In second one, adjacent training symbols are apart from 6 symbol distance and the last one has 12 symbol distance between adjacent symbols.

### 6.5.6 SRS Signaling in the VFIP

When SRS Bytes are present, the VFIP packet shall be extended as defined in Table 5

TABLE 5
VFIP with SRS Packet Syntax

| | | |
|---|---|---|
| Syntax | # of Bits | mnemonic |

VFIP_omp_packet( ) {

| | | |
|---|---|---|
| transport_packet_header | 32 | bslbf |
| OM_type | 8 | bslbf |

| | | |
|---|---|---|
| reserved | 8 | uimsbf |
| srs_bytes | 26*8 | uimsbf |
| srs_mode | 8 | uimsbf |
| private | 155*8 | uimsbf |

transport_packet_header—as defined and constrained by ATSC A/110A, Section 6.1.

OM_type—as defined in ATSC A/110, Section 6.1 and set to 0x30.

srs_bytes—as defined in Section 6.5.4.2.

srs_mode—signals the SRS mode to the exciter and shall be as defined in

private—defined by application tools. If unused, shall be set to 0x00.

TABLE 6
SRS Mode Values

| srs_mode | Meaning |
|---|---|
| 0x00 | No SRS used |
| 0x01 | SRS-10 bytes |
| 0x02 | SRS-15 bytes |
| 0x03 | SRS-20 bytes |
| 0x04-0xFF | ATSC Reserved |

### 6.6 Turbo Stream

### 6.6.1 Introduction

Turbo Stream is expected to be used in combination with SRS. The Turbo Stream is tolerant of severe signal distortion, enough to support other broadcasting applications. The robust performance is achieved by additional forward error corrections and Outer Interleaver (Bit-by-Bit interleaving), which offers additional time-diversity.

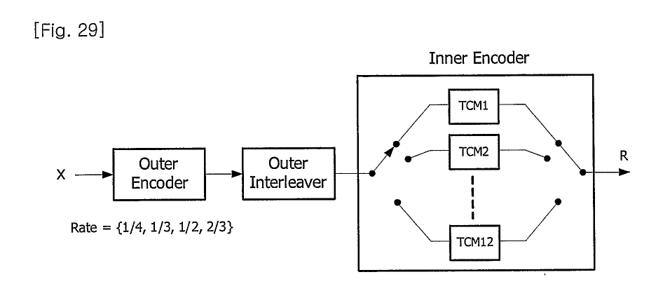

The simplified functional A-VSB Turbo Stream encoding block diagram is shown in FIG. 29. The Turbo Stream data are encoded in the Outer Encoder and bit-wise-interleaved in the Outer Interleaver. The coding rate in the Outer Encoder can be selectable among {1/4, 1/3, 1/2, 2/3} rates. Then, the interleaved data are fed to the Inner Encoder, which has 12-way data splitter for the (12) TCM encoders input, and 12-way data de-splitter at outputs. The (de-)splitter operation is defined in ATSC Standard A/53 Part 2.

Since the Outer Encoder is concatenated to the Inner Encoder through the Outer Interleaver, this implements an iteratively decodable serial Turbo Stream encoder. This scheme is unique and ATSC specific in the sense that the Inner Encoder is already a part of the 8-VSB system. By virtue of the A-VSB core element DF and by applying cross layer mapping techniques by placing robust bytes in defined locations in TS packets the normal ATSC Inner Encoder is deterministically time division multiplexed (TDM) to carry Normal or Robust symbols. This cross layer approach enables an A-VSB receiver to perform a partial reception technique by identifying the robust symbols at the physical layer and demodulating just the robust symbols it needs and ignoring all normal symbols. All normal ATSC receivers continue to treat all symbols as normal symbols and thus ensure backward compatibility. This cross layer TDM technique eliminates the need for a second and therefore separate inner encoder to realize an ATSC turbo encoder. This design enables a significant bit savings by sharing (TDM) the existing ATSC inner encoder at the physical layer as part of the new A-VSB Turbo encoder. Note: Other designs that totally de-couple the new proposed turbo encoder from the 8-VSB physical layer will offer no opportunity for bit efficiency in encoding since two (2) new encoders must be introduced. The partial reception capability will also have benefits when used as part of a power saving scheme for battery powered receivers. Only two blocks (the Outer Encoder and the Outer Interleaver) are newly introduced in the A-VSB Turbo Stream encoder.

### 6.6.2 System Overview

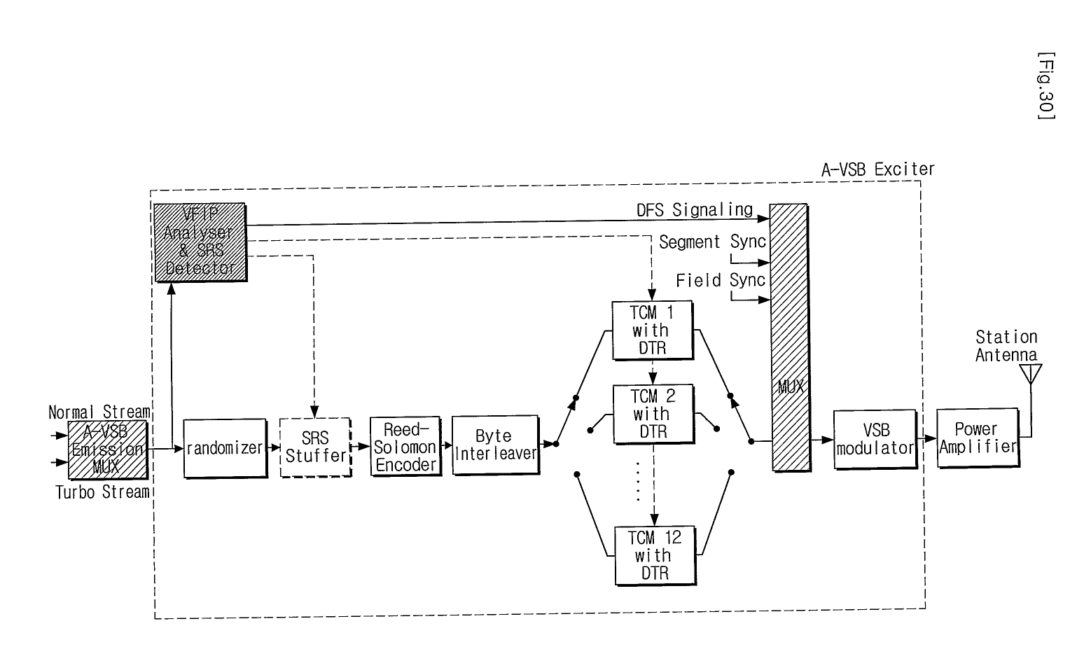

The A-VSB transmitter for Turbo stream is composed of the A-VSB Mux and exciter as shown in FIG. 30. The necessary Turbo coding process is done in the A-VSB Mux and then the coded stream is delivered to the A-VSB exciter.

The A-VSB MUX receives a normal stream and Turbo Stream(s). In The A-VSB Mux, after being pre-processed, each Turbo stream is outer-encoded, outer-interleaved and are encapsulated in the adaptation field of the normal stream.

There is no special processing needed in the A-VSB exciter for Turbo stream operation it is the same as that of aNormal ATSC A/53 Exciter. The A-VSB exciteris a synchronous slave of the emission multiplexer (DF) and the cross layer TDM of the robust symbols will occur in the inner ATSC encoder with no knowledge needed of Turbo Stream in exciter except for DFS signaling. Hence no added complexity is spread into the network for Turbo Stream all turbo processing is in one central location in the A-VSB Emission Multiplexer. In the A-VSB exciter, an ATSC A/53 Randomizer drops sync bytes of TS packets from an A-VSB Mux and randomizes them. The SRS stuffer in FIG. 30 is active only when SRS is used. The use of SRS with Turbo Stream is considered later. After being encoded in (207, 187) Reed-Solomon code, MPEG data stream are byte-interleaved. The byte interleaved data are then encoded by the TCM encoders.

An A-VSB Multiplexer has to notify the corresponding exciter of the necessary information (DFS signaling). The VFIP (VSB Frame Initialization Packet) includes this information.

Note: If SRS is used a high speed data channel can carry signaling to exciter.

The information is conveyed to a receiver through the reserved space in the data field sync.

### 6.6.3 A-VSB Multiplexer for Turbo Stream

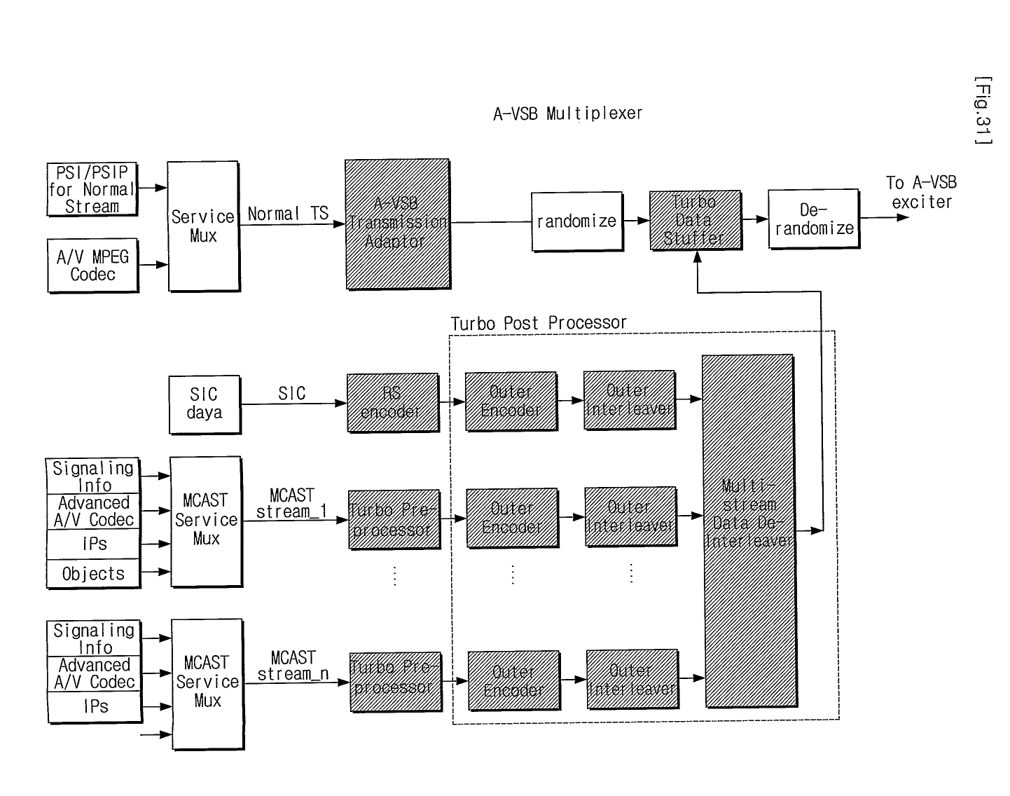

A-VSB Multiplexer for Turbo Stream is shown in FIG. 31. There are new blocks, Transmission Adaptor (TA), Turbo Pre-processor, Outer encoder, Outer interleaver, Multi-stream Data De-interleaver and Turbo-packet Stuffer. An A-VSB Transmission Adaptor recovers all elementary streams from the normal TS and re-packetizes all elementary streams with adaptation fields in every 4th packets, which serves as Turbo stream packet placeholders.

In the Turbo pre-processor, the MCAST packets are RS-encoded and Time-interleaved. Then, the time-interleaved data are expanded by the Outer-encoder with a selected code rate and Outer-interleaved.

Multi-stream Data De-interleaver provides a sort of ATSC A/53 Data De-interleaving function for multi-stream. The Turbo data Stuffer simply puts the multi-stream data de-interleaved data into the AF of A/53 Randomized TA output packets. After A/53 De-randomized, the output of Turbo data stuffer results in the output of A-VSB Multiplexer.

### 6.6.3.1 A-VSB Transmission Adaptor (TA)

A Transmission Adaptor (TA) recovers all elementary streams from the normal TS and re-packetizes them with adaptation fields in every 4th packet to be used for placeholders of the SRS, SIC (SIC(Signaling Information Channel) is a kind of Turbo stream to be used for the signaling information transmission.), and Turbo-coded MCAST Stream. The exact behavior of TA depends on the chosen sliver template.

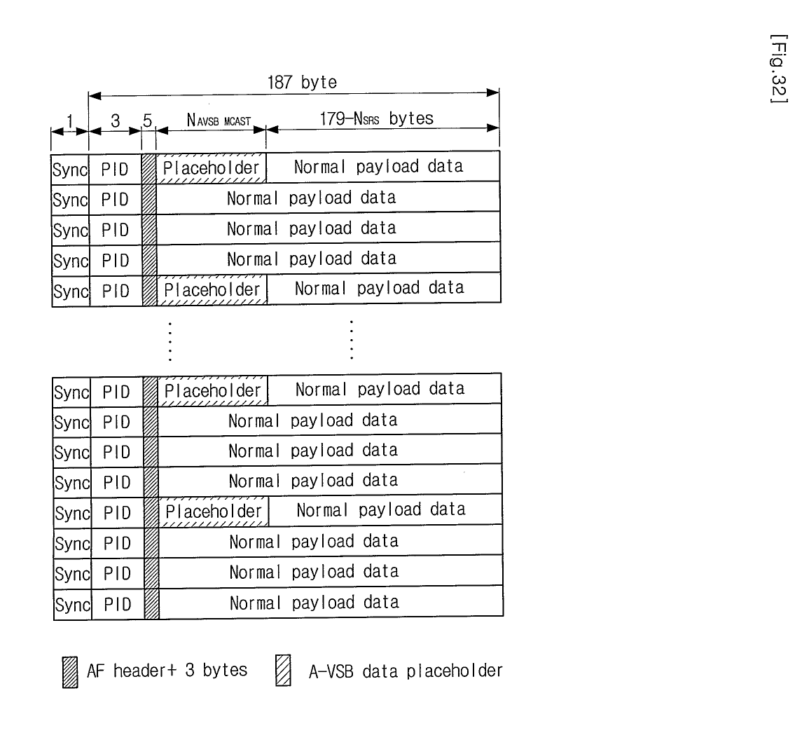

FIG. 32 shows the snapshot of TA output with the adaptation field placed in every 4th packet. Since 1 package contains 312 packets, there are 78 packets which are forced to have AF for A-VSB data placeholders.

### 6.6.3.2 Sliver Template for Turbo Stream

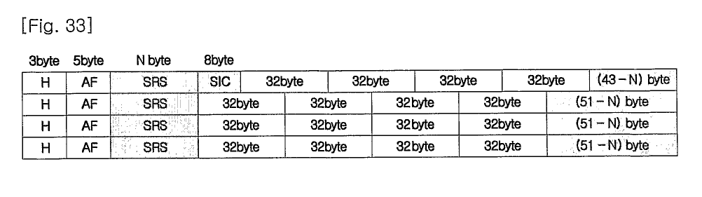

A VSB track is defined as 4 MPEG data packets. The reserved 8 byte space in AF for Turbo stream is called sector. A group of sectors is called a cluster. FIG. 33 shows the segmentation and partitioning of 4 packets with 4 sectors (32 bytes). Since the Turbo stream mapping into a cluster repeats every 4 packets, it suffices to define the Turbo stream mapping within 4 packets. Let a cluster be defined as a multiple of 4 sectors (32 bytes). There exist 4 or 5 clusters in a MPEG data packet depending on the length of SRS (NSRS). Each Turbo stream occupies a cluster of a {1, 2, 3, 4} multiples of 32 bytes. The cluster size determines the normal TS overhead for Turbo stream. An outer encoder code rate {1/4, 1/3, 1/2, 2/3} determines the Turbo stream data rate with a cluster size. When a MPEG data packet is entirely dedicated for A-VSB data (Turbo stream and SRS), a null packet, A/90 data packet, or a packet with a newly defined PID is used to save 2 bytes of AF header and 3 bytes private field overhead.

Table 7 summarizes the Turbo Stream modes which are defined from a VSB cluster size and a code rate. The length of reserved bytes for Turbo streams (N_{Tstream}) is 32 bytes* M and determines the normal TS payload loss. For example, when M=4 or equivalently N_{Tstream}=128 bytes, normal TS loss is

$$\frac{128 \cdot 78 \cdot 8 ( bits )}{24.2 ( ms )} = 3.30 Mbps$$

In Table 7 there are many modes defined by an outer encoder code rate and a cluster size. The combination of these two parameters is confined to (4) code rates (2/3, 1/2, 1/3, 1/4) and four adaptation field lengths (N_{Tstream}): 32, 64, 96, and 128 bytes. This result in 15 effective Turbo Stream data rates because 128 bytes of a Turbo fragment is excluded in the 2/3 code rate. Including the mode where the Turbo Stream is switched off, there are 16 different modes.

The first byte of the first Turbo stream packet will be synchronized to the first byte in the AF area in a template. The number of encapsulated Turbo TS packets in a package (312 MPEG data packets) is the “# of MCAST packets in package” in Table 7.

TABLE 7
Normal TS Loss by Turbo TS Rate and Code Rate

| # of MCAST packets | Turbo TS | Normal TS Loss (kbps) | | | | | | | |
|---|---|---|---|---|---|---|---|---|---|
| in package (NT) | Rate (kbps) | 2/3 (sector) | | 1/2 (sector) | | 1/3 (sector) | | 1/4 (sector) | |
| 3 | 186.45 | | | | | | | 825.12 | (4) |
| 4 | 248.60 | | | | | 825.12 | (4) | | |
| 6 | 372.89 | | | 825.12 | (4) | | | 1,650.25 | (8) |
| 8 | 497.19 | 825.12 | (4) | | | 1,650.25 | (8) | | |
| 9 | 559.34 | | | | | | | 2,475.37 | (12) |
| 12 | 745.79 | | | 1,650.25 | (8) | 2,475.37 | (12) | 3,300.50 | (16) |
| 16 | 994.38 | 1,650.25 | (8) | | | 3,300.50 | (16) | | |
| 18 | 1,118.68 | | | 2,475.37 | (12) | | | | |
| 24 | 1,491.57 | 2,475.37 | (12) | 3,300.50 | (16) | | | | |

Similar to the deterministic sliver for SRS, several pieces of information (such as PCR etc.) have to be delivered through the adaptation field along with the Turbo Stream data. In case of SRS, there are 4 fixed packet slots for constraint-free packets. On the contrary, the deterministic sliver for Turbo stream allows more degree of freedom for constraint-free packets location because all packets carrying no Turbo stream bytes can be any form of packets.

However, a Turbo stream sliver together with SRS has the same constraints as a SRS sliver.

The parameters for Turbo Stream decoding shall be known to a receiver by the DFS and SIC signaling schemes. They are a Turbo stream mapping, an outer encoder code rate for each Turbo stream.

### 6.6.3.3 MCAST Service Multiplexer

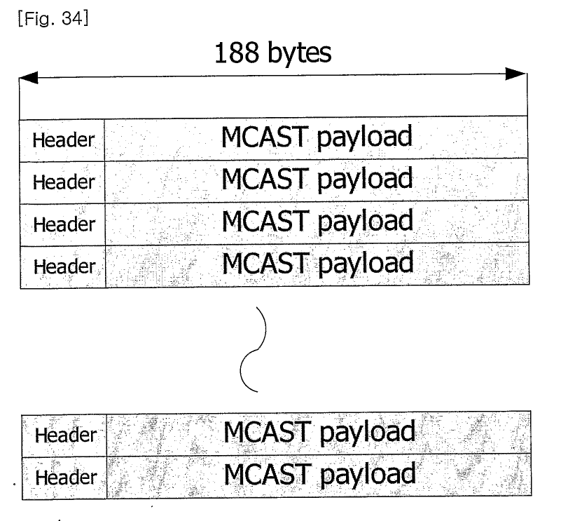

The MCAST Service Multiplexer block multiplexes the encapsulated A/V stream, IPs, and objects. FIG. 34 shows a snapshot of its output stream which is the output of Transport layer and the input to the Link layer. A MCAST packet has 188 bytes of length and its detail syntax is defined in ATSC-MCAST.

### 6.6.3.4 Turbo Pre-Processor

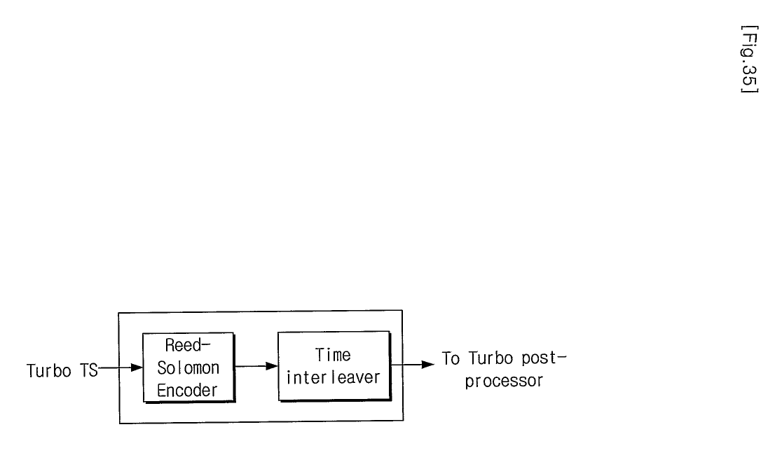

The Turbo Pre-processor block is depicted in FIG. 35. First of all, the Turbo TS packets are encoded by (208, 188) systematic RS encoder and then go through a long time interleaver. The time interleaver spreads the RS encoded MCAST packets to improve system performance in the burst noise channel environment. As an exception, SIC does not go through a time interleaver because the time delay induced by a time interleaver is not desirable for SIC.

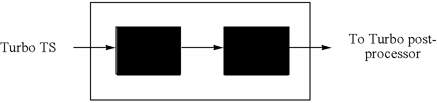

### 6.6.3.4.1 Reed-Solomon Encoder

The MCAST stream and SIC is encoded with the (208, 188) systematic RS code.

### 6.6.3.4.2 Time Interleaver

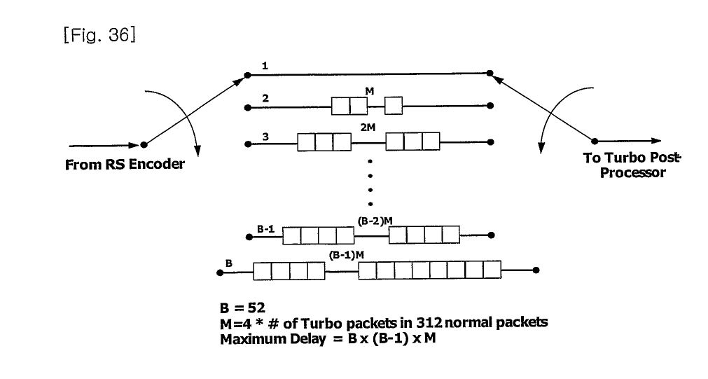

The Time Interleaver in FIG. 36 is a type of the convolutional byte interleaver which is shown in FIG. 36. The number of branches (B) is fixed to 52 while the basic memory size (M) varies with the number of MCAST packets delivered in a package, so that the maximum interleaving depth is constant regardless of the number of MCAST packets contained in every package.

The maximum delay is Bx(B-1)xM. Given the number of MCAST packets (NT) per package and the basic memory size (M) equal to NT*4, the maximum delay becomes Bx(B-1)xM=51x208xNT bytes. Since 208xNT bytes are transmitted in each field, the bytes of a MCAST packet is spread over 51 fields in all Turbo stream transmission rates which corresponds to 1.14 second of the interleaving depth.

The Time Interleaver shall be synchronized to the first byte of the data field. The Table 8 shows the basic memory size for the number of MCAST packets contained 312 normal packets.

The delay induced by the Time interleaver can be undesirable for some applications such as an adaptive time slicing. So the Time interleaver is left as an option for such applications.

TABLE 8
Basic Memory Size in Time Interleaver

| Data rate | # of MCAST Packets | Basic Memory | Maximum delay | Interleaving |
|---|---|---|---|---|
| (Kbps) | per package (NT) | size (M) | in bytes | depth in field |
| 186.5 | 3 | 12 | 31824 | 51 |
| 248.6 | 4 | 16 | 42432 | 51 |
| 372.9 | 6 | 24 | 63648 | 51 |
| 497.2 | 8 | 32 | 84864 | 51 |
| 559.4 | 9 | 36 | 95472 | 51 |
| 745.9 | 12 | 48 | 127296 | 51 |
| 994.5 | 16 | 64 | 169728 | 51 |
| 1118.0 | 18 | 72 | 190944 | 51 |
| 1491.0 | 24 | 96 | 254592 | 51 |

### 6.6.3.5 Turbo Post-Processor

The block diagram of Turbo post-processor is identified in FIG. 29. The one block of the pre-processed MCAST Stream data bytes are collected and then the Outer encoder adds the redundancy bits. Next, the Outer-encoded MCAST Stream data are interleaved in the Outer Interleaver in bit by bit for one block of Turbo post-process. After Multi-stream Data De-interleaved, the resulting data are fed to the Turbo data stuffer which puts the Turbo-coded MCAST Stream (Turbo stream) data bytes into the AF of A/53 Randomized TA output packets.

### 6.6.3.5.1 Outer Encoder

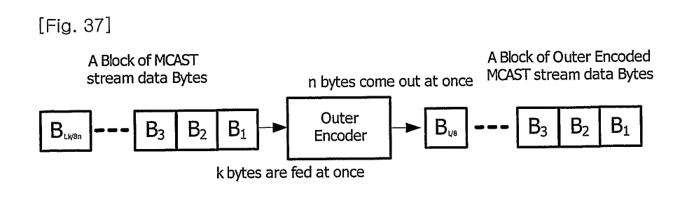

The outer encoder in the Turbo processor is depicted in FIG. 37. It receives a block of MCAST Stream data bytes (L/8 bytes=L bits) and produces a block of outer encoded MCAST Stream data bytes. It operates on a byte basis. So k bytes enter the outer encoder and n bytes come out when the selected code rate is k/n.

The choice of the encoding block size (L) is shown in Table 9 where the variable “Tx” is the transmitter version number. “Tx” is set to 0 when it is not explicitly specified. The operation with “Tx=1” is described in Section 6.6.5. The transmitter version number is signaled to receivers through DFS and SIC.

TABLE 9
Outer Interleaver Block Size by Cluster Size

| | Cluster Size | | Outer Interleaver | Outer Interleaver |
|---|---|---|---|---|
| | In Bytes | Normal TS | Block (L bits) | Block (L bits) |
| # of Sectors | per slivers | Loss (Mbps) | at Tx = 1 | at Tx = 0 |
| 4 | 2496 | 0.8252 | 3328 | 19968 |
| 8 | 4992 | 1.6504 | 6656 | 39936 |
| 12 | 7488 | 2.4757 | 9984 | 59904 |
| 16 | 9984 | 3.3009 | 13312 | 79872 |

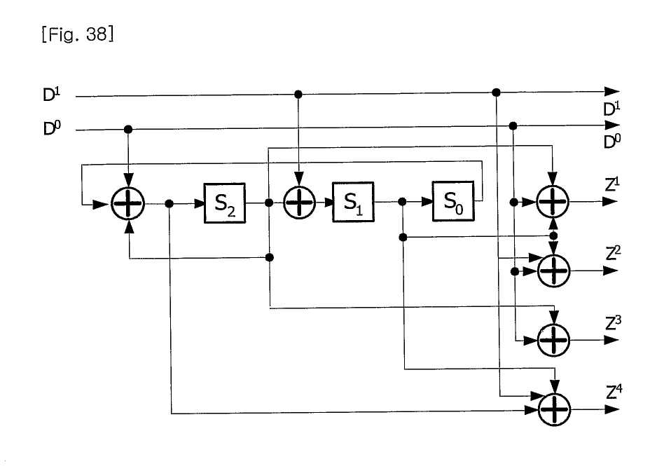

The outer encoder is shown in FIG. 38. It can receive 1 bit)(D⁰) or 2 bit (D¹D⁰) and produces 3 bits˜6 bits. At the beginning of a new block, the Constituent Encoder state is set to 0. No trellis-terminating bits are appended at the end of a block. Since the block size is relatively long, it doesn't deteriorate the error-correction capability too much. Possible residual errors are corrected by the RS code applied in the Turbo Pre-processor.

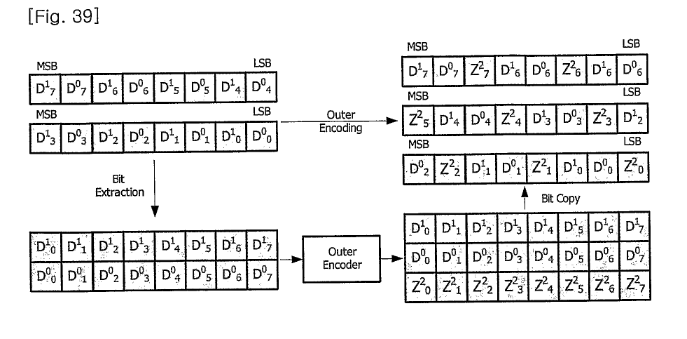

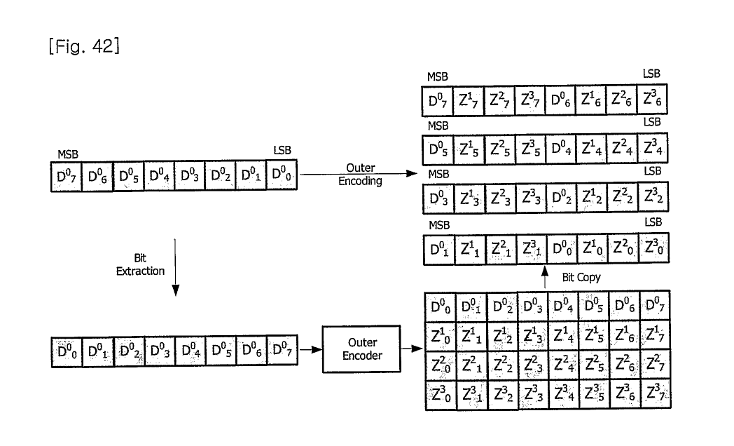

FIG. 39˜FIG. 42 show how to encode. In the 2/3 rate mode, 2 bytes of bits are arranged to be put to the outer encoder and the 3 bytes from (D¹, D⁰, Z²) are organized to produce 3 bytes. In the 1/2 rate mode, 1 byte is put through D⁰ to the outer encoder and the two bytes obtained from (D⁰ Z¹) are used to produce 2 bytes output. In the 1/3 rate mode, 1 byte is fed to the encoder through D⁰ and 3 bytes are obtained from D⁰, Z¹, Z². In the 1/4 rate mode, 1 byte enter the encoder through D⁰ and 4 bytes are produced from D⁰, Z¹, Z², Z³. The top byte is processed at first and the next top byte is processed as the input to the encoder. Similarly, the top byte precedes the next top byte at the output of the encoder in FIG. 39˜FIG. 42.

### 6.6.3.5.2 Outer Interleaver

The outer bit interleaver scrambles the outer encoder output bits. The bit interleaving rule is defined by a linear congruence expression as follows

Π(i)=(P·i+D_{(i mod 4)})mod L

For a given interleaving length (L), this interleaving rule has 5 parameters (P, D0, D1, D2, D3) which is defined in Table 10.

TABLE 10
Interleaving Rule Parameters (TBD in blanks)

| L | P | D0 | D1 | D2 | D3 |
|---|---|---|---|---|---|
| 79872 | 485 | 0 | 0 | 0 | 1940 |
| 59904 | | | | | |
| 39936 | 265 | 0 | 0 | 0 | 1060 |
| 19968 | | | | | |
| 13312 | 81 | 0 | 0 | 2916 | 12948 |
| 9984 | | | | | |
| 6656 | 45 | 0 | 0 | 5604 | 5648 |
| 4992(SIC) | | | | | |
| 3328 | | | | | |

Each Turbo Stream mode specifies the interleaving length (L) as shown in Table 7. For example, when the interleaving length L=13312 is used, the Outer Interleaver takes Turbo Stream data bytes 13312 bits (L bits) to scramble. Table 10 dictates the parameter set (P, D0, D1, D2, D3)=(81, 0, 0, 2916, 12948). The interleaving rule is generated by.

$$\prod ( i ) = \{ \begin{matrix}( 81 \cdot i ) mod 13312 \\ ( 81 \cdot i + 2916 ) mod 13312 \\ ( 81 \cdot i + 12948 ) mod 13312\end{matrix} \begin{matrix}i mod 4 == 0 , 1 \\ i mod 4 == 2 \\ i mod 4 == 3\end{matrix}$$

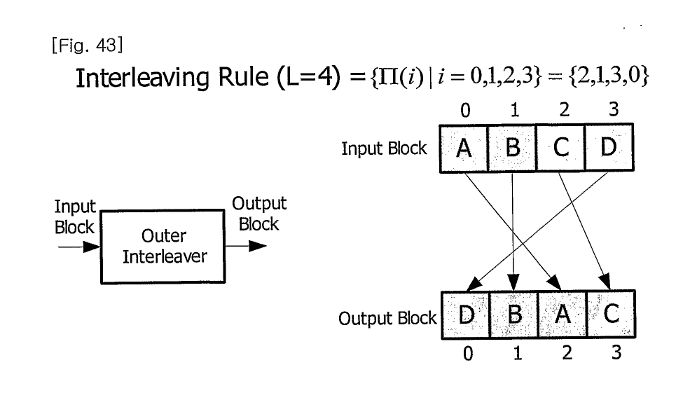

An interleaving rule is interpreted as “The i-th bit in the input block is placed in the Π(i)—the bit in the output block”. FIG. 43 shows an interleaving rule when the length is 4.

### 6.6.3.5.3 Multi-Stream Data Deinterleaver

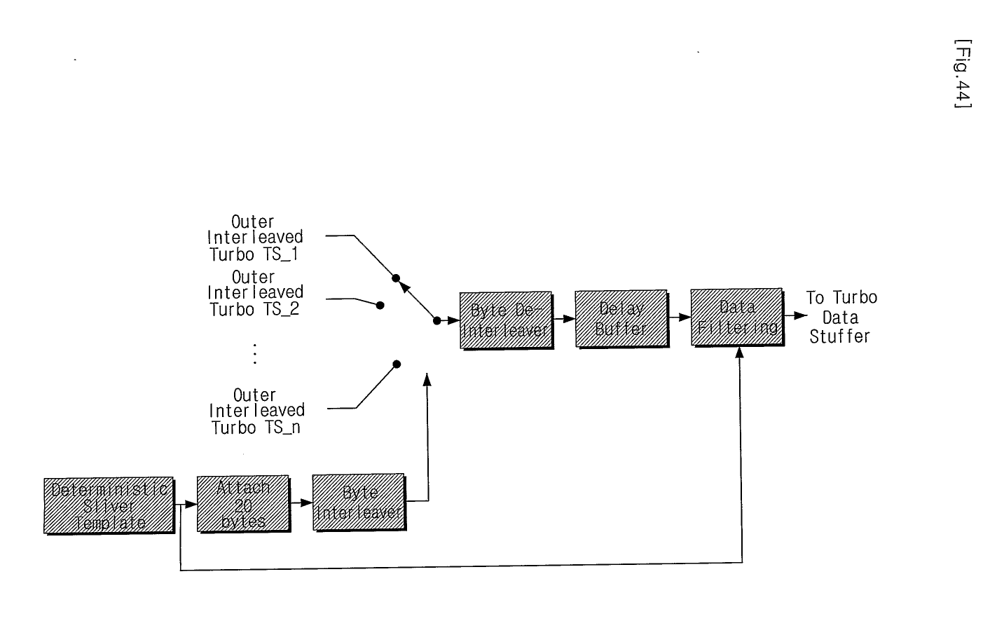

FIG. 44 shows the detail block diagram of Multi-stream data de-interleaver. According to the selected deterministic sliver template, multiplexing information is generated through 20 byte attacher and A/53 byte interleaver. After multiplexing Turbo stream bytes according to the generated multiplexing information, they are A/53 byte de-interleaved. Since ATSC A/53 byte Interleaver has the delay of 52x51x4 and one sliver consists of 207x52 bytes, 52x3=156 bytes of delay buffer is necessary to synchronize to the sliver unit. Finally, the delayed data corresponding to the reserved space in AF of the selected sliver template are output to the next block, Turbo data stuffer.

### 6.6.3.6 Turbo Data Stuffer

The operation of the Turbo data stuffer is to get the output bytes of the Multi Stream Data De-interleaver and put them sequentially in the AF made by TA as is shown in FIG. 30.

6.6.4 Turbo Stream Combined with SRS

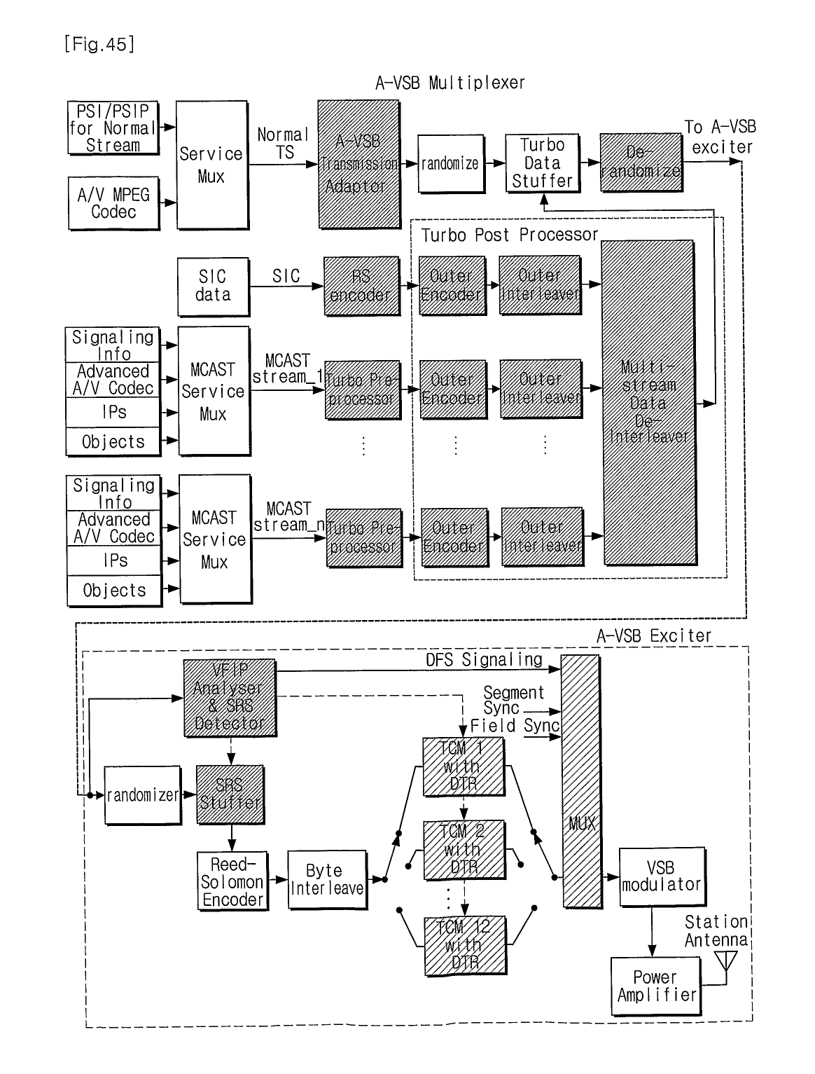

For clarity, the preceding explanation of the construction of the Turbo Stream was as if no SRS was present. However, the use of SRS is recommended. SRS is easily incorporated into Turbo Stream transmission system. FIG. 45 depicts the Turbo Stream in combination with SRS feature. It is just a simple combination of the two sliver templates shown in. The Turbo Fragment always follows the SRS-bytes. The Turbo stream mapping representation also shows the position of SRS in FIG. 33.

### 6.6.5 New Transmission Mode

A new transmission mode is devised for a reliable and efficient data transmission. This new mode is signaled through DFS and SIC with the parameter tx_version=1. The description other than this section is under the tx_version=0.

In this mode, Turbo stream data bytes occupy an entire normal MPEG data packet payload. Consequently, null packets, A/90 packets, or packets with a newly defined PID will be used.

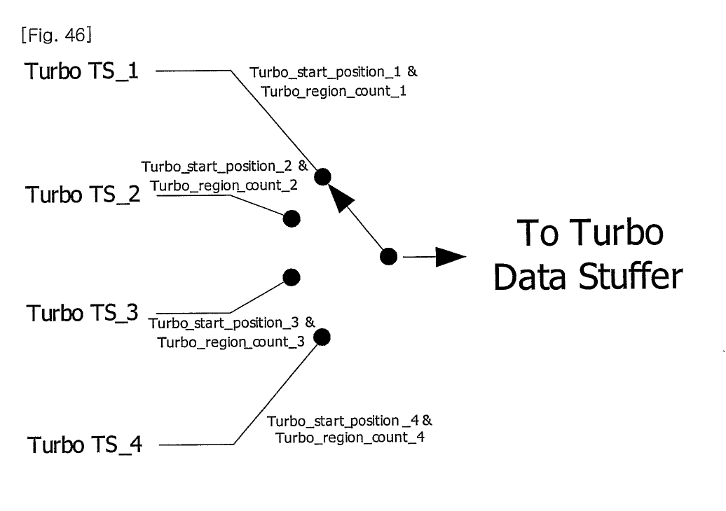

The Multi-stream Data De-interleaver in the A-VSB multiplexer is depicted in FIG. 46 when operating in the new transmission mode. The maximum 4 Turbo streams are allowed. The parameters, Turbo_start_position & Turbo_region_count indicate how to place the Turbo stream bytes into MPEG data packet payload area. They are signaled through SIC.

### 6.6.5.1 Stream Mapping to VSB Parcel

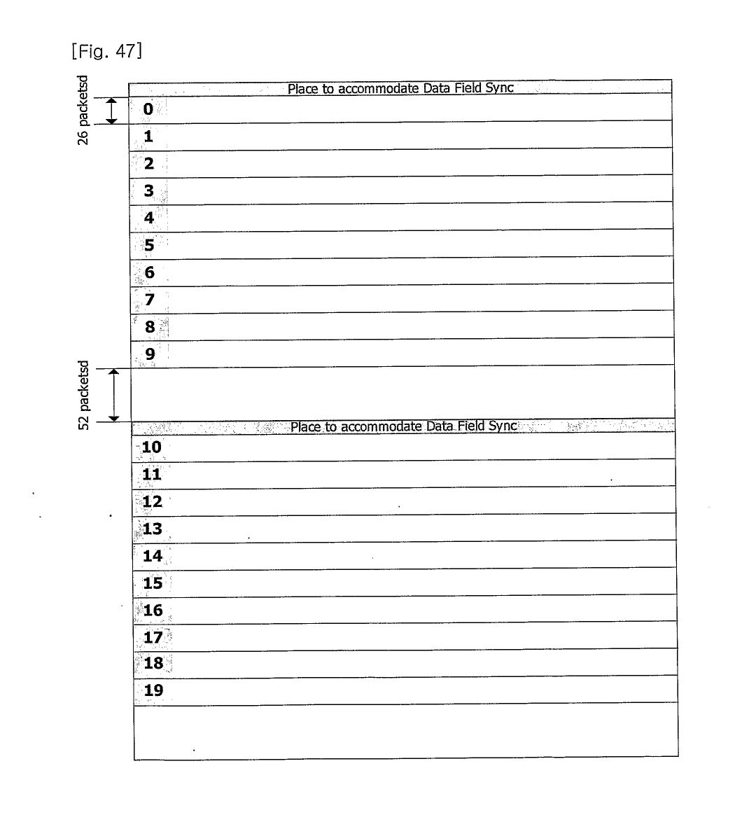

Consecutive 104 MPEG data packets every VSB parcel will carry Turbo stream bytes in this transmission mode. SRS and SIC are not affected in this mode. The consecutive 104 MPEG data packets are placed in a fixed location of a parcel as shown in FIG. 47 where the row number is the value of Turbo_start_position in SIC. The consecutive 104 MPEG data will be placed only at even-number-th position in FIG. 47.

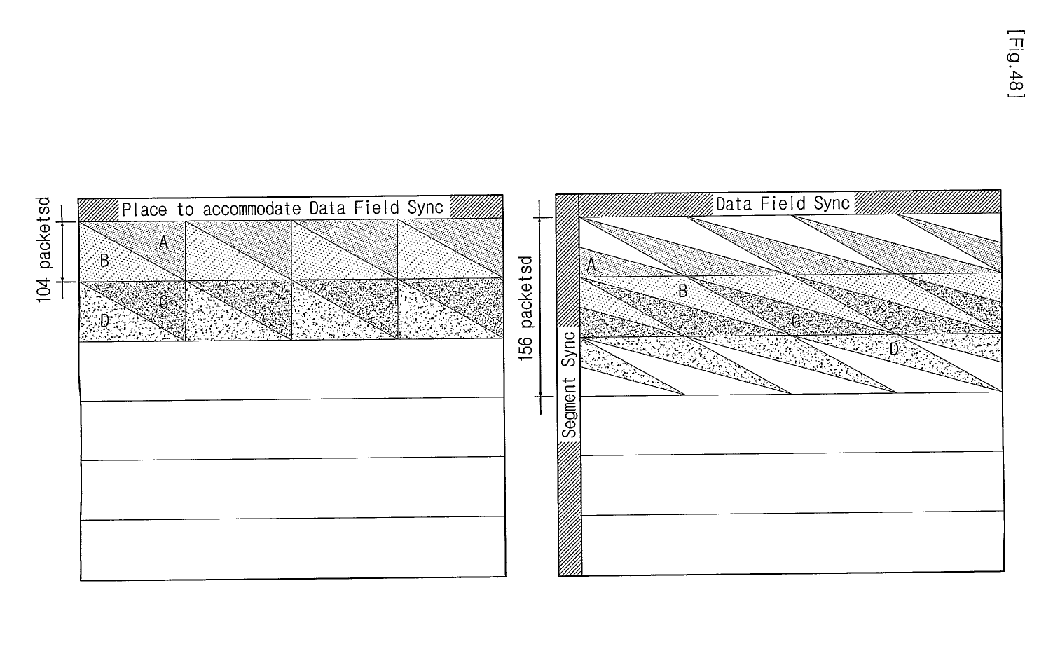

When the consecutive 104 packets for Turbo stream transmission are located in 0th row in FIG. 47, the Turbo stream symbols appears in a field as shown in FIG. 48 on the right. The A, B, C, and D in FIG. 48. represent the region painted with the same color. This region will be assigned to one of Turbo streams. Each Turbo stream occupies a region or a union of several regions. These relations are summarized in Table 11. The first stream can have 1, 2, or 4 as a “Turbo_region_count” parameter. When it is 1, The first stream specifies the region A. When it is 2, the union of region A and D will be the area where the first stream bytes are contained.

TABLE 11
Region Association to Streams

| Stream | Turbo_region_count | Formation |
|---|---|---|
| The first stream | 1 | A |
| | 2 | A + D |
| | 4 | A + B + C + D |
| The second stream | 1 | B |
| | 2 | B + C |
| The third stream | 1 | C |
| The fourth stream | 1 | D |

### 6.6.5.2 Necessary Signaling

In this transmission mode, each stream has the following information in SIC. (1) Turbo_start_position indicates a stream position which is a row number in FIG. 47. (2) Turbo_region_count associates the region(s) with stream together with Turbo_start_position. See Table 11 for more details. (3) Duplicate Flag means that the consecutive 104 MPEG data packets repeat twice in the transmission. At the start of each consecutive 104 packets, a DTR will occurs to reset the TCM states, so that the resulting symbols from the two same MPEG data packets are the same. These same symbols are useful to decode the transmitted data more reliably in a receiver. (4) coding rates is the Turbo stream code rate.

The DFS also include the mode-specific information which is Duplicate Indicator. It says if the consecutive 104 MPEG data packets included in the field is a duplicate of the previous packets or not.

### 6.7 Signaling Information

Signaling information that is needed in a receiver must be transmitted. There are two mechanisms for signaling information. One is through Data Field Sync and the other is via SIC (System Information Channel).

Information that is transmitted through Data Field Sync is Tx Version, SRS, and Turbo decoding parameters of Primary Service. The other signaling information will be transmitted through SIC.

Since SIC is a kind of usual Turbo stream, the signaling information in SIC passes through the exciter from an A-VSB Mux. On the other hand, the signaling information in DFS has to be delivered to the exciter from an A-VSB Mux through VFIP packet because a DFS is created while the exciter makes a VSB frame. There are two ways to do this communication. One is through the VFIP and the other is through the SRS-placeholder which is filled with SRS-bytes in the exciter.

6.7.1 DFS Signaling Information through the VFIP

When Turbo Stream bytes are present, the VFIP shall be extended as defined in Table 12. This is shown with SRS included.

Note: If SRS is used a high speed data channel can carry all signaling to exciter. TBD

If SRS is not included then the srs_mode field is set to zero (private=0x00).

TABLE 12
DF with SRS and Turbo Stream Packet Syntax

| | | |
|---|---|---|
| Syntax | # of Bits | mnemonic |

VFIP_omp_packet( ) {

| | | |
|---|---|---|
| transport_packet_header | 32 | bslbf |
| OM_type | 8 | bslbf |

| | | |
|---|---|---|
| reserved | 8 | uimsbf |
| srs_bytes | 26*8 | uimsbf |
| srs_mode | 8 | uimsbf |
| turbo_stream_mode | 8 | uimsbf |
| private | 154*8 | uimsbf |

transport_packet_header—as defined and constrained by ATSC A/110A, Section 6.1.

OM_type—as defined in ATSC A/110, Section 6.1 and set to 0x30.

srs_bytes—as defined in Section 6.5.4.2.

srs_mode—signals the SRS mode to the exciter and shall be as defined in

turbo_stream_mode—signals the Turbo Stream modes

private—defined by other applications or application tools. If unused, shall be set to 0x00.

### 6.7.2 DFS Signaling Information

### 6.7.2.1 A/53 DFS Signaling (Informative)

The information about the current mode is transmitted on the Reserved (104) symbols of each Data Field Sync. Specifically,

1. Allocate symbols for Mode of each enhancement: 82 symbols

A. 1st˜82 th symbol

2. Enhanced data transmission methods: 10 symbols
A. 83th˜84 th symbol (2 symbols): reserved
B. 85th˜92th symbol (8 symbols): Enhanced data transmission methods
C. On even data fields (negative PN63), the polarities of symbols 83 through 92 shall be inverted from those in the odd data field

3. Pre-code: 12 symbols

For more information, refer to the ATSC Digital Television Standard (A/53).

6.7.2.2 A-VSB DFS Signaling extended from A/53 DFS Signaling

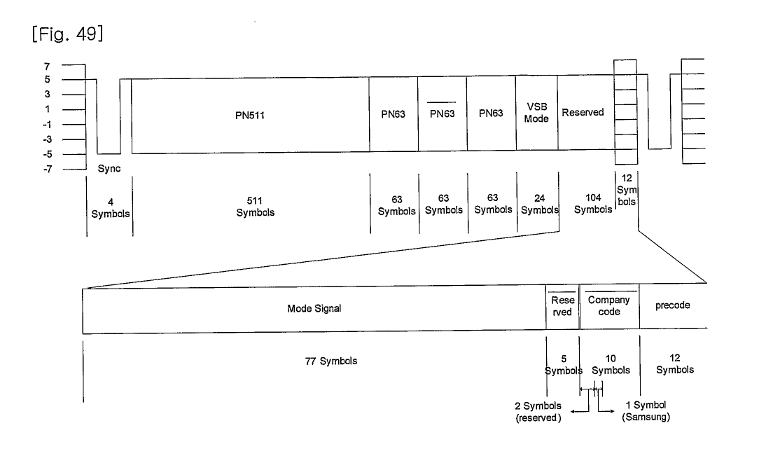

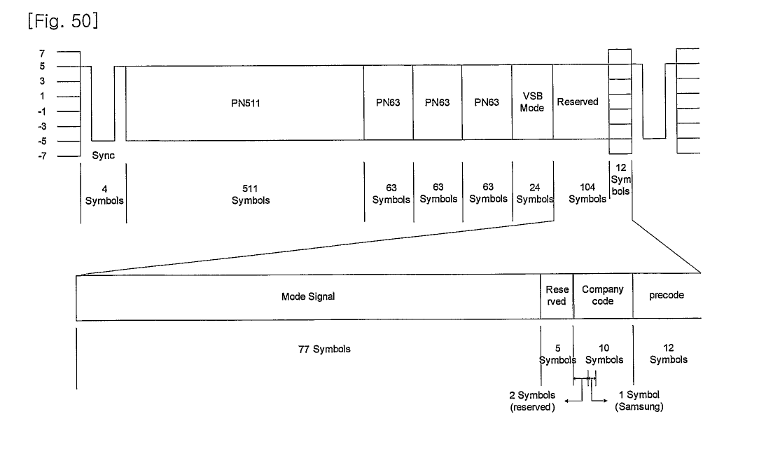

Signaling information is transferred through the reserved area of 2 DFS. 77 Symbols in each DFS amount to 154 Symbols. Signaling information is protected from channel errors by a concatenated code (RS code+convolutional code). The DFS structure is depicted in FIG. 49 and FIG. 50.

1) Allocation for A-VSB Mode

The mapping between a Value and an A-VSB mode is as follows.

Tx Version

TABLE 13
Mapping of Tx Mode

| Tx Version | Value |
|---|---|
| Tx Version 0 | 00 |
| Tx Version 1 | 01 |
| Reserved | 10~11 |

Tx Version 0

Information about Tx Mode (2 bits), Advanced SRS flag (1 bits), SRS (2 bits), Primary Service Mode (4 bits) are transmitted at Tx Version 1.

The mapping is as follows.

Advanced SRS flag

TABLE 14
Mapping of Scatter flag

| Item | Value |
|---|---|
| Conventional SRS | 0 |
| Advanced SRS | 1 |

SRS at conventional SRS

TABLE 15
Mapping of SRS @ Conventional SRS

| SRS Bytes per Packet | Value |
|---|---|
| 0 | 00 |
| 10 | 01 |
| 15 | 10 |
| 20 | 11 |

SRS at advanced SRS

TABLE 16
Mapping of SRS @ Advanced SRS

| Item | Value |
|---|---|
| 0 | 00 |
| Method 0 | 01 |
| Method 1 | 10 |
| Method 2 | 11 |

Mode of Primary Service

TABLE 17
Mapping of Turbo Stream Transmission Mode

| Cluster size in bytes | | Turbo Data Rate | # of MCAST Packets | |
|---|---|---|---|---|
| In every track | Turbo Code Rate | (kbps) | Per package | Value |
| 0 | — | — | | 0000 |
| 32 | 1/2 | 374 | 6 | 0001 |
| 32 | 1/3 | 249 | 4 | 0010 |
| 32 | 1/4 | 186 | 3 | 0011 |
| 64 | 1/2 | 374 | 12 | 0100 |
| 64 | 1/3 | 249 | 8 | 0101 |
| 64 | 1/4 | 186 | 6 | 0110 |
| 96 | 1/2 | 374 | 18 | 0111 |
| 96 | 1/3 | 249 | 12 | 1000 |
| 96 | 1/4 | 186 | 9 | 1001 |
| 128 | 1/2 | 374 | 24 | 1010 |
| 128 | 1/3 | 249 | 16 | 1011 |
| 128 | 1/4 | 186 | 12 | 1100 |

| | |
|---|---|
| Reserved | 1101~1111 |

Tx Version 1

Information about Tx Mode (2 bits), Advanced SRS flg (1 bits), SRS (2 bits), Duplicate indicator (1 bit) arwe transmitted at Tx Version 2.

### 1

The mapping is as follows.

Advanced SRS flag

TABLE 18
Mapping of SRS

| Item | Value |
|---|---|
| Conventional SRS | 0 |
| Advanced SRS | 1 |

SRS at conventional SRS

TABLE 19
Mapping of SRS @ Conventional SRS

| SRS Bytes per Packet | Value |
|---|---|
| 0 | 00 |
| 10 | 01 |
| 15 | 10 |
| 20 | 11 |

SRS at advanced SRS

TABLE 20
Mapping of SRS @ Advanced SRS

| Item | Value |
|---|---|
| 0 | 00 |
| Method 0 | 01 |
| Method 1 | 10 |
| Method 2 | 11 |

Duplicate Indicator

TABLE 21
Mapping of Duplicate Indicator

| Item | Value |
|---|---|
| The next is NOT | 0 |
| duplicated data | |
| The next is duplicated | 1 |
| data | |

2) Error Correction Coding for DFS Signaling Information

The DFS mode signaling information is encoded by a concatenation of a (6, 4) RS code and a 1/7 convolutional code.

R-S Encoder

The (6, 4) RS parity bytes are attached to Mode Information.

1/7 rate Tail-biting Convolutional Coding

(6, 4) R-S encoded bits are encode again by a 1/7 rate tail-biting convolutional code.

Symbol Mapping

The mapping between a Bit and Symbol is as Table 22.

TABLE 22
Symbol Mapping

| Value of Bit | Symbol |
|---|---|
| 0 | −5 |
| 1 | +5 |

Insert mode signaling symbols at Data Field Sync's Reserved areas

### 6.7.2.3 System Information Channel (SIC) Signaling

The SIC is identified in FIG. 31. SIC channel information is encoded and delivered through adaptation fields like Turbo streams. The reserved area for SIC repeats at the first sector of the first packet in every track and occupies 8 bytes (1 sector) in the adaptation fields of the first packet as seen in FIG. 12.

SIC information goes through the (208, 188) RS encoder and then the Turbo post processor. Contrary to the other Turbo streams, SIC doesn't pass through the time interleaver. 208 bytes of RS encoded bytes are transmitted in one VSB parcel that each package has 104 bytes of RS encoded data respectively. When going through post processor, each 104 bytes SIC information block is 1/6-rate outer encoded by repeating twice 1/3 rate outer encoder output. SIC encoding block spans 1 field whereas Turbo stream byte encoding block are 1 slice (tx_version=1) or 1 field (tx_version=0).

The outer coded SIC goes through outer interleaver of 4992 bits length and then is Data De-Interleaved by Multi-stream Data De-Interleaver with all Turbo stream bytes.

### 6.8 SFN System Overview (Informative)

When identical ATSC transport streams are distributed from a studio to multiple transmitters and when the channel coding and modulation processes in all modulators (transmitters) are synchronized, the same input bits will produce the same output RF symbols from all modulators. If the emission times are then controlled, these multiple coherent RF symbols will appear like natural environmental echoes to a receiver's equalizer and hence be mitigated and received.

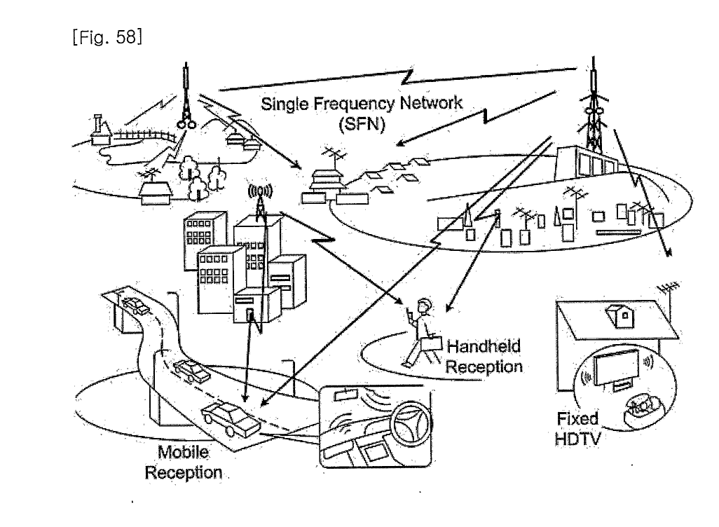

The A-VSB application tool, Single Frequency Network (SFN) offers the option of using transmitter spatial diversity to obtain higher and more uniform signal strength throughout and in targeted portions of a service area. An SFN can be used to improve the quality of service to terrain shielded areas, including urban canyons, fixed or indoor reception environments, or to support new ATSC Mobile and Handheld services this is depicted in FIG. 58.

The A-VSB application tool, SFN, requires several elements in each modulator to be synchronized. This will produce the emission of coherent symbols from all transmitters in the SFN and enable interoperability The synchronized elements are:

Frequency

Data Frame (locked to 1PPSF)

Pre-Coders/Trellis Coders

Emission Time

The frequency synchronization of all modulators' pilot frequencies and symbol clocks can be achieved by locking these to a universally available frequency reference such as the 10 MHz reference from a GPS receiver.

Data frame synchronization requires that all modulators choose the same packet from the incoming transport stream to start or initialize a VSB Frame. This requirement is synergistic with the A-VSB core element Deterministic Frame (DF). A special Operations and Maintenance Packet (OMP) known as a VSB Frame Initialization Packet (VFIP) is inserted once every 20 VSB data frames (Superframe) as the last, or 624th, packet in a frame, this as determined by a Superframe cadence counter in either an emission multiplexer or VFIP inserter which is referenced to 1PPSF (See section on ATSC System Time). All modulators slave their VSB data framing when VFIP appears in the transport stream.

Synchronization of all pre-coders and Trellis Coders in all exciters, known collectively as just Trellis Coders is achieved by leveraging the A-VSB core element Deterministic Trellis Reset (DTR) in a sequential fashion over the first 4 data segments in a Super Frame. The cross layer mapping applied in VFIP has byte 12 byte positions reserved for DTR to synchronize all trellis coders in all exciters in a SFN.

The emission time of the coherent RF symbols from all SFN transmitters is synchronized by the insertion of time stamps into the VFIP. These time stamps are referenced to a universally available temporal reference, e.g., the 1 Pulse per Second (1PPS) from a GPS receiver.

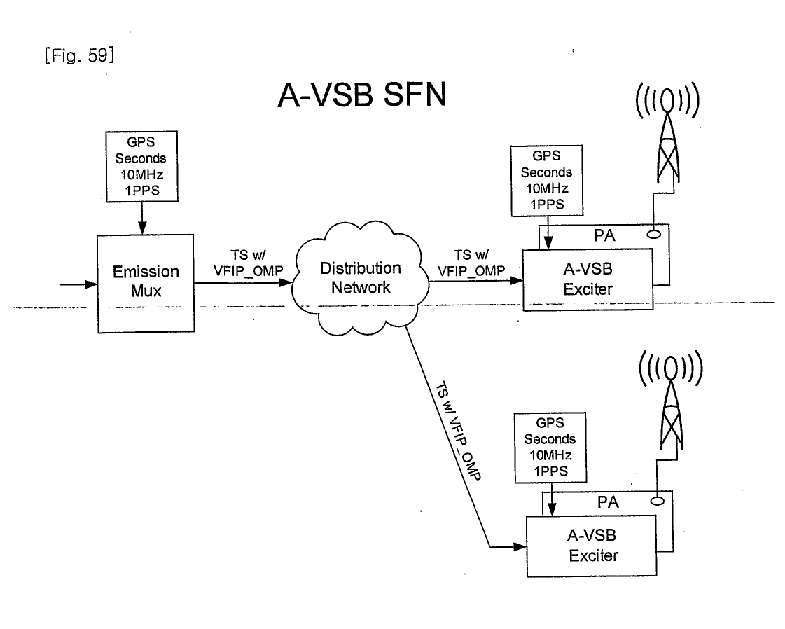

FIG. 59 shows an SFN with an emission multiplexer sending a VFIP to each transmitter in the SFN over a distribution network. This VFIP contains the needed syntax to create all the functionality needed for an A-VSB SFN, as described above.

### 6.8.1 Encoding Process

A brief overview is presented of how the core element DF is used to synchronize all VSB frames and how DTR is used to synchronize all Trellis Coders in all exciters in a SFN. This is followed by a discussion of how the emission timing is achieved to control the delay spread seen by a receiver, this is presented using a SFN timing diagram.

### 6.8.1.1 DF (Frame Synchronization, DTR (Trellis Coders Synchronization)

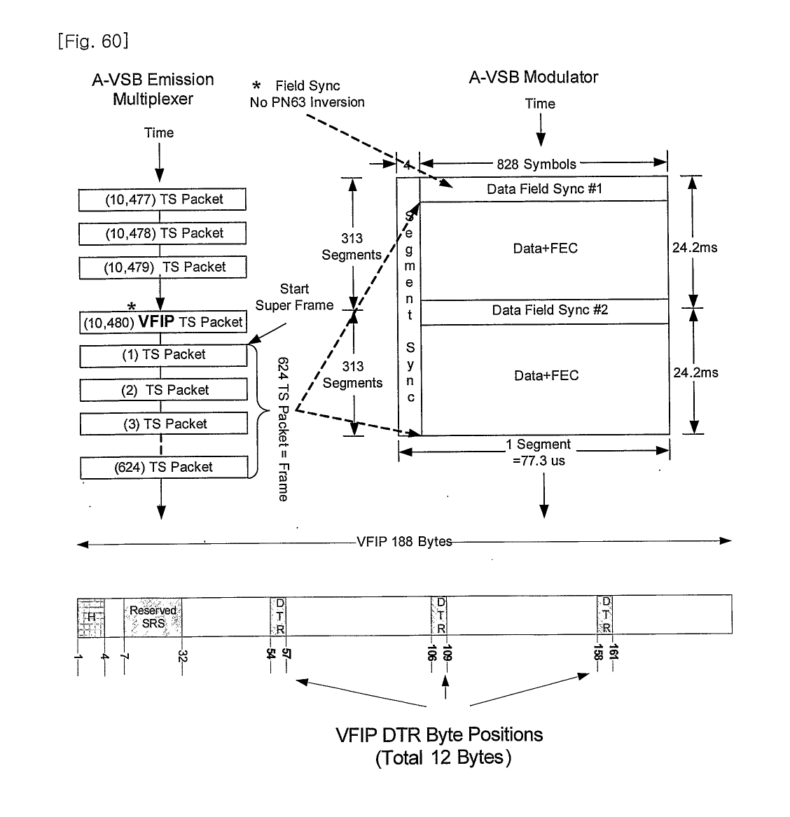

The VFIP is generated in a emission multiplexer and must be inserted as the last (624^{th}) packet in the last VSB frame of a Super Frame, that is exactly once every 10,480 TS packets. The insertion timing is determined by a super frame counter in the emission multiplexer which is locked to ATSC System Time. All exciters initialize or start a VSB Frame by inserting a DFS with no PN 63 inversion after the last bit of VFIP. This action will synchronize all VSB frames in all exciters in a SFN. This is shown in FIG. 60.

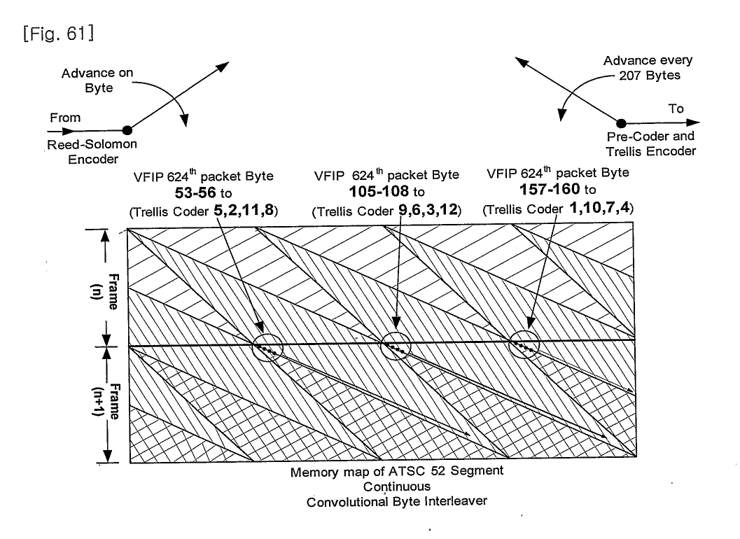

Synchronization of all (12) Trellis coders in all exciters uses cross layer mapping in a VFIP, which contains twelve DTR bytes in pre-determined byte positions, see FIG. 60. These DTR bytes are used to deterministically trigger a reset of each one of the (12) Trellis Coders in each exciter in a SFN to a common zero state at the same instant. The DTR is designed to occur in a sequential fashion over the first 4 data segments of the next super frame following the insertion of a VFIP. FIG. 61 shows the position of the DTR bytes in the ATSC 52-segment byte interleaver. The last 52 packets in Frame (n), with VFIP being the last (i.e., the 624th), are clocked as shown into the interleaver from the RS Encoder by the commutator on the left. The commutator on the right then reads out the bytes row-by-row and sends them to the intrasegment byte interleaver and then to the Trellis Coders. The middle horizontal line represents the frame boundary between Frames (n) and (n+1) start of next super frame. Notice that half of the bytes of the last 52 input packets remain in Frame(n) and the other half reside in Frame (n+1) when removed from the ATSC 52-segment byte interleaver. Note: The DTR byte position in the 52-segment interleaver appears to have been shifted one byte position this is because the segment sync has been stripped from TS packet.

The DTR bytes in VFIP are shown circled and reside in the first 4 data segments of (Frame n+1) beginning of next super frame when they are removed from interleaver. These DTR bytes are each sent to one of the 12 trellis coders, using the mapping shown. A Deterministic Trellis Reset (DTR) occurs upon arrival of each of the DTR byte at its respective targeted trellis coder. As a result of first framing using DF and now by the simultaneous deterministic trellis reseset (DTR) in all exciters within a network, coherent symbols will be produced from all transmitters.

In summary, the appearance of a VFIP will cause VSB frame synchronization, and the DTR bytes in VFIP are used to set each trellis coder to a zero state simultaneously in all exciters.

### 6.8.1.2 Emission Time Synchronization

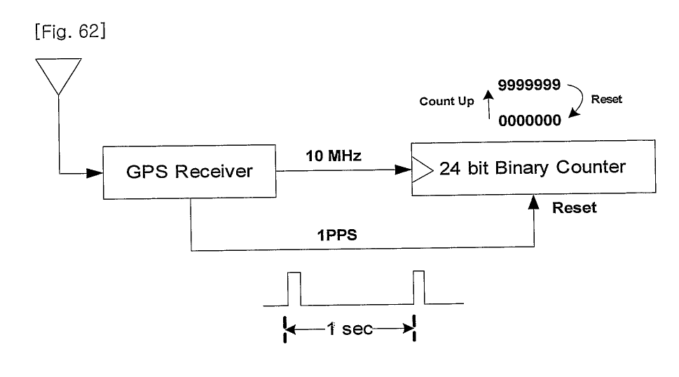

The emission times of the coherent symbols from all transmitters need to be tightly controlled so that their arrival times at a receiver don't exceed the delay spread or echo handling range of the receiver's equalizer. Transmitters can be located miles apart and will receive a VFIP over a distribution network (Microwave, Fiber, Satellite, etc). The distribution network has a different transit delay time on each path to a transmitter. This must be mitigated to enable a common temporal reference to control all emission timing in SFN. The 1PPS signal from a GPS receiver is used to create a common temporal reference in all nodes of the SFN, that is the emission multiplexer and all the exciters. This is shown in FIG. 62.

All nodes in the network have the equivalent of this circuit, a 24 bit binary counter driven by the GPS 10 MHz clock signal. The counter counts up from 0000000-9999999 in one-second intervals, then resets to 0000000 on the edge of the 1PPS pulse from the GPS receiver. Each clock tick and count advance is 100 nanoseconds. With the universal availability of GPS, this technique is easy to establish in all nodes in a network and forms the basis of all time stamps used to implement SFN emission timing.

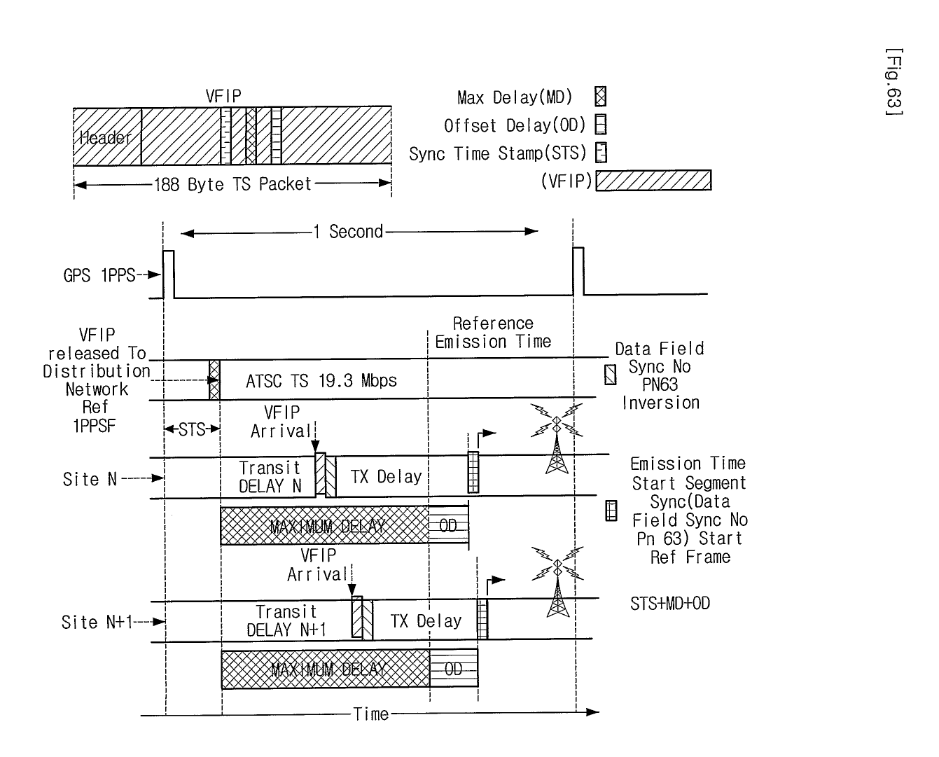

The VFIP (see Section 6.8.2) contains the syntax for three timestamps used to establish the basic emission timing needed in a SFN: sync_time_stamp (STS), maximum_delay (MD), and tx_time_offset (OD). FIG. 63 is an A-VSB SFN timing diagram (note use of STS, MD, and OD). All nodes have the 24-bit counter discussed above available as the temporal reference for all time stamps.

First, the different transit delay times on all distribution paths must be compensated to enable tight SFN timing control. The MD timestamp contains a pre-calculated time stamp value established by the SFN network designer based on the transit time delays of all paths. The MD value is calculated to be greater than the longest transit delay on any path of the distribution network. By selecting a time stamp value larger than the largest transit delay and by using a STS timestamp allows an input FIFO buffer delay to be established in each exciter equal to the MD value minus the actual transit delay experienced on the path to the exciter. This will establish a reference emission time that is the same for all transmitters and is independent of the transit delays encountered in the distribution network, transit delays have been mitigated. Then a calculated offset delay value OD may optionally be then applied to each exciter individually to optimize the SFN timing to the environment.

Observing the SFN timing diagram more closely, we see the commonly available 1PPS on the first line of the timing diagram. Directly below is shown the release of the VFIP into the distribution network carrying an STS value equal to the value that was observed on the 24 bit counter in the emission multiplexer the instant the VFIP was released into distribution network. Site N is shown on the next line with the arrival of the VFIP; the instant that the VFIP arrives, the count on the exciter's 24-bit counter is stored (arrival time). The actual transit time delay measured in 100 ns increments that the VFIP experienced is the difference of the values of the (arrival time) minus the value of the received STS (inserted by emission multiplexer). The next line shows Site N+1, which experienced a different transit delay. The reference emission time is observed to be equal at both sites, as a result of the tx_delay calculated independently in each modulator. The actual emission time for each site can then be optionally offset by the OD value, allowing for optimization of network timing under the control of the SFN designer.

Note: In an ideal model with all transmitters systems having identical time delays the above description would produce a common reference emission time. However, in the real world a delay value is calculated for each site to compensate each site's inherent time delay. All exciters have a means of accepting a 16-bit value of the calculated Transmitter and Antenna Delay (TAD) a value represented in 100 ns increments. This value includes the total delay through the transmitter the RF filters and transmission line up to and including the antenna. This calculated value (TAD) is entered by the network designer and is subtracted from the MD value received in VFIP to set an accurate, common timing demarcation point for the RF emission as the air interface of the antenna at each site. The TAD value shall equal the time from the entry of the last bit of the VFIP into the Data Randomizer in the exciter to the appearance at the antenna air interface of the leading edge of segment sync of the data field sync having no PN 63 Inversion.

The cross layer mapping of the (12) DTR bytes in a VFIP will by design be used to reset the (12) trellis coders in a exciter and this will produce a total of 12 RS byte-errors into VFIP. A VFIP packet error occurs because the 12 byte-errors within a single packet exceeds the 10-byte RS correction capability of ATSC. This deterministic packet error will occur only on each VFIP packet every 10,480 TS packets. It should be noted that normal receivers will ignore the VFIP with an ATSC reserved PID 0x1FFA. Extensibility is envisioned for VFIP for controlling SFN translators and for providing signaling to SFN field test & measurement equipment. Therefore, additional error correction is included within the VFIP to allow specially designed receivers to successfully decode the syntax of a transmitted VFIP, effectively allowing reuse of same VFIP over multiple tiers of a SFN translator network.

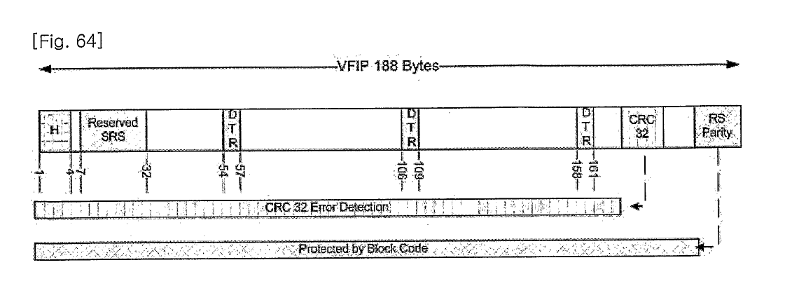

FIG. 64 shows that a VFIP has a CRC 32 used to detect errors on the distribution network and an RS block code used to detect and correct potential errors of the transmitted VFIP. The RS encoding in emission multiplexer sets all DTR bytes to 0x00 and these will be received with deterministic errors and be set to 0x00 in the exciter this will allow a special ATSC receiver to still correct up to normal 10 RS byte errors.

### 6.8.1.3 Support for Translators in SFN

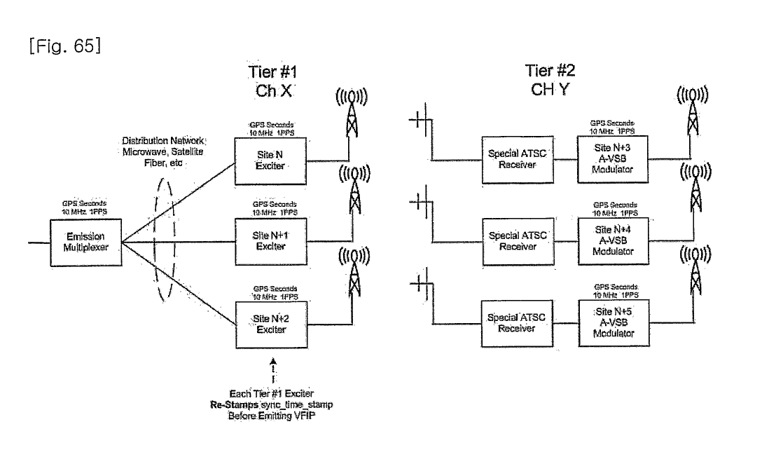

FIG. 65 shows a two-tier SFN Translator network using VFIP. Tier #1 transmits on Ch X, receives the data stream over a distribution network, and achieves emission timing as described above for an SFN.

The RF broadcast signal from Tier #1 is used as the distribution network to the transmitters in Tier #2. To achieve this goal, the sync_time_stamp (STS) field in VFIP is recalculated (and re-stamped) before being emitted by tier #1 exciters. The updated (tier #2) sync_time_stamp (STS) value is equal to the sum of the sync_time_stamp (STS) value and the maximum_delay (MD) value received from the tier #1 distribution network. The recalculated sync_time_stamp (STS) is used along with the tier #2 tier_maximum_delay value in the VFIP. The tier#2 emission timing is then achieved as described for an SFN. If another tier of translators is used, a similar re-stamping will occur at tier #2, etc. A single VFIP can support up to a total of 14 transmitters in up to four tiers. If more transmitters or tiers are desired an additional VFIP can be used.

### 6.8.2 VFIP Syntax (Normative)

A special VFIP is required for the operation of an SFN. This OMP shall have an OM_type in the range of 0x31-0x3F. It contains the syntax to also support SRS and Turbo Stream, when used in combination with the application tool SFN.

An important design feature of this VFIP is the fixed locations of the (12) DTR bytes fields as shown graphically in 52. The complete VFIP syntax is shown in Table 23.

TABLE 23
VFIP

| Syntax | # of Bits | mnemonic |
|---|---|---|
| vfip_packet( ) { | | |
| transport_packet_header | 32 | bslbf |
| om_type | 8 | bslbf |
| reserved | 8 | bslbf |
| for (i=0; i<26;i++) { | | |
| SRS_reserved | 8 | uimsbf |
| } | | |
| reserved | 8 | bslbf |
| srs_mode | 8 | uimsbf |
| turbo_stream_mode | 8 | uimsbf |
| sync_time_stamp | 24 | uimsbf |
| maximum_delay | 24 | uimsbf |
| network_id | 12 | uimsbf |
| T&M_flag | 1 | bslbf |
| number_of_translator_tiers | 3 | uimsbf |
| reserved | 8 | uimsbf |
| for (i=0; i<3; i++) { | | |
| if (i < number_of_translator_tiers) { | | |
| tier_maximum_delay | 24 | uimsbf |
| } | | |
| else { | | |
| stuffing_bytes | 24 | uimsbf |
| } | | |
| } | | |
| DTR_reserved | 32 | uimsbf |
| if (number_of_translator_tiers = 4) { | | |
| tier_maximum_delay | 24 | uimsbf |
| } | | |
| else { | | |
| stuffing_bytes | 24 | uimsbf |
| } | | |
| if (T&M_flag = ‘1’) { | | |
| field_T&M | 40 | bslbf |
| } | | |
| else { | | |
| stuffing_bytes | 40 | uimsbf |
| } | | |
| tx_data_section_lenght | 8 | uimsbf |
| for (i=0; i<6; i++) { | | |
| if (i < tx_data_section_lenght) { | | |
| tx_data | | |
| } | | |
| else { | | |
| stuffing_bytes | 48 | bslbf |
| } | | |
| } | | |
| for (i=0; i<3; i++) { | | |
| stuffing_byte | 8 | uimsbf |
| } | | |
| DTR_reserved | 32 | uimsbf |
| for (i=6; i<14; i++) { | | |
| if (i < tx_data_section_lenght) { | | |
| tx_data | 48 | bslbf |
| } | | |
| else { | | |
| stuffing_bytes | 48 | bslbf |
| } | | |
| } | | |
| DTR_reserved | 32 | uimsbf |
| crc_32 | 32 | rpchof |
| for (i=0; i<N; i++) { | | |
| stuffing_byte | 8 | uimsbf |
| } | | |
| vfip_ecc | 160 | uimsbf |
| } | | |

TABLE 24
tx_data

| Syntax | # of Bits | mnemonic |
|---|---|---|
| tx_data( ) { | | |
| tx_address | 12 | uimsbf |
| reserved | 4 | 0000 |
| tx_time_offset | 16 | uimsbf |
| tx_power | 12 | uipfmsbf |
| tx_id_level | 3 | uimsbf |
| tx_data_inhibit | 1 | uimsbf |
| } | | |

transport_packet_header—and constrained by ATSC A/110A, Section 6.1.

OM_type—defined in ATSC A/110, Sec 6.1 and set to a value in a range of 0x31-0x3F inclusive, are assigned sequentially starting with 0x31 and continuing according to the number of transmitters in the SFN design.

srs_bytes—as defined in Section 6.5.4.2

srs_mode—signals SRS mode

turbo_stream_mode—signals Turbo Mode

sync_time_stamp—contains the time difference, expressed as a number of 100 ns steps, between the latest pulse of the 1PPS signal and the instant VFIP is transmitted into the distribution network as indicated on a 24-bit counter in an emission multiplexer.

maximum_delay—a value larger than the longest delay path in the distribution network expressed as a number of 100 ns steps. The range of maximum_delay is 0x000000 to 0x98967F, which equals a maximum delay of 1 second.

network_id—a 12-bit unsigned integer field representing the network in which the transmitter is located. This also provides part of the 24 bit seed value (for the Kasami Sequence generator defined in A/110A) for a unique transmitter identification sequence to be assigned for each transmitter. All transmitters within a network shall use the same 12-bit network_id pattern.

TM_flag—signals data channel for automated A-VSB field test & measurement equipment where 0 indicates T&M Channel inactive, and 1 indicates T&M Channel active.

number_of translator_tiers—indicates number of tiers of translators as defined in Table 25.

TABLE 25
Translator Tiers

| number_of_translator_tiers Value | Meaning |
|---|---|
| 000b | No translators |
| 001b | one tier of translators |
| 010b | two tiers of translators |
| 011b | three tiers of translators |
| 100b | four tiers of translators |
| 101b-111b | Prohibited |

tier_maximum_delay—shall be value larger than the longest delay path in the translator distribution network expressed as a number of 100 ns steps. The range of tier_maximum_delay is 0x000000 to 0x98967F this equals a maximum delay of 1 second.

stuffing_byte—shall be set to 0xFF.

stuffing_byte_{—}3—shall be set to 0xFFFFFF.

stuffing_byte_{—}5—shall be set to 0xFFFFFFFFFF.

stuffing_byte_{—}6—shall be set to 0xFFFFFFFFFFFF.

DTR_bytes—shall be set 0x00000000.

field_TM—private data channel to control remote field T&M and monitoring equipment for the maintenance and monitoring of SFN.

number_of_tx_data_sections—the number of tx_data( ) structure fields (as defined in [Table TBD]) This is currently constrained to the values 0x00-0x0E, with 0x0F-0xFF Prohibited.

crc_{—}32—A 32 bit field that contains the CRC of all the bytes in the VFIP, excluding the vfip_ecc bytes. The algorithm as defined in ETSI TS 101 191, Annex A.

vfip_ecc—A 160-bit unsigned integer field that carries 20 bytes of Reed Solomon Parity bytes for error correcting coding used to protect the remaining payload bytes.

tx_address—A 12-bit unsigned integer field that carries the unique address of the transmitter to which the following fields are relevant. Also used as part of the 24-bit seed value (for the Kasami Sequence generator—see A/110A) for a unique sequence to be assigned to each transmitter. All transmitters in a network shall have a unique 12-bit address assigned.

tx_time_offset—A 16-bit signed integer field that indicates the time offset value, measured in 100 ns increments, allowing fine adjustment of the emission time of each individual transmitter to optimize network timing

tx_power—A 12-bit unsigned integer plus fraction that indicates the power level to which the transmitter to which it is addressed should be set. The most significant 8 bits indicate the power in integer dB relative to 0 dBm, and the least significant 4 bits indicate the power infractions of a dB. When set to zero, tx_power shall indicate that the transmitter to which the value is addressed is not currently operating in the network.

tx_id_level—A 3-bit unsigned integer field indicates to what injection level (including off) the RF watermark signal of each transmitter shall be set.

tx_data_inhibit—A 1-bit field that indicates when the tx_data( ) information should not be encoded into the RF watermark signal

### 6.8.3 RF Watermark

The spread spectrum signal technology introduced first in A/110A for the Transmitter Identification (TxID) is also included. In addition to the applications of Transmitter identification and enabling special test equipment for SFN timing and monitoring purposes other uses of this technology are envisioned. [TBD]

### 6.8.4 ATSC System Time (AST)

The emission multiplexer sends a VFIP every 10,480 TS packet or 20 VSB frames also known as a super frame to an A-VSB exciter to establish the Deterministic Frame which enables cross layer techniques to be employed to enhance 8-VSB. The emission multiplexer uses a global super frame reference signal derived from GPS to enable all A-VSB stations to synchronize their VSB data framing. This synchronization may enable such things as future location based applications or ease the interoperability with 802.xx networks. If the global framing reference is combined with the deterministic mapping (DF) of Turbo Stream content an effective handoff scheme for mobile applications can be developed.

To achieve these goals a global reference signal is needed to signal the start of a VSB Super Frame (SF) to all emission multiplexers and A-VSB exciters. This becomes possible because of the fixed ATSC symbol rate and the fixed ATSC VSB frame structure and the global availability of GPS (For reference see USNO GPS timing operations http://tycho.usno.navy.mil/gps.html). The GPS has several temporal references available that will be used. 1.) defined Epoch 2.) a GPS Seconds Count 3.) 1PPS.

The epoch or start of GPS time is defined as Jan. 6, 1980 00:00:00 UTC. We first define the ATSC epoch to be the same as the GPS epoch, Jan. 6, 1980 00:00:00 UTC.

The ATSC Epoch is also the instant the 1st Symbol of the segment sync of 1st DFS (No PN 63 Inv) of the 1st Super frame was emitted at air interface of Antenna of All ATSC DTV Stations.

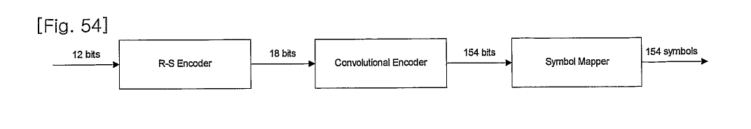

The GPS second count gives the number of seconds elapsed since the epoch. The one pulse per second signal (1PPS) is also provided by a GPS receiver and signals the start of a second by a rising edge of 1PPS. We next define an ATSC unit of time close to one second in duration which we can compare to GPS seconds. The A-VSB Super Frame is equal to 20 VSB frames and has a period of 0.967887927225471088 Seconds. Given the common epoch and the global availability of GPS second count and 1PPS we can calculate the offset between the next GPS second tick indicated by 1PPS and the start of a super frame at any time in future since the epoch. The super frame start signal is term the one pulse per super frame (1PPSF). FIG. 54 shows an example of the calculation of time offset between 1PPS and 1PPSF using an example GPS Second count of 851,472,000 (˜27 years since epoch). This relationship allows circuitry to be designed in the emission multiplexer and exciter to have the common 1PPSF reference for SFN and MFN. The ATSC System Time is defined as the number of Super frames since Epoch.

### 6.8.5 ATSC System Time Implementation

This section to be completed soon. [TBD]

### 7 Transport Layer

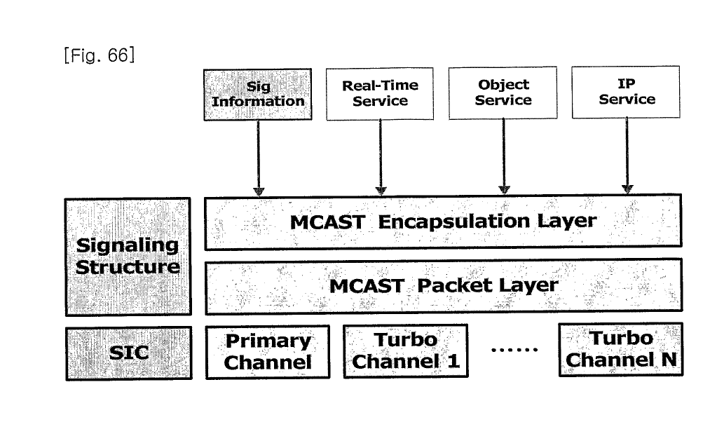

FIG. 66 depicts the protocol stack of MCAST. The Encapsulation Layer encapsulates all of the different kinds of data for MCAST packet delivery. The Packet Layer segments the encapsulated data into MCAST packets and adds a transmission header. The Signaling Information Channel (SIC) contains all the signaling information for the turbo channel.

MCAST has the capability of supporting multiple types of services and delivering various types of content. The supported service types are:

real-time services

Internet protocol (IP) based services, and

object download services.

Real-time services are when video and audio are intended to be consumed as it is received—in “real time”. Real-time service data types are video, audio and auxiliary information to be presented with A/V. Sections 7.1 and 7.2 provide the detail description of the video and audio.

IP services are very broad and include datacasting and other IP data received in real time but intended to be consumed either in real time or stored for later.

Object download services consist of multimedia data received at any time in advance and to be presented later in response to received control information

In mobile services, fast service acquisition is an important requirement. MCAST reduces the steps of tuning, demultiplexing and decoding the services, and thus provides the fast service acquisition.

### 7.1 Video

MCAST supports H.264/AVC [[143]] video. To allow full compliance to the specification and upward compatibility with future enhanced version, a decoder shall be able to skip over data structure which are currently “reserved”, or which correspond to functions not implemented.

### 7.1.1 Profile and Level

The H.264/AVC bitstream shall conform to the restrictions described in [[143]] as the Baseline Profile, Level 1.3 with constraint_set1_flag being equal to 1. Support of the levels beyond level 1.3 is optional.

### 7.1.2 Sample Aspect Ratio

Square (1:1) sample aspect ratio shall be used.

### 7.1.3 Random Access Points

Sequence and picture parameter sets should be sent together with a random access point at lease once every 2 seconds.

### 7.2 Audio

MCAST supports MPEG-4 AAC profile, MPEG-4 HE AAC profile and MPEG HE AAC v2 profile as defined in ISO/IEC 14496-3 [[144]]. To allow full conformance and upward compatibility with future enhanced versions, decoders shall be able to skip over data structures which are currently “reserved”, or which correspond to functions not implemented by the decoder.

### 7.2.1 Audio Mode

The AAC bitstream shall be encoded in mono, parametric stereo or 2-channel stereo according to the functionality defined in the HE AAC v2 profile level 2; or optionally in multichannel according to the functionality defined in the HE AAC v2 profile level 4 as specified in ISO/IEC 14496-3 including amendments 1 and 2[[144]].

### 7.2.2 Bitrate

The maximum bit rate of the audio shall not exceed 192 kbit/s for a stereo pair. And, when present, the maximum bit rate of the encoded audio shall not exceed 320 kbit/s for multi channel audio.

### 7.2.3 Matrix Downmix

The decoder shall support the matrix downmix as defined in ISO/IEC 14496-3 [5].

### 7.3 MCAST Signaling Mechanism

This section describes the signaling mechanism of MCAST. In mobile broadcasting fast access is key requirement. MCAST provides two complementary methods to provide this functionality. First there is the notion of a “primary service” where a decoder tunes by default without user navigation. Second, service information is encoded in the real-time elementary streams.

MCAST also provide a Signaling Information Channel (SIC). SIC contains essential information for turbo channel processing and is thus mandatory.

### 7.3.1 Primary Service

The primary service is the first priority service for the user to watch. In the general case of service access in the turbo stream, the SIC should be acquired and decoded first for turbo processing. SIC specifies the physical decoding information and some simple description information of all turbo services. In case of primary service, access information is defined in Data Field Sync (DFS). See Section [TBD]. The primary service and SIC shall be in continuous transmission mode and the SIC shall exist in every frame. SIC is mandatory, however the primary service is optional and depends on the service provider.

### 7.3.2 Critical Service Information

For real time rich media services, the Program Specific Information (PSI), which includes the MPEG-2 tables: PAT, PMT, CAT, and NIT, must be acquired and decoded first in order to then decode the multimedia streams in the broadcasting system. Then the decoder must wait for the first decodable frame. Only then can the user watch video.

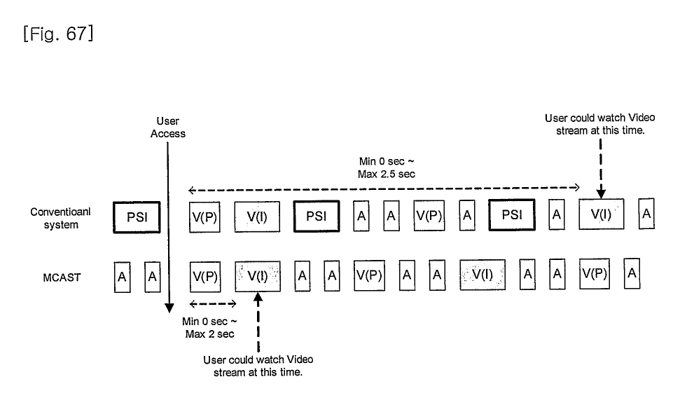

In MCAST critical decoder information is encoded in an information descriptor included in each multimedia elementary stream. The decoder configuration information and multimedia data are transported at the same time so the receiver does not need to wait to get PSI before decoding the video and audio. This difference in decoding time is compared in FIG. 67.

Let's assume that the transmission periods for the PAT and PMT are each 0.5 seconds and “delta” seconds for a video I frame. In the worst case for the conventional system, it takes 0.5+0.5+“delta” seconds to see the first video frame. But MCAST just takes “delta” seconds to get the first I frame presented on the receiver. This is because the I-frame has encoded with it its own decoder configuration information.

MCAST can therefore rapidly process the I frame right after it receives it.

### 7.3.2.1 Decoder Configuration Information

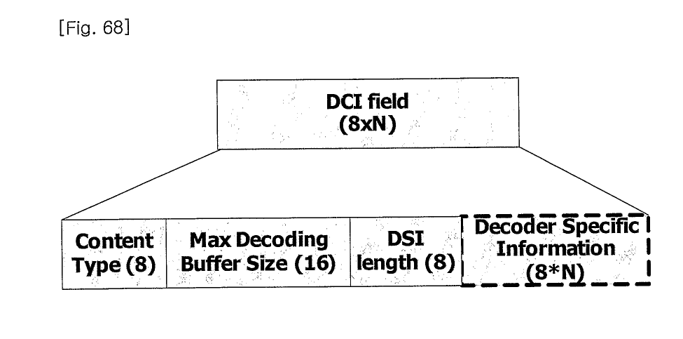

FIG. 68 defines the syntax of the Decoder Configuration Information (DCI) structure for real time media. It is encoded in the MCAST encapsulation layer. The DCI contains the specific information needed by the media decoder. The DCI exists only in the encapsulation packet for real time media

Content Type—This indicates the content type of the stream. The defined values are in Table 26.

TABLE 26
Content Type Values

| Value | Content Type Description |
|---|---|
| 0 | forbidden |
| 1 | H.264/AVC |
| 2 | HE AAC |
| 3~255 | reserved |

Max Decoding Buffer Size—This indicates the length of the decoding buffer in bytes. The definition of the buffer is stream type dependent.

DSI length—This indicates the length of Decoder Specific Information field in bytes.

Decoder Specific Information—This contains decoder specific information. The definition of this field is stream type dependent.

### 7.3.3 Signaling Information Channel (SIC)

### 7.3.3.1 Service Configuration Information

The SIC contains detailed turbo channel information. It has service configuration information structures and it contains the turbo channel position information in the MCAST parcel and turbo decoding information for every turbo channels. The detail syntax is defined in Table 27.

TABLE 27
Service Configuration Information

| Syntax | # of bits |
|---|---|
| ServiceConfigurationInformation( ) | |
| { | |
| frame_group_information ( ) | 16 |
| turbo_channel_information_flag | 1 |
| additional_service_information_flag | 1 |
| padding_flag | 1 |
| reserved | 1 |
| version_indicator_information ( ) | 12 |
| if(turbo_channel_information_flag){ | |
| turbo_channel_information ( ) | 64 |
| } | |
| if (additional_service_information_flag) | |
| { | |
| addtional_service_information( ) | 8 * N |
| } | |
| if(padding_flag) | |
| { | |
| byte | 8 * N |
| } | |
| CRC | 16 |
| } | |

frame_group_information( )—This structure specifies the current and total number of frames within a frame group as more fully defined in Section 7.3.3.3.

turbo_channel_information_flag—This bit indicates the existence of the turbo_channel_information( ) structure.

additional_service_information_flag—This bit indicates the existence of the turbo_channel_information( ) structure.

padding_flag—This bit indicates the existence of padding bytes.

reserved—This is the reserved bits for future use. The bits shall be set to ‘1’.

version_indicator_information( )—This is the version of the service configuration information structure as more fully defined in Section 7.3.3.2.

turbo_channel_information—This structure includes the turbo channel information as more fully defined in Section 7.3.3.4.

additional_service_information( )—This structure is used to send additional description information for every turbo channel as more fully defined in Section 7.3.3.5.

byte—This is a series of padding bytes used by SIC encoder to fill all unallocated bandwidth. It is set to 0xFF.

CRC—This 16-bit field is a CRC calculated on the packet header and the packet data field. It shall be shall be based on the polynomial G(x)=x16+x12+x5+1. At the beginning of each CRC word calculation, all shift register stage contents shall be initialized to “1”. The CRC word shall be complemented (1's complement).

### 7.3.3.2 Version Indicator Information

The service configuration information is very crucial, so the version management is important. When the version is changed, the turbo channel information structure must be transported in advance The syntax of the version_indicator_information( ) structure is defined in Table 28.

TABLE 28
Version Indicator Information

| Syntax | # of bits |
|---|---|
| version_indicator_information( ) | |
| { | |
| frame_counter | 8 |
| version | 4 |
| } | |

frame_counter—This field indicates the number of frames before the version update.

version—This field indicates the version number of the service configuration information. The number shall be incremented by 1 whenever there are changes to the two fields that follow this structure: turbo_channel_information( ) and additional_service_information( ) It is not incremented when the fields that preceed the version_indicator_information( ) structure change; and is not incremented when one additional service information is transmitted into several fragments.

7.3.3.3 Frame Group information

The frame group information is used for MCAST frame slicing. The frame group occurs periodically starting in the same frame number. The frame_group_information( ) structure includes the current frame number and the total number of frames in frame group. The syntax of frame grouping information is defined in Table 29.

TABLE 29
Frame Group Information

| Syntax | # of bits |
|---|---|
| frame_group_information{ | |
| current_frame_number | 8 |
| total_frame_number | 8 |
| } | |

current_frame_number—This indicates the current frame number. The frame number is incremented by 1 within a frame group.

total_frame_number—This indicates the total number of frames in the group.

### 7.3.3.4 Turbo Channel Information

The turbo channel information is defined in this structure. The physical decoding information, the existence of MCAST_frame_slicing and total number of turbo channels are the critical fields. For support of MCAST_frame_slicing, the structure indicates the current frame number and the number of frame blocks to receive for the selected turbo channel. The syntax of the turbo_channel_information( ) structure is defined in Table 30.

TABLE 30
Turbo Channel Information

| Syntax | # of bits |
|---|---|
| turbo_channel_information ( ) | |
| { | |
| version | 4 |
| num_of_turbo_channels | 4 |
| tx_version | 2 |
| reserved | 2 |
| For (i=0; i<= num_of_turbo_channels; i++) { | |
| turbo_channel_id | 4 |
| is_enhanced | 1 |
| reserved | 8 |
| MCAST_Frame_slicing_flag | 1 |
| MCAST_AL_FEC_flag | 1 |
| if(tx_version==0) | |
| { | |
| full_packet_flag | 1 |
| turbo_start_sector | 7 |
| turbo_cluster_size | 6 |
| coding_rates | 3 |
| } | |
| else if(tx_version==1) | |
| { | |
| turbo_start_position | 5 |
| turbo_region_count | 5 |
| duplicate_flag | 1 |
| coding_rates | 3 |
| reserved | 3 |
| } | |
| if (Frame_slicing_flag) | |
| { | |
| start_frame_number | 8 |
| frame_count | 8 |
| } | |
| if(AL_FEC_flag) | |
| { | |
| AL_FEC_Informaion | 8 |
| } | |
| } | |
| } | |

version—This 3 bit field indicates the version of the turbo channel information. The number shall be incremented by 1 when the turbo channel information changed.

num_of turbo_channels—This field indicates the total number of turbo channels.

tx_version—See section Signaling Information[TBD].

reserved—These bits are reserved for future use and shall be set to ‘1’.

turbo_channel_id—This is the identifier of this turbo channel. When a detailed description of the service is included in the stream, this id is used for identification of the turbo channel.

is_enhanced—This bit, when set, indicates enhanced video scalability, and when clear indicates base video.

reserved—These bits are reserved for future use and shall be set to ‘1’.

MCAST_Frame_Slicing_flag—This bit, when set, specifies that the turbo stream is transmitted in burst mode.

MCAST_AL_FEC_flag—This bit, when set, specifies that the turbo stream supports application layer FEC.

full_packet_flag—If this field set to 1 then the last sector of the turbo stream byte is carried by null packet. If set to 0, then carried by AF.

turbo_start_sector—This field indicates the physical start position of the turbo stream. See Section section for more details. [TBD]

turbo_cluster_size—This indicates the cluster size by a number of sectors for Turbo stream.

coding_rates—This indicates the index of turbo channel coding rate.

turbo_start_position—the start position of the stream data in the new transmission mode (Tx_version=1). See section [TBD] for more details

turbo_region_count—the number of regions used for the stream in the new transmission mode (Tx_version=1). See section [TBD] for more details

duplicate_flag—the duplication technique in the new transmission mode (Tx_version=1). See section [TBD] for more details

start_frame_number—This field indicates the start position of the turbo stream delivered in burst mode. It is set to the number of the first frame to be received.

frame_count—This number specifies the number of frames to acquire for turbo service in burst mode.

MCAST_AL_FEC_Information—AL-FEC related information

### 7.3.3.5 Additional Service Information

The syntax of the additional service information structure is described in Table 31.

TABLE 31
Additional Service Information

| Syntax | # of bits |
|---|---|
| additional_service_information( ) | |
| { | |
| current_index | 8 |
| last_index | 8 |
| length | 8 |
| user_data | 8 * N |
| } | |

current_index—This indicates current index of the block within the total number of description blocks.

ast_index—This indicates last index within the total number of description blocks.

length—This indicates the length of current fragment.

user_data—The syntax of the user_data( ) structure is a series of <tag><length><data>. The tag field is 8 bits and the values are defined in Table 32. The length field is 8 bits and defines the length of the data field in bytes. Table 33 defines the syntax of turbo channel information descriptor.

TABLE 32
User Data Tags

| Tag | Description |
|---|---|
| 0 | forbidden |
| 1 | turbo channel information descriptor |
| 2~255 | reserved |

TABLE 33
Turbo Channel Information Descriptor

| Syntax | # of bits |
|---|---|
| turbo_channel_information_descriptor ( ) | |
| { | |
| tag | 8 |
| length | 8 |
| turbo_channel_information( ) | 8 * N |
| } | |

tag—This indicates the type of descriptor and shall be set to 1.

length—This indicates the total length of turbo_channel_information( ) structure.

turbo_channel_information( )—as defined in Section 7.3.3.4.

### 7.4 MCAST Multiplexing Mechanism

The SIC describes multiple turbo channels and every turbo channel has several virtual channels. In every virtual channel, the same type of data is carried. The data types are:

signaling,

real time media service,

IP packets, and

Objects.

Each sub channel can also have sub data channels. The sub data channel could be a service itself or components of service.

The signaling data channel is located on first packet in the turbo channel within an MCAST parcel. The signaling data channel carries 188-byte MCAST transport packets which contain Location Map Table (LMT) and Linkage Information Table (LIT). The LMT provides the position, the data type and number of all sub data channels. The LIT contains the service composition information. It provides the number and identification of supported services.

The detailed syntax of the LMT and LIT are defined in Section 7.5.2.

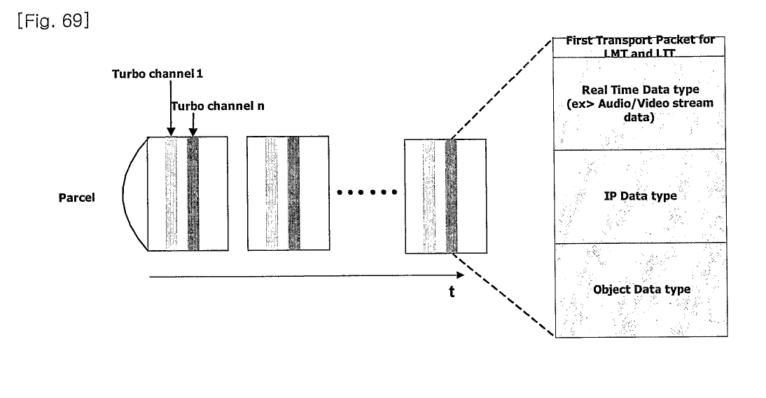

FIG. 69 illustrates the multiplexing structure of turbo data channel in ATSC frame.

### 7.4.1 Location Map Table (LMT)

The Location Map Table (LMT) is located on the signaling data channel which is positioned first in the turbo data channel.

The LMT shall specify the position and type of every sub data channel within an MCAST parcel. The sub data channel consists of sequence sets of 188 bytes MCAST packets in an MCAST parcel. The first packet start with number 0. The LMT shall keep the list of end index number of every sub data channels within MCAST parcel.

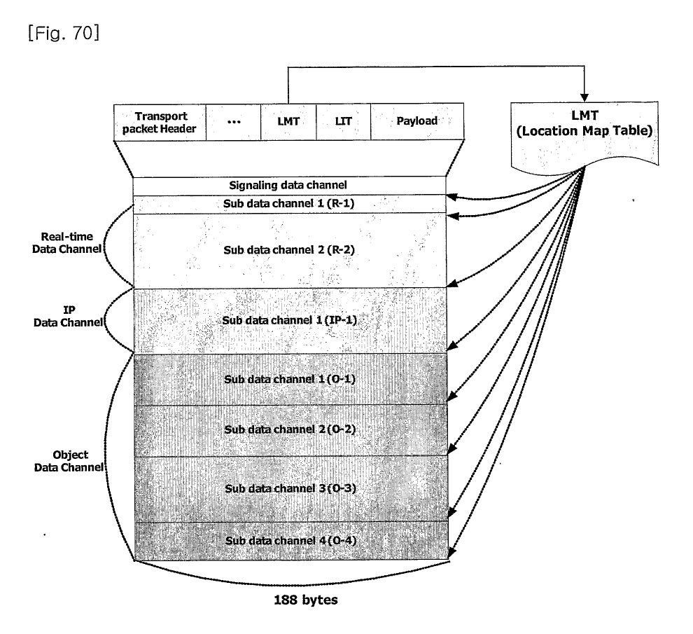

As shown in FIG. 70, the first transport packet in an MCAST parcel is for signaling, and it includes the LMT, LIT and optional data in the payload.

### 7.4.2 Linkage Information Table (LIT)

The Linkage Information Table (LIT) is located on the signaling data channel which is positioned first in an MCAST parcel. The LIT shall specify the service component list of service. Every service is composed of one or more sub data channels. The position of the sub data channel is determined from the LMT.

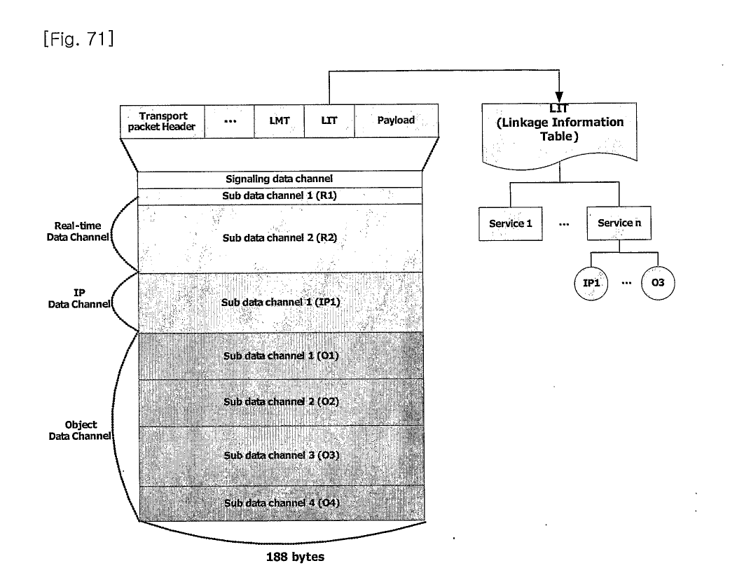

FIG. 71 illustrates the location of the LIT in the signaling data channel and specifies what kinds of information are included in the LIT. The LIT is tightly coupled with the LMT.

### 7.5 MCAST Transport Layer

The transport layer is in two parts—the encapsulation layer and the packetization layer. The packetization layer is responsible for fragmenting the application data. The encapsulation layer is responsible for encapsulating all of the types of application data into the MCAST packet.

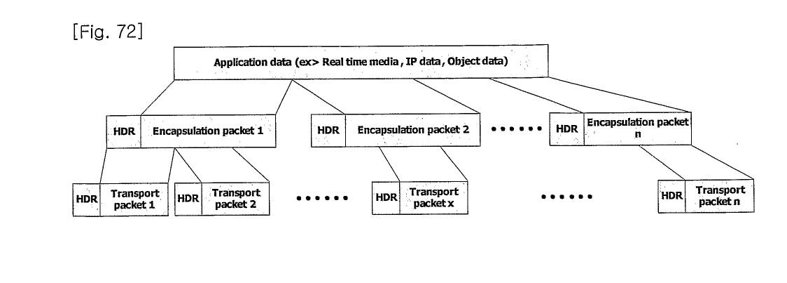

Every type of application data has a specialized encapsulation format. The format is very flexible and is adapted for every data type. Each encapsulation packet will be fragmented into the number of MCAST packets. FIG. 72 specifies how encapsulation packets are fragmented to MCAST packets.

Section 7.5.1 specifies the packet structure of the encapsulation layer and Section 7.5.2 specifies the packet structure of the packetization layer.

### 7.5.1 Encapsulation Layer

### 7.5.1.1 Signaling Encapsulation Packet (SEP)

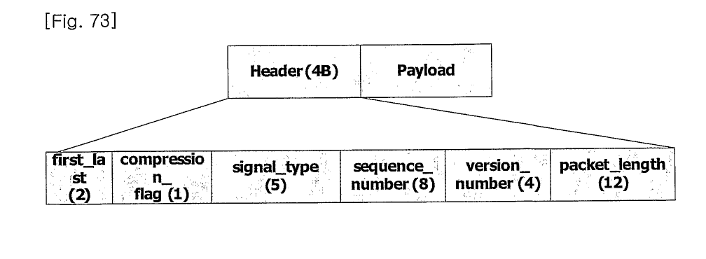

This section specifies the syntax of the encapsulation packet for signaling data. As shown in FIG. 73, this packet has a 4-byte header and a payload. The payload shall include a description or metadata of the application such as Electronic Service Guide (ESG), Electronic Program Guide (EPG) and so on. The structures of ESG and EPG metadata are not defined in this document. The complete packet syntax shall be as defined in Table 34.

TABLE 34
Signaling Encapsulation Packet

| | # of |
|---|---|
| Syntax | bits |
| signaling_encapsulation_packet( ) | |
| { | |
| first_last | 2 |
| compression_flag | 1 |
| signal_type | 5 |
| sequence_number | 8 |
| version_number | 4 |
| packet_length | 12 |
| for(i=0; i<N; i++){ | |
| data_byte | 8 |
| } | |
| } | |

first_last—This 2-bit field specifies if the packet is the first or last encapsulation packet as defined in Table 35

TABLE 35
first_last values

| Value | Description |
|---|---|
| 00 | Intermediate packet of a series |
| 01 | Last packet of a series |
| 10 | First packet of a series |
| 11 | The one and only packet |

compression_flag—This 1-bit field, when set, specifies that the payload data is compressed.

signal_type—It specifies the payload type. [TBD]

sequence_number—This 8 bit field is incremented with each encapsulation packet with the same data type. This value is used for object fragment identifier during retransmission.

version_number—This 4 bit field is the version number of the signaling encapsulation packet. The version number shall be incremented by 1, whenever the encapsulation payload is changed.

packet_length—It specifies the number of bytes of the payload in the packet.

data_byte—The payload dependent on the signal_type. [TBD]

### 7.5.1.2 Real Time Encapsulation Packet (REP)

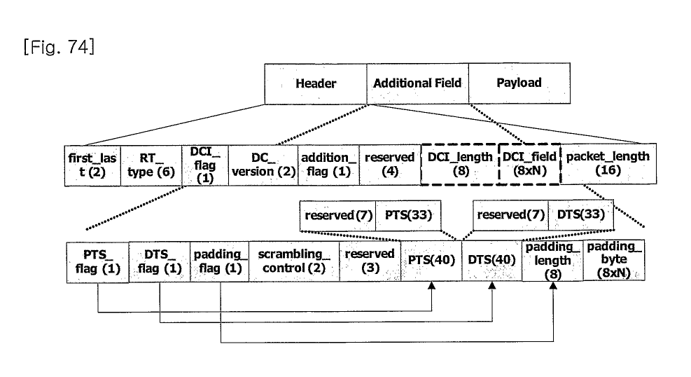

This section describes that the syntax of the encapsulation packet for the real-time data type. This packet is composed of several transport packets. As shown in FIG. 74, this packet has a header, additional field and a payload.

TABLE 36
Real-time Encapsulation Packet

| | # of |
|---|---|
| Syntax | bits |
| real-time_encapsulation_packet( ) | |
| { | |
| first_last | 2 |
| RT_type | 6 |
| DCI_flag | 1 |
| DC_version | 2 |
| addition_flag | 1 |
| reserved | 4 |
| if(DCI_flag==1){ | |
| decoder_configuration_information( ) | N * 8 |
| } | |
| packet_length | 16 |
| if(addition_flag==1){ | |
| PTS_flag | 1 |
| DTS_flag | 1 |
| padding_flag | 1 |
| scrambling_control | 2 |
| reserved | 3 |
| if(PTS_flag==1){ | |
| reserved | 7 |
| PTS | 33 |
| } | |
| if(DTS_flag==1){ | |
| reserved | 7 |
| DTS | 33 |
| } | |
| if(padding_flag==1){ | |
| padding_length | 8 |
| for(i=0; i<N; i++) | |
| padding_byte | 8 |
| } | |
| } | |
| for(i=0; i<N; i++){ | |
| data_byte | 8 |
| } | |
| } | |

first_last—This 2-bit field specifies if the packet is the first or last encapsulation packet, as defined in Table 35.

RT_type—This 6-bit field signals the payload type. [TBD]

DCI_flag—When set, this indicates the presence of the decoder_configuration_information( ) structure (DCI). This value is tightly coupled to the transport packet DC value and must be set the same.

DC_version—This 2-bit field specifies the version number of the DCI.

addition_flag—This 1-bit field, when set, indicates the presence of several additional fields.

reserved—These bits are reserved for future use and shall be set to ‘1’.

decoder_configuration_information( )—The structure as defined in Section 7.3.2.1.

packet_length—This 16-bit field specifies the number of bytes of the payload in the packet right after packet length.

PTS_flag—When set, this 1-bit field indicates the presence of the PTS field.

DTS_flag—When set, this 1-bit field indicates the presence of the DTS field.

padding_flag—When set, this 1-bit field indicates the presence of padding bytes.

scrambling_control—It signals the scrambling mode of the encapsulation packet payload. [TBD]

reserved—These bits are reserved for future use, and shall be filled with ‘1’.

PTS—This 33-bit field is the presentation time stamp.

reserved—These bits are reserved for future use, and shall be filled with ‘1’.

DTS—This 33-bit field is the decoding time stamp.

padding_length—It specifies the number of bytes of padding in the packet.

padding_byte—One or more 8 bit values set to 0xFF that can be inserted by the encoder. It is discarded by the decoder.

data_byte—This the payload dependent on the RT t [TBD].

### 7.5.1.3 IP Encapsulation Packet

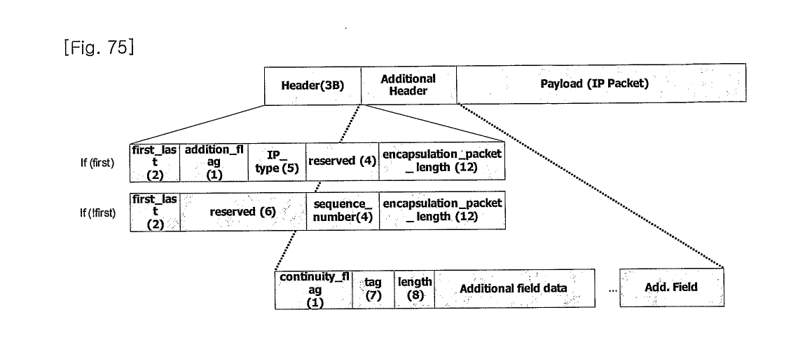

FIG. 75 describes the structure of IP encapsulation packet. It is designed to deliver IP datagrams. IP datagram may divide into several encapsulation packets. Last IP Encapsulation packet will be identified by setting first_last field value to 01 and 11. The detailed syntax is defined in Table 37.

TABLE 37
IP Encapsulation Packet

| | # of |
|---|---|
| Syntax | bits |
| IP_Encapsulation_Packet( ) | |
| { | |
| first_last | 2 |
| if(first_last & 2){ | |
| addition_flag | 1 |
| IP_type | 5 |
| reserved | 4 |
| payload_length | 12 |
| else{ | |
| reserved | 6 |
| sequence_number | 4 |
| payload_length | 12 |
| } | |
| if(addition_flag==1){ | |
| do{ | |
| continuity_flag | 1 |
| tag | 7 |
| length | 8 |
| additional_data | 8 * N |
| }while(continuity_flag==1) | |
| } | |
| for(i=0; i<N; i++){ | |
| payload | 8 |
| } | |
| } | |

first_last—This 2-bit field specifies if the packet is the first or last encapsulation packet as defined in Table 35.

addition_flag—This 1-bit flag, when set, indicates the presence of the additional_data field.

IP_type—This 5-bit field indicates the IP payload type. [TBD]

reserved—These bits are reserved for future use and shall be filled with ‘1’.

sequence_number—This 4-bit field increments with the same data type of the encapsulation packet. This field is used for IP fragment identifier during retransmission.

payload_length—This 12-bit field specifies the number of payload bytes.

continuity_flag—This 1-bit field, when set, indicates that there is a subsequent set of {tag, length, additional_data} fields. If this flag is set to ‘0’, it means that this field is the last field of the additional fields.

tag—This 7-bit field specifies the type of additional_data. TBD.

length—It specifies the number of bytes of the additional_data.

additional_data—This variable length field contains information according to the tag field value.

payload—This variable length field contains the IP packet data as defined by the IP_type field.

### 7.5.1.4 Object Encapsulation Packet (OEP)

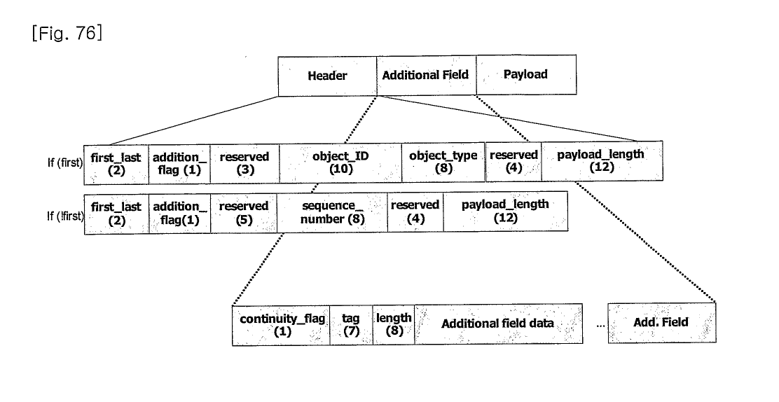

This section specifies the syntax of the encapsulation packet for the object data type. This packet is composed of several transport packets which carry the object data type. As shown in FIG. 76, this packet has a header, additional field and a payload. The additional field data contains extra information about the payload.

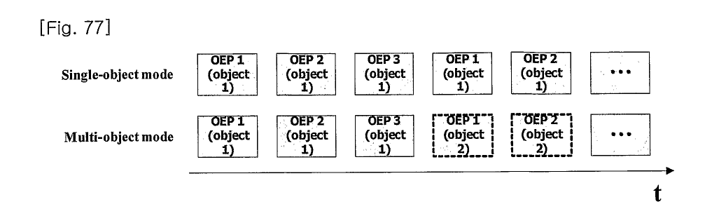

The object data can be transported through object data channel by two methods. See FIG. 77. One data channel could carry one or more objects at a time. In this case, identification of successive objects in the same data channel is needed, which is done with the object_id. Additional field data is used to carry the information about each object. The detailed syntax is defined in Table 38.

TABLE 38
Object Encapsulation Packet

| | # of |
|---|---|
| Syntax | bits |
| Object_Encapsulation_Packet( ) | |
| { | |
| first_last | 2 |
| addition_flag | 1 |
| if(first_last & 10){ | |
| reserved | 3 |
| object_ID | 10 |
| object_type | 8 |
| reserved | 4 |
| payload_length | 12 |
| else{ | |
| reserved | 5 |
| sequence_number | 8 |
| reserved | 4 |
| payload_length | 12 |
| } | |
| if(addition_flag==1){ | |
| do{ | |
| continuity_flag | 1 |
| tag | 7 |
| length | 8 |
| additional_data | 8 * N |
| }while(continuity_flag==1) | |
| } | |
| for(i=0; i<N; i++){ | |
| payload | 8 |
| } | |
| } | |

first_last—This 2-bit field specifies if the packet is the first or last encapsulation packet, as defined in Table 35.

addition_flag—When set, this 1-bit field indicates the presence of the additional_data field.

reserved—These bits are reserved for future use and shall be set to ‘1’.

object_ID—This 10-bit field identifies each object delivered in the same object data channel.

object_type—This 8-bit field specifies the type of object, such as jpeg (compressed or not), text (compressed or not), mp3 and so on as defined in [TBD].

sequence_number—This 8-bit field is the number of the partial packet fragment. When the object length exceeds the maximum encapsulation packet length then this field indicates the fragment number.

payload_length—This 12-bit field specifies the number of bytes of data following this field.

continuity_flag—This 1-bit field, when set, indicates the existence of the next additional_data field. If this flag is set to ‘0’, it means that this field is the last field of the additional_data fields.

tag—This 7-bit field specifies the type of additional_data information. TBD.

length—This 8-bit field specifies the number of bytes of the additional_data.

additional_data—This variable length field contains extra information as defined by the tag field.

payload—This variable length field contains the object data as defined by object_type.

### 7.5.2 Packetization Layer

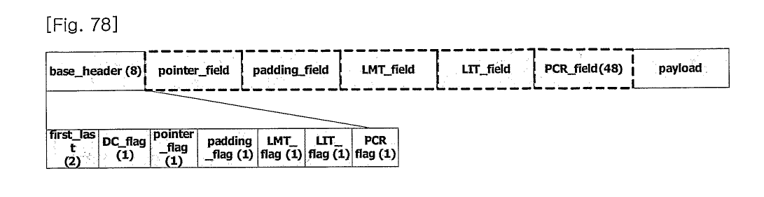

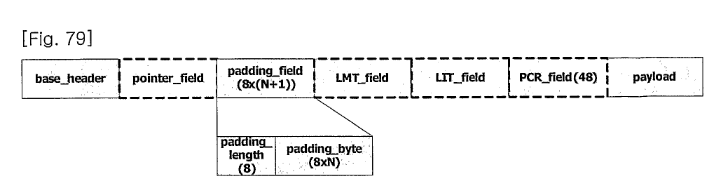

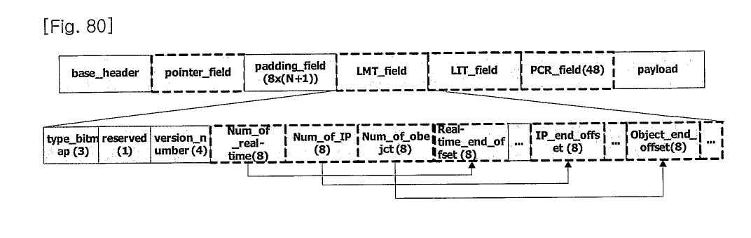

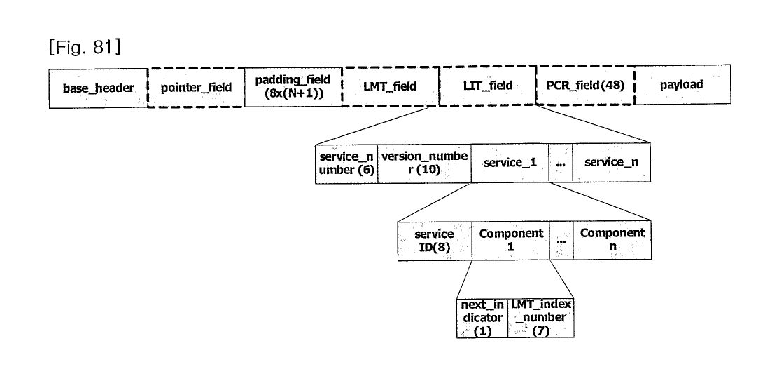

This section specifies the syntax of the transport packet. This packet is composed of several header fields and a payload. As shown in FIG. 78, this packet has a base header, pointer flag, padding, Location Map Table (LMT), Linkage Information Table (LIT) and a payload. FIG. 79 describes the structure of the padding field. FIG. 80 and FIG. 81 describe the structures of the LMT and LIT fields.

TABLE 39
Transport Packet

| | # of |
|---|---|
| Syntax | bits |
| Transport_Packet( ) | |
| { | |
| first_last | 2 |
| DC_flag | 1 |
| pointer_flag | 1 |
| padding_flag | 1 |
| LMT_flag | 1 |
| LIT_flag | 1 |
| PCR_flag | 1 |
| if(pointer_flag==1) | |
| pointer_field | 8 |
| if(padding_flag==1){ | |
| padding_length | 8 |
| for(i=0; i<N; i++) | |
| padding_byte | 8 |
| } | |
| if(LMT_flag==1){ | |
| type_bitmap | 3 |
| reserved | 1 |
| version_number | 4 |
| if(type_bitmap & 4){ | |
| num_of_real-time | 8 |
| for(i=0; i<num_of_real-time; i++) | |
| real-time_end_offset | 8 |
| } | |
| if(type_bitmap & 2){ | |
| num_of_IP | 8 |
| for(i=0; i<num_of_IP; i++) | |
| IP_end_offset | 8 |
| } | |
| if(type_bitmap & 1){ | |
| num_of_object | 8 |
| for(i=0; i<num_of_object; i++) | |
| object_end_offset | 8 |
| } | |
| } | |
| if(LIT_flag==1){ | |
| num_of_service | 6 |
| version_number | 10 |
| for(i=0; i<num_of_service; i++){ | |
| service_ID | 8 |
| do{ | |
| next_indicator | 1 |
| LMT_index_number | 7 |
| } while (next_indicator == 1) | |
| } | |
| } | |
| if(PCR_flag==1) | |
| { | |
| program_clock_reference_base | 33 |
| Reserved | 6 |
| program_clock_reference_extension | 9 |
| } | |
| for(i=0; i<N; i++){ | 8 |
| data_byte | |
| } | |
| } | |

first_last—This 2-bit field specifies if the packet is the first or last encapsulation packet, as defined in Table 35.

DC_flag—This 1-bit field, when set, indicates the presence of the decoder_configuration_information( ) structure (DCI). If the first_last field set to 1 or 3, and the pointer_field set to 1 it means that it provides random access functionality within packet and the encapsulation packet contains the DCI structure for the second encapsulation packet.

pointer_flag—This 1-bit field, when set, indicates the presence of the pointer_field.

padding_flag—This 1-bit field, when set, indicates the presence of padding.

LMT_flag—This 1-bit field, when set, indicates the presence of various LMT-related fields.

LIT_flag—This 1-bit field, when set, indicates the presence of various LIT-related fields.

PCR flag—This 1-bit field, when set, indicates the presence of the PCR-related fields.

pointer_field—This 8-bit field is an offset from the beginning of the transport packet to the first byte of the second encapsulation packet present in the same transport packet.

padding_length—This 8-bit field specifies the number of padding_byte's.

padding_byte—This 8-bit value is equal to 0xFF and can be inserted by the encoder. It is discarded by the decoder.

type_bitmap—This 3-bit field indicates the presence of various type-dependent fields.

When set: the first bit indicates the presence of the real-time media data channel-related fields; the second bit indicates the presence of the IP data channel-related fields; and the third bit indicates the presence of object data channel-related fields.

reserved—These bits are reserved for future use and shall be set to ‘1’.

version_number—This 4-bit field indicates the version number of the LMT fields. The version number shall be incremented by 1 modulo 16 whenever one of the LMT-related fields changes.

num_of_real-time—This 8-bit field indicates the number of real-time sub data channels in the real-time media type channel.

num_of_IP—This 8-bit field indicates the number of IP sub data channels in the IP type channel.

num_of_object—This 8-bit field indicates the number of object sub data channels in the object type channel.

real-time_end_offset—This 8-bit field indicates the end position of the real-time sub data channel of the real-time data type in the data channel. If the current MCAST parcel doesn't have a real-time data channel, then the offset should be set the same as the previous offset.

IP_end_offset—This 8-bit field indicates the end position of the IP sub data channel of the IP data type in the data channel. If the current MCAST parcel doesn't have an IP sub channel, then the offset should be set the same as the previous offset.

object_end_offset—This 8-bit field indicates the end position of the object sub data channel of the object data type in the data channel. If the current MCAST parcel doesn't have an object sub channel, then the offset should be set the same as the previous offset.

num_of service—This 6-bit field indicates the number of the available services in this data channel.

version_number—This 10-bit field specifies the version number of the Linkage Information Table-related fields. The version number shall be incremented by 1 whenever one of the LIT-related fields changes.

service_ID—This 8-bit field uniquely identifies the service in a Turbo channel.

next_indicator—This 1-bit field, when set, indicates the existence of additional next_indicator and LMT_index_number_fields. If set to 0 no more next_indicator and LMT_index_number fields are present after this pair.

LMT_index_number—This 7-bit field is the “array” index of each LMT.

reserved—These bits are reserved for future use and shall be filled with ‘1’.

program_clock_reference_base; program_clock_reference_extension—These shall be as defined in ISO/IEC 13818-1 [[142]].

data_byte—This contains the encapsulation packet data. When the transport packet contains the LMT and LIT fields, these data bytes are not defined in this document.

### 8 Power Management Mechanism

This section introduces the power saving mechanism in MCAST. In general, the critical factors of power consumption are the display panel (e.g. LCD) and the RF module. This section focuses on the power saving mechanism based on RF module control.

In generic broadcasting system, the RF module must be turned on and monitor all input frames to find the existence of wanted frames. In MCAST, all turbo services are grouped and mapped into sequence set of frames and the information like position, number of frame and etc are delivered via the SIC. From this information the device is made aware of the idle and active periods of interest.

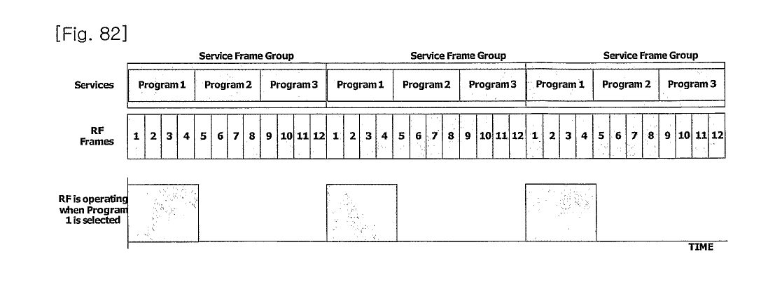

FIG. 82 is an example of MCAST frame slicing and how frame numbers are used to identify the service. For example, if the user selects program 1 then the RF module may work to receive frame number 1 to number 4 in the RF frame groups. That is, the transport layer is commanding to the physical layer to receive the frames from number 1 to 4. The number of RF frame groups can also be varied which is also signaled in the SIC.

Data transmitted in the burst mode are mapped to a multiple of 4 sectors. The required parameters for burst mode are: data rates, transmission period and turbo coding rates. These 3 parameters are used by following equation for the number of required sectors for burst transmission. The max number of sectors should not exceed 16.

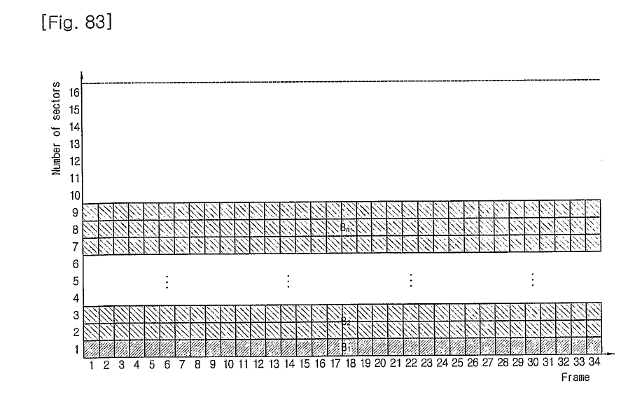

The number of sectors will be mapped into a sequence of frames in continuous mode. FIG. 83 depicts the relationship between number of blocks mapped to X and time mapped to Y in continuous mode.

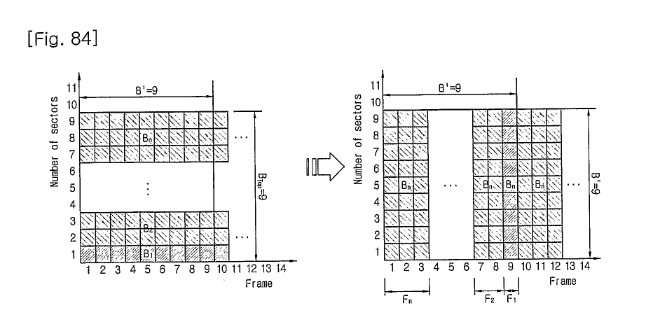

FIG. 84 rotates FIG. 83 90 degrees clockwise or counter clockwise. Assume that Bx is the transmission data for burst. The transmission period M, transmission period, Bx or multiple of 4 sectors. If M=k*Bx′ then, the required frames for service F, mapped to k*F. Following equations shows the relationship among data rates, transmission period and the number of frames.

B₁×M=Bₓ×F₁

B₂×M=Bₓ×F₂

B_{N}×M=Bₓ×F_{N}

F_{N}=Bₙ×M/Bₓ

Note that if Bₓ, F_{N}, M are not integer then they are rounded to nearest integer.

### 9 AL-FEC

### 9.1 AL-FEC Encoding Process

In a message word (u₁, u₂), each of u₁ and u₂ represents a bit string with length L (L>1). Similarly, in a codeword (v₁, v₂, v₃, v₄, v₅, v₆), vᵢ {i=1, . . . , 6} consists of a bit string with length L.

A message word (u1, u2) is encoded to a codeword (vᵢ, v₂, v₃, v₄, v₅, v₆) by v₁=u₁, v₂=u₁⊕u₂, v₃=u₁⊕u₂, v₄=u₂, v₅=u₁, v₆=u₂ when the generator matrix G is given by

$$\begin{matrix} & 1 \; 2 \; 3 \; 4 \; 5 \; 6 v / u\end{matrix}$$

$$G = [ \begin{matrix}1 \\ 0\end{matrix} \begin{matrix}1 \\ 1\end{matrix} \begin{matrix}1 \\ 1\end{matrix} \begin{matrix}0 \\ 1\end{matrix} \begin{matrix}1 \\ 0\end{matrix} \begin{matrix}0 \\ 1\end{matrix} ] \begin{matrix}1 \\ 2\end{matrix}$$

where the operator ⊕ means the bitwise exclusive-OR.

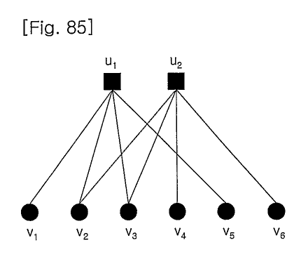

Since the length of codeword is three times of that of message word, the code rate is one third. The generator matrix can be conveniently expressed by a graph. FIG. 85 depicts the graph representing the above G matrix.

The generator matrix is an important element to be properly designed.

### 9.1.1 Concatenated AL-FEC

Following the widespread code concatenation construction, the above encoding process is extended to the concatenated encoding process.

### 9.2 Generator Matrix Design

### 9.2.1 Design Example [TBD]

### 9.2.2 Pre-Designed AL-FEC Code Table [TBD]

### 10 Scalable Video+FE

To support scalable Video Coding & FEC to allow for graceful service degradation in low S/N environments the Mac Layer can bind two Turbo channels together at physical layer and signal (SIC) this to receiver. A scalable Video codec is used at application layer and the base layer and audio along with signaling is multiplexed into turbo ch#1, the enhancement layer is multiplexed into turbo ch#2. Different FEC ¼ and ½ is applied independently to the layers. The Mac layer then will bind the turbo channels together and map them together at physical layer and signal this mapping via SIC. The binding allows a receiver to demodulate quickly the base+enhancement layers into memory. A receiving device has the option of just demodulation base layer only (Handheld) or Base & Enhance (Mobile). This provides scalability for different devices and graceful service degradation under low S/N. The codec could be a spatial scalable with base layer (QVGA), base+enhance layer (VGA).

### 11 Statistical Multiplexing with Adaptive Time Slicing

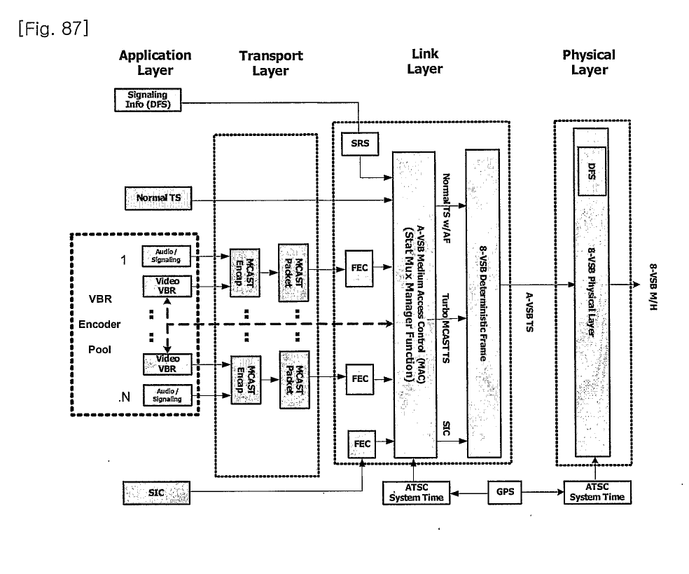

The efficiency that can be gain by employing statistical multiplexing techniques to control a pool of VBR video encoders is well known. Given a constant bandwidth this can be used to enable an overall higher video quality across a given number of channels or enable the capability to carry more channels with the same video quality. It is believed that the A-VSB M/H architecture will support such future extensibility and concept is illustrated in this section. This is shown first from a high level system architecture view FIG. 87.

This shows the A-VSB Mac layer is now also running a scheduling algorithm which performs a management function over a pool of (N) VBR video encoders.

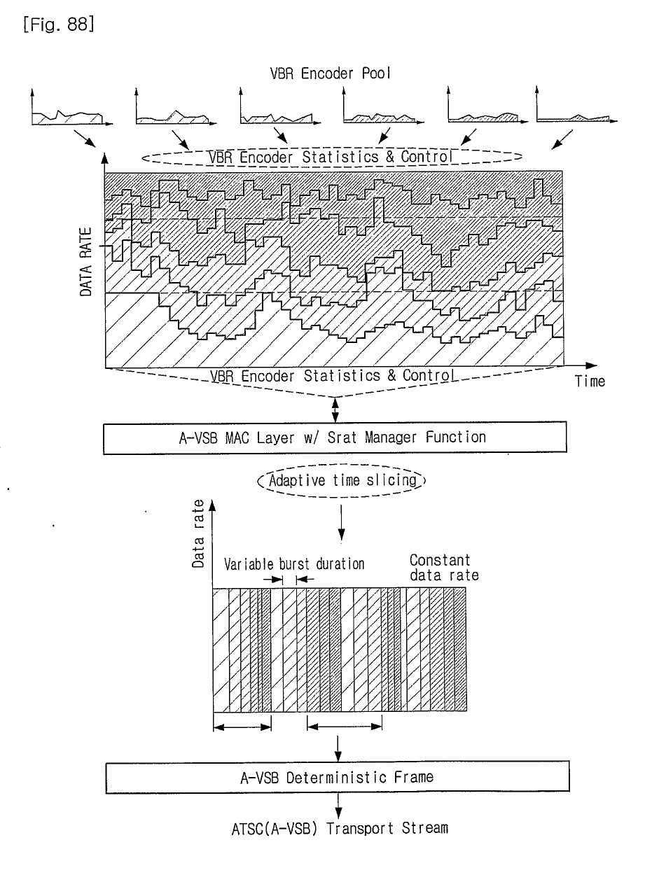

The Mac Layer with the embedded statistical manager shown keeps a total “Constant Data Rate” assigned to the pool of video encoders, and control dynamically via metadata from VBR encoder pool on scene complexities. Considering the FEC that will be applied the Mac Layer makes instantaneous decisions and control the encoders in the pool. This achieves the objective of keeping video quality the same but enabling maybe 5 or 6 channels instead of just 4 possible under CBR multiplexing, this shown in FIG. 88. It will be noticed that total data rate assign the pool is held constant but the Mac layer assigns a new burst start address and varies the individual “burst duration” as a function of the instantaneous scene complexities observed and this is signaled in SIC. This functionality is termed adaptive time slicing. The gains achieved will be directly proportional to size of pool (N). Increasing pool size will give better efficiency which can be as great as 40 percent. The more diverse the programming (not all sports) will also insure better video quality.

The Mac Layer communications with encoders could also enable the deterministic placement of an “I Frame” at beginning of each burst. This allows efficient use of a long GOP while ensuring that channel switching speed is not compromised.

### Annex A

### Processing Flow of DCI

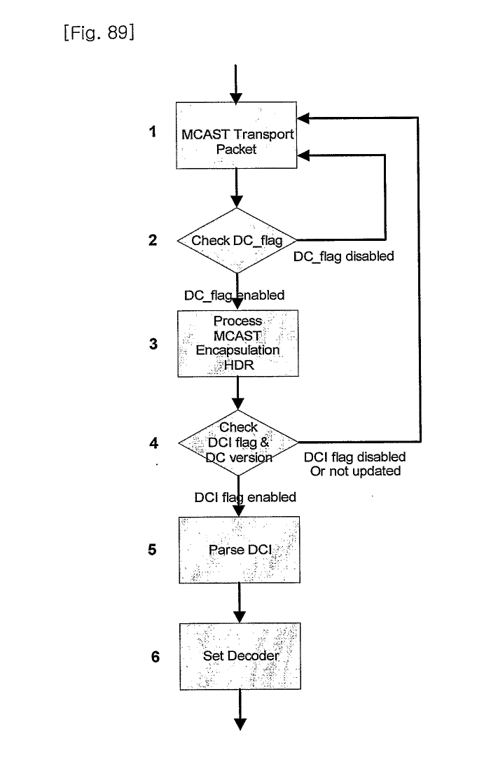

FIG. 89 shows the initialization process flow of the decoder when the user selects the mobile service in turbo channel.

The following procedures explain each step of FIG. 89 in more detail.

1. Receive MCAST Transport packet

2. Check the DC_flag

3. If RAP flag enabled then compose encapsulation packet

4. Check the DCI flag and version of DCI (Decoder Configuration Information)

5. Parse DCI structure

6. Set the appropriate decoder for the signaled types

### Annex B

### Processing Flow of LMT & LIT

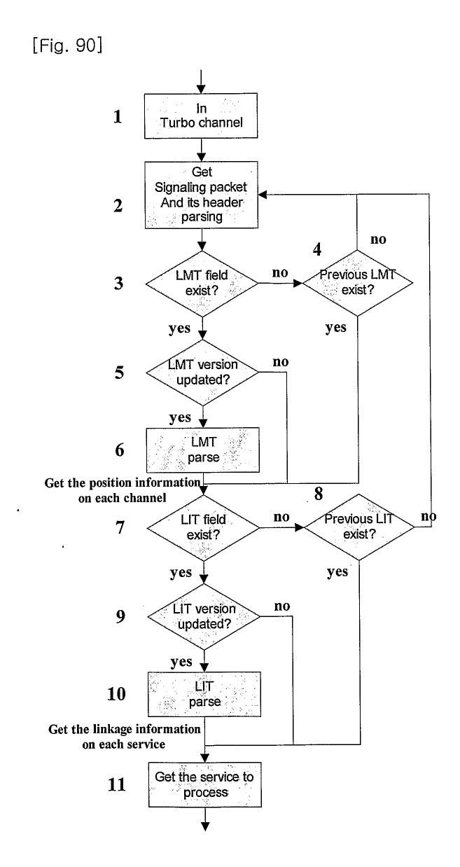

The FIG. 90 shows the decoder processing procedure of the LIT and LMT when the user selects the turbo channel.

The following procedures explain each step of FIG. 90 in more detail.
1. Select Turbo channel
2. Get the signaling packet which is located in the first position of the frame.
3. Check for the presence of the LMT in the signaling packet. If yes go to step 5.
4. Check whether there is a previous LMT which was cached or not. If yes go to step 7 (use the previous LMT), if no go back to step 2 (wait for the signaling packet which includes the LMT field)
5. Check the version number of the LMT. If it is the same as previous LMT then process with the previous LMT info. If it is new then parse and adopt the new one.
6. Parse the LMT field and get the position information on each sub-channel.
7. Check for the presence of the LIT in the signaling packet. If yes go to step 9.
8. Check whether there is a previous LIT which was cached or not. If yes go to step 11 (use the previous LIT), if no go back to step 2 (wait for the signaling packet which includes the LIT field)
9. Check the version number of the LIT. If it is the same as the previous LIT then process with the previous LIT info. If it is new then parse and adopt the new one.
10. Parse the LIT field and get the linkage information on each service.
11. Get the service to process

### II. Technical Disclosure

### Physical Layer for ATSC-M/H System

### 1 Scope

### 1.1 Purpose

This document constitutes the specification for the Advanced VSB (A-VSB) system. The syntax and semantics of this document conform to A/53 and ISO/IEC 13818-1, with additional constraints and conditions specified herein.

### 1.2 Application

The behavior and facilities of this document are intended to apply to terrestrial television broadcast systems and receivers. In addition, the same behavior and facilities may be specified and/or applied to other transport systems (such as cable or satellite).

### 1.3 Organization

This document is organized as follows:

Section 1—Describes purpose, application and organization of this specification

Section 2—Enumerates normative and informative references

Section 3—Defines acronyms, terminology, and conventions

Section 4—Provides an overview of the Advanced VSB System

Section 5—Defines the Deterministic Frame (DF)

Section 6—Defines the Deterministic Trellis Reset (DTR)

Section 7—Defines the Supplementary Reference Sequence (SRS)

Section 8—Defines the Turbo Stream

Section 9—Defines the Physical layer signaling

Annex A—Describes the 8-VSB Reed-Solomon Encoder

Annex B—Describes the 8-VSB Byte Interleaver

Annex C—Describes an issue with use of the adaptation field

This document makes use of certain notational devices to provide valuable informative and explanatory information in the context of normative and, occasionally, informative sections. These devices take the form of paragraphs labeled as Example or Note. In each of these cases, the material is to be considered informative in nature.

### 2 References

The following documents are essential references for this document. At the time of publication, the editions indicated were valid. For references not including a publication date, the most recent published version shall apply. All external documents are subject to revision and amendment, and parties to agreements based on this document are encouraged to investigate the possibility of applying the most recent editions of the documents listed below.

### 2.1 Normative References

The following documents contain provisions that in whole or in part, through reference in this text, constitute normative provisions of this document.

1. ATSC A/53D: “ATSC Standard: Digital Television Standard (A/53), Revision D”, Advanced Television Systems Committee, Washington, D.C.

1)

2. ATSC A/110A: “Synchronization Standard for Distributed Transmission, Revision A”, Section 6.1, “Operations and Maintenance Packet Structure”, Advanced Television Systems Committee, Washington, D.C.

2)

### 2.2 Informative References

The following documents contain information which may be useful to the reader [TBD—detailed titles and numbers].

3. “ASI”

4. SMPTE 310M,

5. ISO/IEC 13818-1:2000,

6. “Single Frequency Network”

3) 7. “Working Draft Amendment 2 to ATSC Digital Television Standard (A/53C) with Amendment 1 and Corrigendum 1”

### 3 Definition of Terms

With respect to definition of terms, abbreviations, and units, the practice of the Institute of Electrical and Electronics Engineers (IEEE) as outlined in the Institute's published standards shall be used. Where an abbreviation is not covered by IEEE practice, or industry practice differs from IEEE practice, then the abbreviation in question will be described in Sections 3.3 and 3.4 of this document.

### 3.1 Conformance Notation

As used in this document, “shall” or “will” denotes a mandatory provision of the document. “Should” denotes a provision that is recommended but not mandatory. “May” denotes a feature whose presence does not preclude conformance, which may or may not be present at the option of the implementer.

### 3.2 Treatment of Syntactic Elements

This document contains symbolic references to syntactic elements used in the audio, video, and transport coding subsystems. These references are typographically distinguished by the use of a different font (e.g., restricted), may contain the underscore character (e.g., sequence_end_code) and may consist of character strings that are not English words (e.g., dynrng).

### 3.3 Acronyms and Abbreviation

The following acronyms and abbreviations are used within this specification.

### DF Deterministic Frame

AF Adaptation Field in A/53 defined TS packet

### DFS Data Field Sync

### DTR Deterministic Trellis Reset

### OMP Operations and Maintenance Packet

### PCR Program Clock Reference

### RS Reed-Solomon

### SRS Supplementary Reference Sequence

### TA Transmission Adapter

### TCM Trellis Coded Modulation

TS A/53 defined Transport Stream

### PSI/PSIP Program Specific Information/Program Specific Information Protocol

### UTF Unit Turbo Fragment

### 3.4 Terms

Data Frame—consists of two Data Fields, each containing 313 Data Segments. The first Data Segment of each Data Field is a unique synchronizing signal (Data Field Sync)

Emission Multiplexer—a special purpose ATSC multiplexer that is used at the facility and feeds directly an 8-VSB transmitter, or transmitters, each having an ATSC modulator.

Exciter—receives the baseband signal (Transport Stream) performs the main functions of channel coding and modulation and produces RF Waveform at assigned frequency. Is capable of receiving external reference signals such as 10 MHz frequency and One Pulse per second (1PPS) temporal from GPS.

MPEG data—sync byte-absent TS

MPEG data packet—sync byte-absent TS packet

N_{SRS}—number of SRS bytes in AF in a TS or MPEG data packet

N_{TStream}—number of Turbo fragment bytes in AF in a TS or MPEG data packet

Segment—in ATSC Normal/A53 exciter, MPEG data are interleaved by ATSC A/53 Byte Interleaver. Then, a data unit of consecutive 207 bytes is called a segment payload or just segment.

Slice—group of 52 segments

Sliver—group of 52 TS or MPEG data packets

SRS-bytes—Pre-calculated bytes to generate SRS-symbols

SRS-symbols—SRS created with SRS-bytes through zero-state TCMs

TCM Encoder—a set of the Pre-Coder, Trellis Encoder, and 8 level mapper

Turbo Fragment—Reserved space in AF for Turbo stream (See Unit Turbo Fragment)

Turbo MPEG data packet—sync byte-absent Turbo TS packet

Turbo payload—Payload carried in Turbo TS packet

Turbo PPS—Turbo Pre-processed Stream

Turbo PPS packet—Turbo Pre-processed Stream packet

Turbo Stream—Turbo coded Transport Stream

Turbo TS packet—Turbo coded Transport Stream packet

VSB Frame—626 segments consisting of 2 data field sync segments and 624 (data+FEC) segments

TUF—32 bytes of reserved space in AF for Turbo stream (Turbo Unit Fragment)

### 4 System Overview

The first objective of A-VSB is to improve reception issues of 8-VSB services in fixed or portable modes of operation. This system is backward-compatible in that existing receiver designs are not adversely affected by the Advanced signal.

This document defines the following core techniques:
Deterministic Frame (DF)
Deterministic Trellis Reset (DTR) And, this document defines the following “application tools”:
Supplementary Reference Sequence (SRS)
Turbo Stream

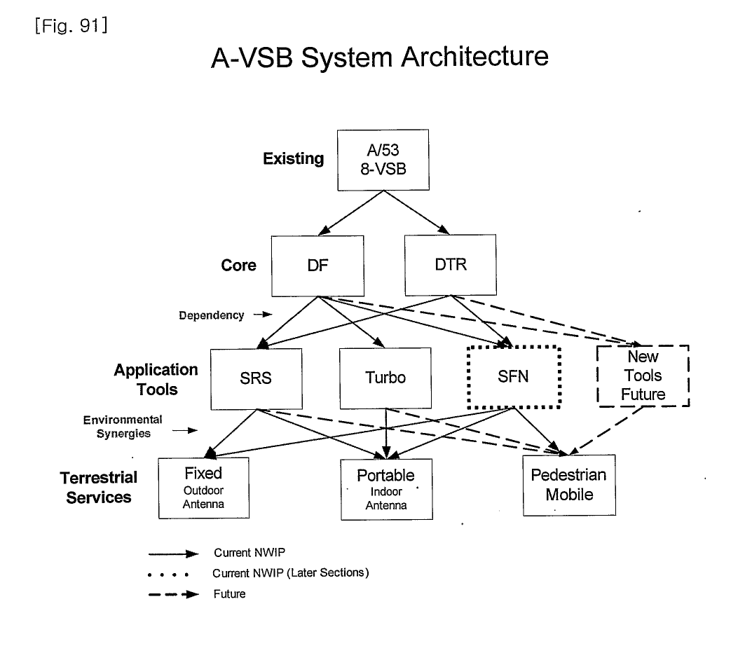

These core techniques and application tools can be combined as shown in FIG. 91. It shows the core techniques (DF, DTR) as the basis for all of the application tools defined here and potentially in the future. The solid green lines show this dependency. Certain tools are used to mitigate propagation channel environments expected for certain broadcast services. Again the green lines show this relationship. Tools can be combined together synergistically for certain terrestrial environments. The green lines demonstrate this synergy. The dash lines are for potential future tools not defined by this document.

The Deterministic Frame (DF) and Deterministic Trellis Reset (DTR) core techniques both prepare the 8-VSB system to be operated in a deterministic, or synchronous manner. In the A-VSB System the emission multiplexer has knowledge of and signals the start of the 8-VSB Frame to the A-VSB modulator. Prior knowledge is an inherent feature of the emission multiplexer which allows intelligent multiplexing. DF and DTR core techniques are backwards compatible with existing receiver designs.

The absence of frequent equalizer training signals has encouraged receiver designs with an over dependence on “blind equalization” techniques to mitigate dynamic multipath. The SRS offers a system solution with frequent equalizer training signals to overcome this using the latest algorithmic advances in receiver design principles. The SRS application tool is backwards compatible with existing receiver designs (the information is ignored), but improves normal stream reception in SRS-designed receivers.

Turbo Stream provides an additional level of error protection capability. This brings robust reception in terms of lower SNR receiver threshold and improvements in multi-path environments. Like SRS, the Turbo Stream application tool is backwards compatible with existing receiver designs (the information is ignored).

The tools such as SRS and Turbo Stream can be used independently. There is no dependency among these application tools. Any combination of them is possible.

One tool not covered in this document is the Single Frequency Network (SFN) which is one example of how to make use of the core techniques and the application tools.

### 5 Deterministic Frame (DF)

### 5.1 Introduction

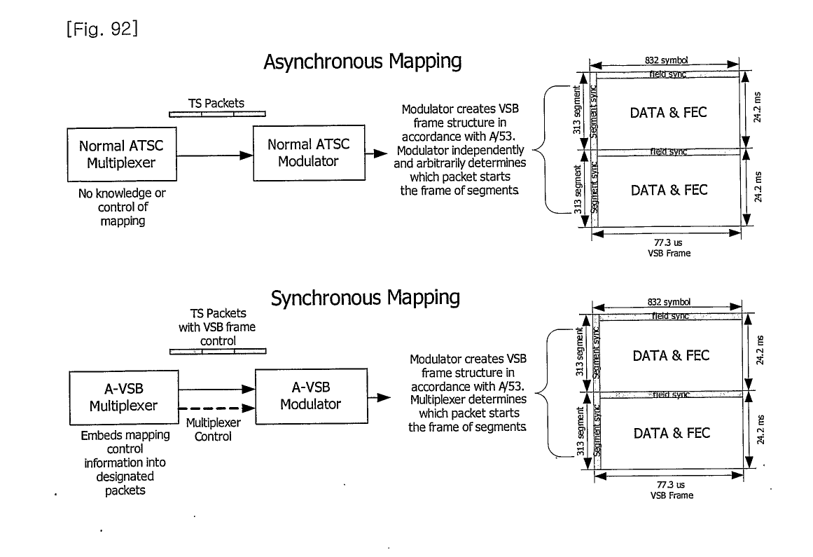

The first core technique of A-VSB is to make the mapping of ATSC Transport Stream packets a synchronous process (currently this is an asynchronous process). The current ATSC multiplexer produces a fixed rate Transport Stream with no knowledge of the 8-VSB physical layer frame structure or mapping of packets. This is depicted in the top of FIG. 92.

When powered on, the normal (8-VSB) ATSC modulator independently and arbitrarily determines which packet begins the frame of segments. Currently, no knowledge of this decision and hence the temporal position of any transport stream packet in the VSB frame is available to the current ATSC multiplexing system.

In the A-VSB system, the emission multiplexer makes a selection for the first packet in the frame which it uses as the start of the frame of packets. This framing decision is then signaled to the A-VSB modulator, which is a slave to the emission multiplexer for this framing decision.

In summary, the starting packet coupled with knowledge of fixed VSB Frame structure gives the emission multiplexer knowledge of every packet position in the frame. This situation is shown in the bottom of FIG. 92. Further, the A-VSB-enabled emission multiplexer works synchronously (master/slave) with the A-VSB modulator to perform intelligent multiplexing. Knowledge of the DF allows pre-processing in an A-VSB-enabled emission multiplexer and synchronous post-processing in an A-VSB-enabled modulator.

### 5.2 Emission Multiplexer to Modulator Control

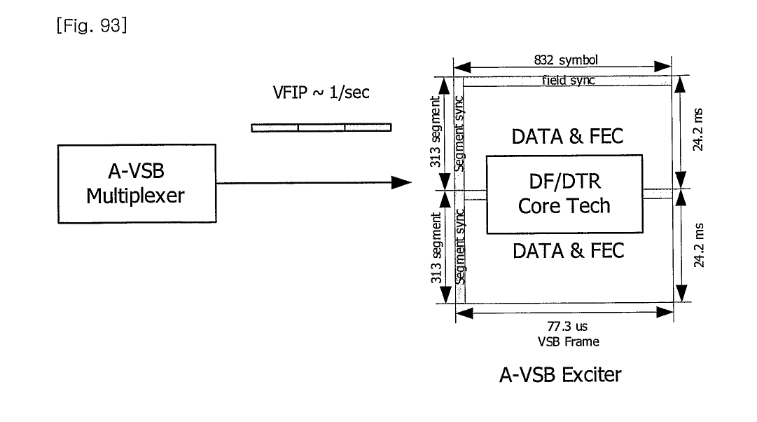

The Deterministic Frame is required to enable the A-VSB-enabled emission multiplexer and an A-VSB-enabled modulator to implement the DF functionality. The configuration is shown in FIG. 93.

Additionally, the emission multiplexer Transport Stream Clock and the Symbol Clock in the A-VSB Modulator shall be locked to a common universally available frequency reference. This may be accomplished with an external frequency reference such as a 10 MHz reference from a GPS receiver. Locking both Symbol and Transport clocks to an external reference brings the stability and buffer management needed in a simple and straight-forward manner.

Note: The normal ATSC Modulator symbol clock is locked to the incoming SMPTE 310M and has a tolerance of +/−30 Hz. By locking both to common external reference this prevents rate adaptation or stuffing by the Modulator in response to drift of the SMPTE 310M+/−54 Hz tolerance. This helps maintains the Deterministic Frame once initialized. ASI is the preferred transport stream interface, however SMPTE 310M can still be used.

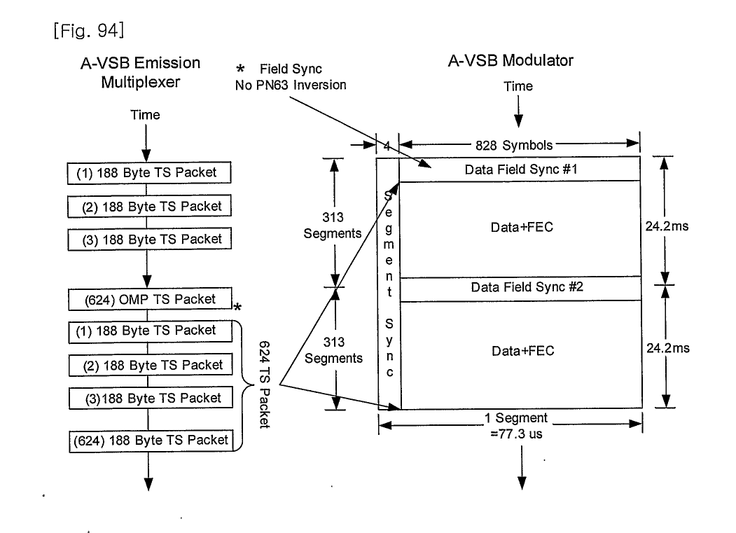

The Emission Multiplexer shall be the master and signals which transport stream packet shall be used as the first VSB Data segment in a VSB Frame. Since the system is operating with synchronous clocks it can be stated with 100 percent certainty which 624 Transport Stream packets make up a VSB Frame with the A-VSB Modulator slaved to syntax and semantics of Emission Multiplexer. A simple Frame counter of 624 TS packets is maintained in the Emission Multiplexer. The DF is achieved through the insertion of a special packet delivered to a modulator, which is called the df_dtr_omp_packet, as defined in Section 5.3. This DF packet shall be the last packet in group of 624 packets when it is inserted, as shown in FIG. 94.

### 5.3 Operations and Maintenance Packet (OMP)

In addition to the common clock, a special Transport Stream packet is needed. This packet shall be an Operations and Maintenance Packet as defined in ATSC A/110A, Section 6.1. New values of OM_type are defined here to extend the use defined by A/110A.

Note: This packet is on a reserved PID, 0x1FFA.

The presence of this packet in the last packet location of the frame provides the deterministic framing.

The emission multiplexer shall insert this special OMP into the transport stream once every 20 frames (˜1/sec) which signals the modulator to start a VSB frame. The insertion as the last 624th packet in the frame shall cause the modulator to insert a Data Field Sync with No PN63 inversion of middle PN63 after the last bit of the OMP.

The complete packet syntax shall be as defined in Table 40.

TABLE 40
DF OMP Packet Syntax

| Syntax | # of Bits | mnemonic |
|---|---|---|
| df_omp_packet( ) { | | |
| transport_packet_header | 32 | bslbf |
| OM_type | 8 | bslbf |
| reserved | 8 | uimsbf |
| private | 182 * 8 | uimsbf |

transport_packet_header—as defined and constrained by ATSC A/110A, Section 6.1.

OM_type—as defined in ATSC A/110A, Section 6.1 and set to 0x20.

private—defined by other core techniques and/or application tools. If unused, shall be set to 0x00.

### 6 Deterministic Trellis Reset (DTR)

### 6.1 Introduction

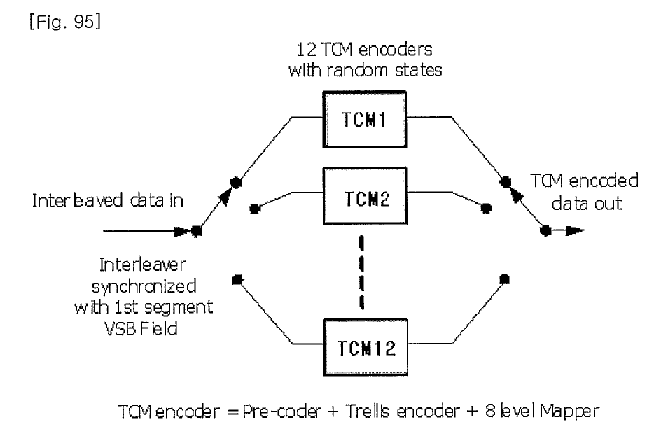

The second core technique is the Deterministic Trellis Resetting (DTR) which resets the Trellis Coded Modulation (TCM) encoder states (the Pre-Coder and Trellis Encoder States) in the ATSC modulator. The reset signaling is at selected temporal locations in the VSB Frame. FIG. 95 shows that the states of the (12) TCM Encoders in 8VSB are random. No external knowledge of the states can be known due to the random nature in the current A/53 design. The DTR offers a new mechanism to force all TCM Encoders to zero state (a known deterministic state). This document refers to the intra-segment interleaver as a byte splitter as that is felt to be more precise term for the function.

### 6.2 Operation of State Reset

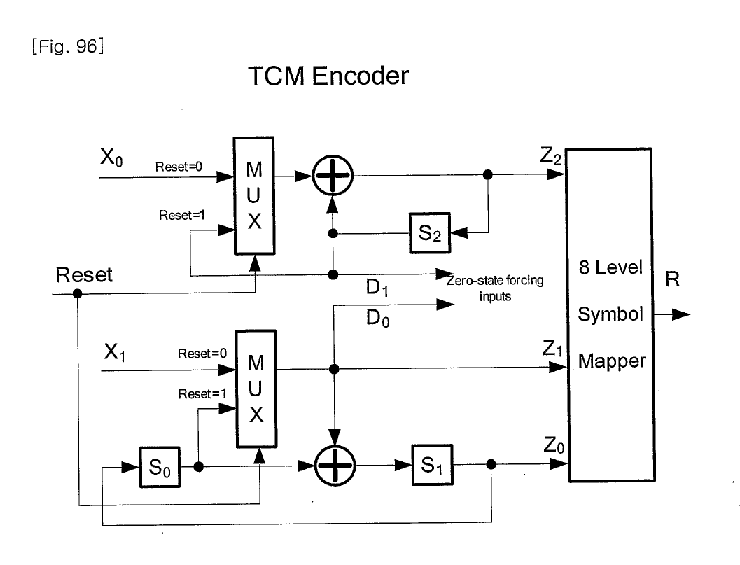

FIG. 96 shows (1 of 12) TCM Encoders used in Trellis Coded 8-VSB (8T-VSB). There are two new Multiplexer circuits added to existing logic gates in circuit shown. When the Reset is inactive (Reset=0) the circuit performs as a normal 8-VSB TCM encoder.

The truth table of an XOR gates states, “when both inputs are at like logic levels (either 1 or 0), the output of the XOR is always 0 (Zero).” Note that there are three D-Latches (S0, S1, S2), which form the memory. The latches can be in one of two possible states (0 or 1). Therefore as shown in Table 41, second column indicates eight (8) possible starting states of each TCM encoder. Table 41 shows the logical outcome when the Reset signal is held active (Reset=1) for two consecutive Symbol Clock periods. Independent of the starting state of the TCM, it is forced to a known Zero state (S0=S1=S2=0). This is shown in next to last column labeled Next State. Hence a Deterministic Trellis Reset (DTR) can be forced over two symbol clock periods. When the Reset is not active the circuit performs normally.

TABLE 41
Trellis Reset Truth Table

| | | | | | (S0 S1 | |
|---|---|---|---|---|---|---|
| | (S0 S1 | | (S0 S1 | | S2) Next | Output |
| Reset at | S2) at | (D0 D1) at | S2) at | (D0 D1) at | State at | (Z2 Z1 |
| t = 0 | t = 0 | t = 0 | t = 1 | t = 1 | t = 2 | Z0) |
| 1 | 0, 0, 0 | 0, 0 | 0, 0, 0 | 0, 0 | 0, 0, 0 | 000 |
| 1 | 0, 0, 1 | 0, 1 | 0, 0, 0 | 0, 0 | 0, 0, 0 | 000 |
| 1 | 0, 1, 0 | 0, 0 | 1, 0, 0 | 1, 0 | 0, 0, 0 | 000 |
| 1 | 0, 1, 1 | 0, 1 | 1, 0, 0 | 1, 0 | 0, 0, 0 | 000 |
| 1 | 1, 0, 0 | 1, 0 | 0, 0, 0 | 0, 0 | 0, 0, 0 | 000 |
| 1 | 1, 0, 1 | 1, 1 | 0, 0, 0 | 0, 0 | 0, 0, 0 | 000 |
| 1 | 1, 1, 0 | 1, 0 | 1, 0, 0 | 1, 0 | 0, 0, 0 | 000 |
| 1 | 1, 1, 1 | 1, 1 | 1, 0, 0 | 1, 0 | 0, 0, 0 | 000 |

Additionally, zero-state forcing inputs (D0, D1 in FIG. 96) are available. These are TCM Encoder inputs which forces Encoder state to be zero. During the 2 symbol clock periods, they are produced from the current TCM encoder state. At the instant to reset, the inputs of TCM Encoder are discarded and the zero-state forcing inputs are fed to a TCM Encoder over two symbol clock periods. Then the TCM Encoder state becomes zero. Since these zero-state forcing inputs (D0, D1) are used to correct parity errors induced by DTR, they should be made available to any application tools.

The actual point at which reset is performed is dependent on the application tool. See the Supplementary Reference Sequence (SRS) for an example.

### 7 Supplementary Reference Sequence (SRS)

### 7.1 Introduction (Informative)

The current ATSC 8-VSB system can be improved to provide reliable reception for fixed, indoor, and portable environments in the dynamic multi-path interference by making known symbol sequences frequently available. The basic principle of Supplementary Reference Sequence (SRS) is to periodically insert a special known sequence in a deterministic VSB frame in such a way that a receiver equalizer can utilize this known contiguous sequence to adapt itself to track a dynamically changing channel and thus mitigate dynamic multi-path and other adverse channel conditions.

### 7.2 An Encoding Process

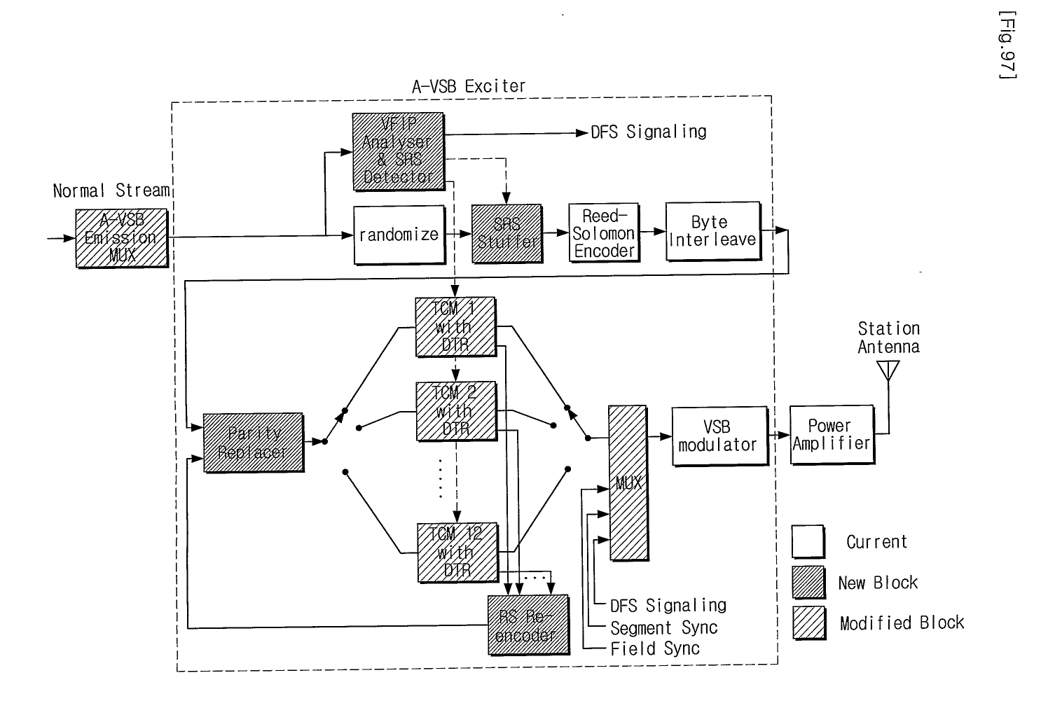

An SRS-enabled ATSC DTV Transmitter is shown in FIG. 97. The blocks modified for SRS processing are shown in pink (Multiplexer and TCM encoders block) while the newly introduced block (SRS stuffer) is shown in yellow. The other blocks are the current ATSC DTV blocks. The ATSC Emission Multiplexer takes into consideration a pre-defined deterministic frame template for SRS. The generated packets are prepared for the SRS post-processing in an A-VSB modulator.

The (Normal A/53) randomizer drops all sync bytes of incoming TS packets. The packets are then randomized. Then the SRS stuffer fills the stuffing area in the adaptation fields of packets with a pre-defined byte-sequence, (the SRS-bytes). The SRS-bytes-containing packets are then processed for forward error corrections with the (207, 187) Reed-Solomon code. In the byte Interleaver, bytes of RS-encoder output get interleaved. As a result of the byte Interleaving, the SRS-bytes are placed into contiguous 52 byte positions in 10, 15, 20 or 26 segments. The segment (or the payload for a segment) is a unit of 207 bytes after byte Interleaving. These segments are encoded in (12) TCM encoders. At the beginning of each interleaver-re-arranged SRS-byte sequence, the Deterministic Trellis Reset (DTR) occurs to prepare the generation of known 8 level symbols. These generated symbols have specific properties of noise-like spectrum and zero dc-value which are SRS-byte design criteria.

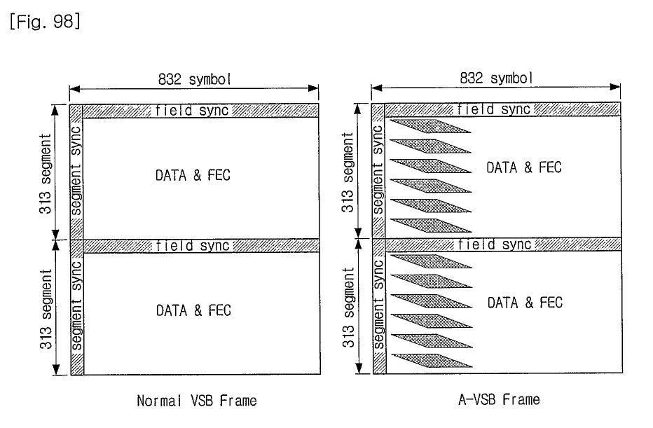

When the TCM encoder states are forced to a known deterministic state by DTR, a pre-determined known byte-sequence (SRS-bytes) inserted by the SRS Stuffer is then TCM encoded immediately. The resulting 8-level symbols at the TCM encoder output will appear as known contiguous 8-level symbol patterns in known locations in the VSB frame. This 8 level symbol-sequence is called SRS-symbols and is available to the receiver as additional equalizer training sequence. FIG. 98 shows the normal VSB frame on the left and an A-VSB frame on the right with SRS turned on. Each A-VSB frame has 12 groups of SRS 8-level symbols. Each group is in 10, 15, 20 or 26 sequential data-segments depending on SRS-N. On MPEG-2 TS decoding, the SRS symbols appearing in the adaptation field will be ignored by a legacy receiver. Hence the backward compatibility is maintained.

FIG. 98 shows 12 (green) groups which have different composition depending on the number of SRS bytes. The actual SRS-bytes that are stuffed and the resulting group of SRS symbols are pre-determined and fixed.

Note: The normal 8-VSB standard has two DFS per frame, each with training sequences (PN-511 and PN-63s). In addition to those training sequences, the A-VSB provides 184 symbols of SRS tracking sequences per segment in group of 10, 15, 20, or 26 segments. Number of such segments (with known 184 contiguous SRS symbols) available per frame will be 120, 180, 240, and 312 for SRS-10, SRS-15, SRS-20, and SRS-26 respectively. These can help a new SRS receiver's equalizer track dynamic changing channel conditions when objects in the environment or the receiver itself is in motion

Since these changes (DTR and that altering SRS-bytes) occur after Reed-Solomon encoding, previously calculated RS parity bytes are no longer valid. In order to correct these erroneous parity bytes, they are re-calculated in the “RS Re-encoder” in FIG. 97. The old parity-bytes are replaced with re-calculated parity-bytes in the “Parity Replacer” block in FIG. 97. This process is expounded in Section 7.2.4

The Turbo Stream post-processor in FIG. 97does nothing to change this process as the input just passes through to the output.

The remaining blocks are the same as the standard ATSC VSB modulator. Each block in FIG. 97 is described in the following sections.

### 7.2.1 ATSC Emission Multiplexer for SRS

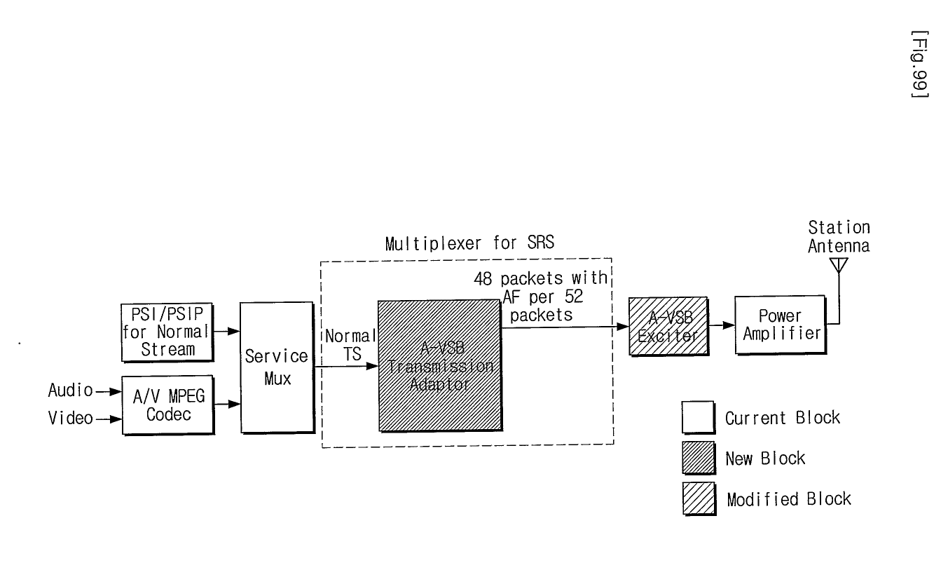

ATSC Emission Multiplexer for SRS is shown in FIG. 99. There is a new conceptual process block, Transmission Adaptor (TA). The Transmission Adaptor re-packetizes all elementary streams to properly set adaptation fields which serve as SRS-byte placeholders.

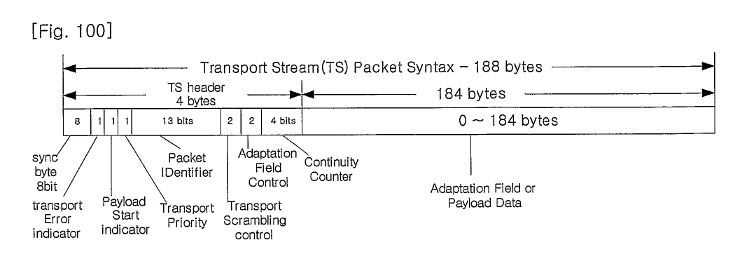

The normal MPEG-2 TS packet syntax is shown in FIG. 100. The adaptation field control in the TS header signals that an adaptation field is present.

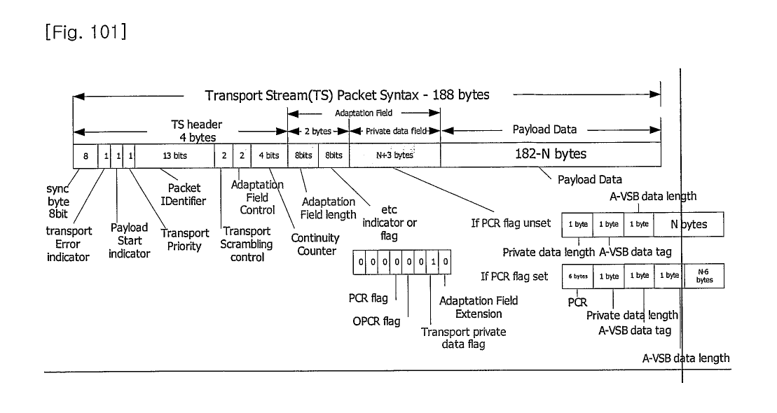

The normal transport packet syntax with an adaptation field is shown in FIG. 101. The “etc indicator” is a 1 byte field for various flags including PCR. See ISO 13818-1 for more details.

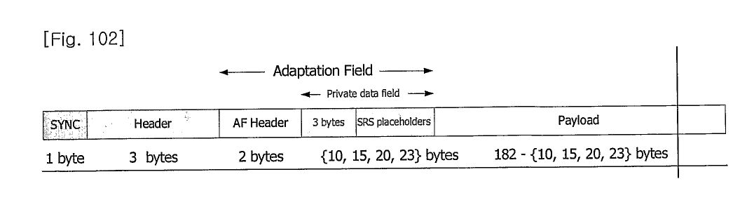

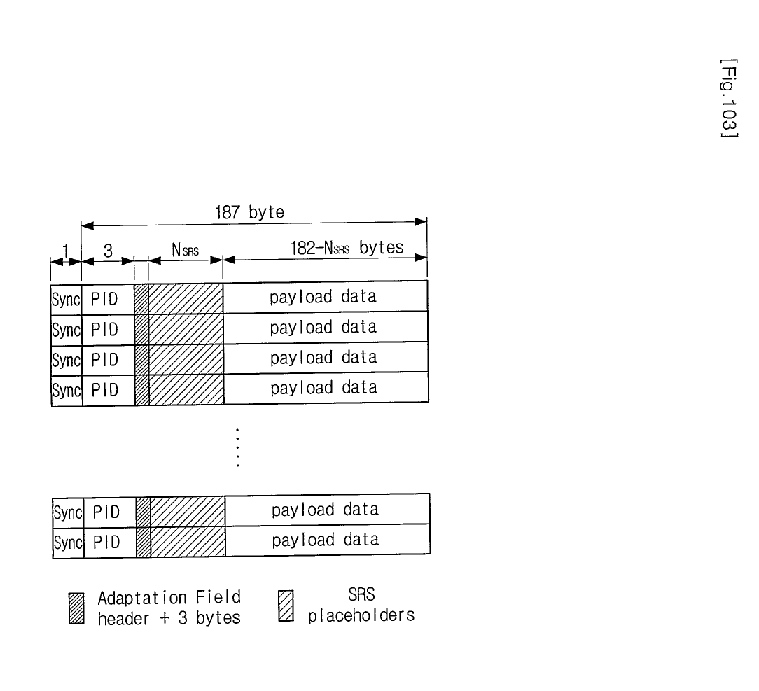

It could be convenient for an upstream device to insert a placeholder for the fixed SRS bytes that are stuffed later. A typical SRS-placeholder-carrying packet is depicted in FIG. 102. and a transport stream with the SRS-placeholder-carrying packets is depicted in FIG. 103, which is the output of the Emission Multiplexer.

This design assumes there is an adaptation field in every packet.

### 7.2.2 A-VSB Exciter for SRS

All TS packets issued by an Emission Multiplexer are assumed to have SRS placeholder adaptation fields for later SRS processing in the Modulator. Before any processing in a Modulator, all sync bytes of packets are eliminated.

It is very helpful to understand the detailed knowledge of the 8-VSB modulator components, and how they can be leveraged to make SRS work.

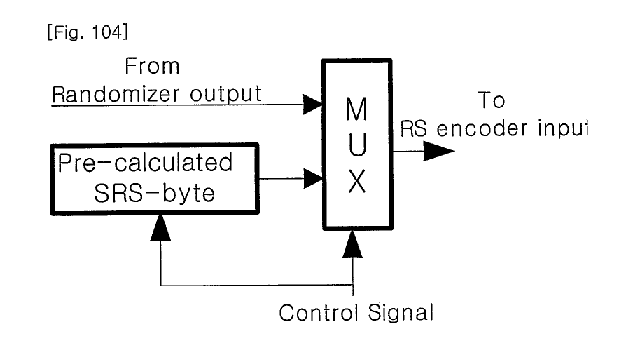

The basic operation of the SRS stuffer is to stuff the SRS bytes into the stuffing area of the adaptation field in each packet. In FIG. 104, the pre-defined fixed SRS-bytes are stuffed into the adaptation field of incoming packets by the control signal at SRS stuffing time. The control signal switches the output of the SRS stuffer to the pre-calculated SRS-bytes properly configured for insertion before the Interleaver.

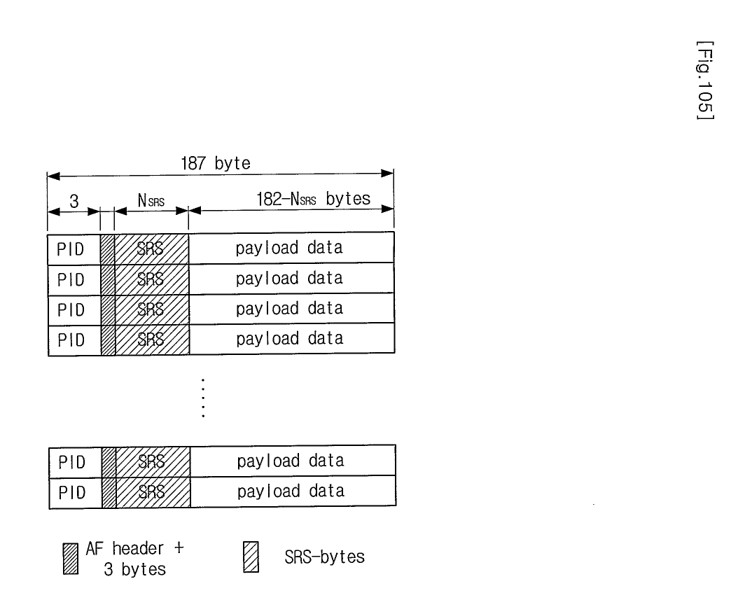

FIG. 105 depicts the packets carrying SRS-bytes in the adaptation field that previously contained the stuffing bytes (see FIG. 103).

The SRS stuffer needs to be careful not to overwrite a PCR or other standard adaptation field values when they are present in the adaptation field.

### 7.2.3 Frame Structure for SRS

A VSB Frame is composed of 2 Data Fields, each data field having a Data Field Sync and 312 data segments. A VSB sliver and slice are defined as a group of 52 MPEG-2 data packets and 52 data segments respectively. So a VSB Frame has 12 slices. This 52 data segment granularity fits well with the special characteristics of the 52 segment VSB-Interleaver.

There are several pieces of information to be delivered through the adaptation field, along with the SRS Bytes to be compatible with A/53. These can be PCR, splice counter, private data and so on. From the ATSC perspective of an Emission Multiplexed, the PCR (Program Clock Reference) and Splice counter must be also carried when needed along with the SRS. This imposes a constraint during the TS packet generation since the PCR is located at the first 6 SRS-bytes. This conflict is solved using the Deterministic Frame (DF). The DF enables {PCR, splice counter}-containing packet to be located in a known position of a slice. Thus a modulator designed for SRS can know the temporal position of the PCR and splice counter and accordingly fill the SRS-bytes, avoiding this other adaptation field information.

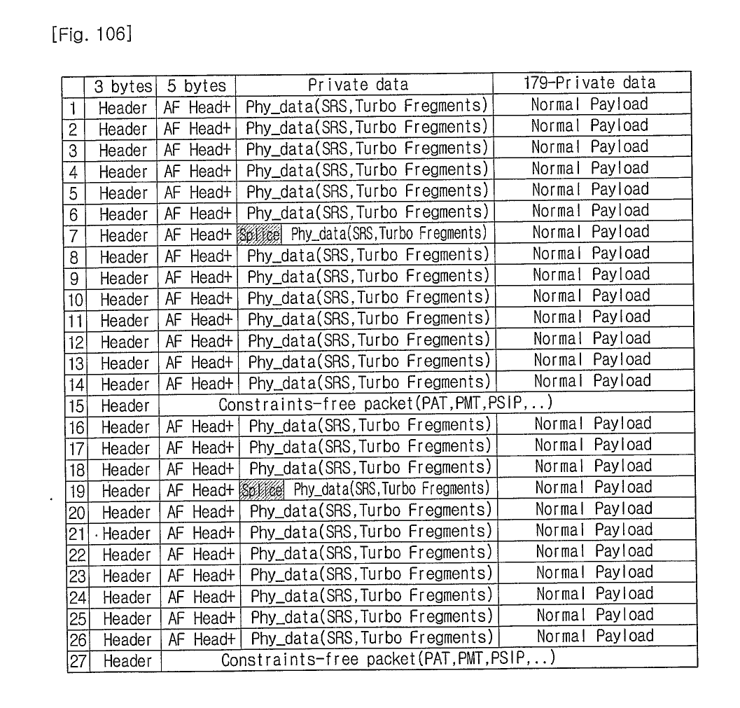

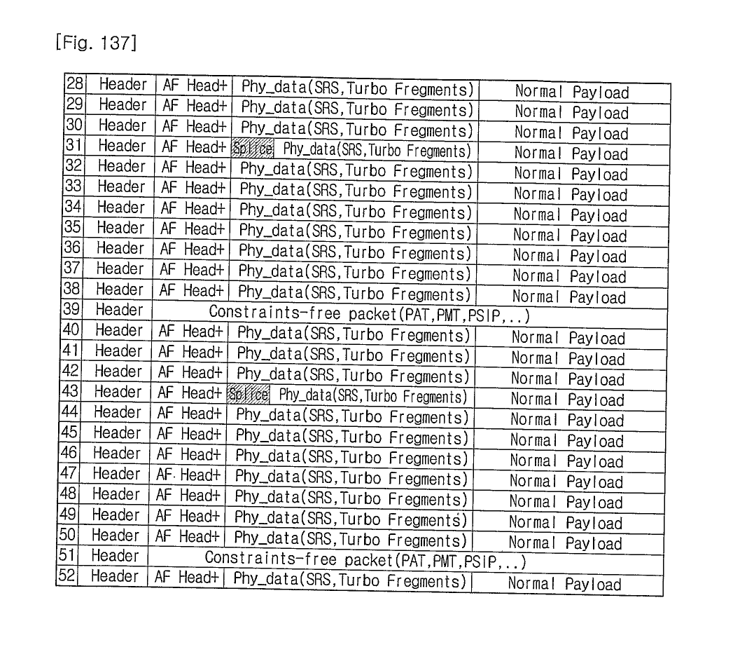

One sliver of SRS DF is shown in FIGS. 106, 137. The SRS DF template stipulates that the 15th, 27th, 39th, and 51st (7th, 19th, 31st, 43rd) MPEG data packets in every VSB Sliver can be a PCR (Splice counter)-carrying packet. This set-up makes the PCR (and Splice counter) available at about 1 ms. This is well within the required frequency limit (minimum 40 ms) for PCR.

Obviously, a normal payload data rate with SRS will be reduced depending on SRS-N bytes in FIG. 105. The N can be 0 through 26, SRS-0 bytes being normal ATSC 8-VSB. The proposed values of SRS-N bytes are {10, 15, 20, and 26} bytes listed in Table 42. The table gives the four SRS byte length candidates. SRS-byte length choices are signaled through the OMP packet to the modulator from the Emission Multiplexer and also through Walsh codes in the DFS Reserved bytes from the modulator to the receiver.

Table 42 shows also the payload loss associated with each choice. Rough payload loss can be calculated as follows. Since 1 slice takes 4.03 ms, the payload loss due to SRS-10 bytes is

$$\frac{( 10 + 2 ) bytes \cdot 52 packets}{4.03 ms} \cdot 8 = 1.24 Mbps$$

Similarly, payload loss of SRS {15, 20, 26} bytes is {1.75, 2.27, 2.89} Mbps. The known SRS-symbols are used to update Equalizer in the receiver. The degree of improvement achieved for a given SRS-N byte will depend on a particular Equalizer design.

TABLE 42
Recommended SRS-N byte

| SRS Mode | Choice 1 | Choice 2 | Choice 3 | Choice 4 |
|---|---|---|---|---|
| SRS-bytes | 10 bytes | 15 bytes | 20 bytes | 23 bytes |
| Length N_{SRS} | | | | |
| Payload Loss | 1.24 Mbps | 1.75 Mbps | 2.27 Mbps | 2.89 Mbps |

7.2.4 8-VSB Trellis Encoder Block with Parity Correction

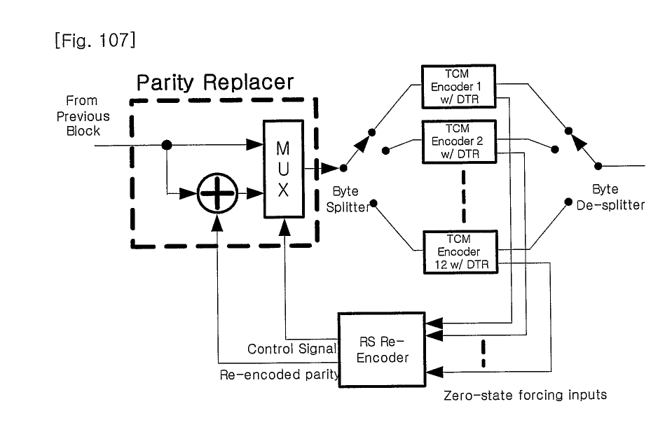

FIG. 107 shows the block diagram of the TCM encoder block with parity correction. The RS re-encoder receives zero-state forcing inputs from TCM encoders with DTR in FIG. 96. The message word for RS-re-encoding is synthesized by taking all zero-bit word except the bits replaced by zero-state forcing inputs. After synthesizing a message word in this way, RS re-encoder calculates the parity bytes. As RS codes are linear codes, any codeword given by the XOR operation of two valid codewords is also a valid codeword. When the parity bytes to be replaced arrive, genuine parity bytes are obtained by the XOR operation of the incoming parity bytes and the parity bytes computed from the synthesized message word. For example, assume that an original codeword by (7, 4) RS code is [M₁ M₂ M₃ M₄ P₁ P₂ P₃] (Mᵢ means a message byte and Pᵢ means a parity byte). The deterministic trellis reset replaces the second message byte (M₂) with M₅ and so the genuine parity bytes must be computed by the message word [M₁ M₅ M₃ M₄]. However the RS re-encoder received only the zero-state forcing input (M₅) and synthesizes the message word with [0 M₅ 0 0]. Suppose that the parity bytes computed from the synthesized message word [0 M₅ 0 0] by the RS re-encoder is [P₄ P₅ P₆]. Then since the two RS codewords of [M₁ M₂ M₃ M₄ P₁ P₂ P₃] and [0 M₅ 0 0 P₄ P₅ P₆] are valid codewords, the parity bytes of the message word [M₁ M₂+M₅ M₃ M₄] will be the bitwise XORed value of [P₁ P₂ P₃] and [P₄ Pₛ P₆]. M₂ is initially set to 0, so that the genuine parity bytes of the message word [M₁ M₅ M₃ M₄] are obtained by [P₁+P₄ P₂+P₅ P₃+P₆]. This procedure explains the operation of Parity Replacer in FIG. 107.

The 12-way byte splitter and 12-way byte de-splitter shown in FIG. 107 which are described in ATSC document A/53 Part 2. The 12 trellis encoders have DTR functionality providing the zero-state forcing inputs.

### 7.3 SRS Bytes and Adaptation Field Contents

Table 43 defines the pre-calculated SRS-byte values reconfigured for insertion before the Interleaver. TCM encoders are reset at the first SRS-byte and the adaptation fields shall contain the bytes of this table according to the algorithm here. The shaded values in Table 43, ranging from 0 to 15 (4 MSB bits are zeros) are the first byte to be fed to TCM encoders (the beginning SRS-bytes). The 12 shaded values in Table 45 rows, after the Interleaver, becomes first SRS-byte for related 12-segments. Since there are (12) TCM encoders, there are (12) bytes in shade in each column except the column 1-7. At DTR, the 4 MSB bits of these bytes are discarded and replaced with the zero-state forcing inputs from FIG. 96. Then the state of TCM encoders becomes zero and TCM encoders are ready to receive SRS-bytes to generate 8 level symbols (SRS-symbols) which serve as a training symbol sequence in a receiver. This training sequence (TCM encoder output) is 8 level symbols, +/−{1, 3, 5, 7}. The SRS-byte values are designed to give the SRS-symbols which have a white noise-like flat spectrum and almost zero DC value (the mathematical average of the SRS-symbols is almost zero.)

Depending on the selected SRS-N bytes, only a specific portion of the SRS-byte values in Table 43 is used. For example, in the case of SRS-10 bytes, SRS byte values from 1st to 10th column in Table 43 are used. In the case of SRS-20 bytes, the byte values from 1st to 20th column are used. Since the same SRS-bytes are repeated at every 52 packets (a sliver), the table in Table 43 has values for only 52 packets.

TABLE 403
Pre-calculated SRS Bytes to be stuffed into adaptation fields

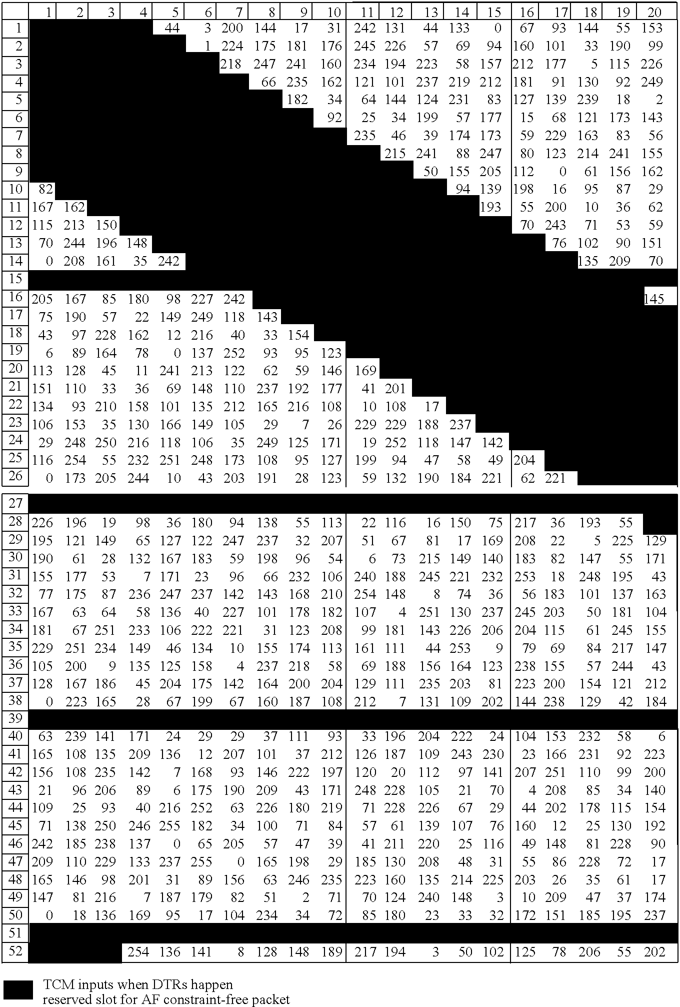

### 7.4 SRS Signaling in the OMP

When SRS Bytes are present, the DF-OMP packet shall be extended as defined in Table 44.

TABLE 44
DF OMP with SRS Packet Syntax

| Syntax | # of Bits | mnemonic |
|---|---|---|
| df_srs_omp_packet( ) { | | |
| transport_packet_header | 32 | bslbf |
| OM_type | 8 | bslbf |
| reserved | 8 | uimsbf |
| srs_bytes | 26 * 8 | uimsbf |
| srs_mode | 8 | uimsbf |
| private | 155 * 8 | uimsbf |

transport_packet_header—as defined and constrained by ATSC A/110A, Section 6.1.

OM_type—as defined in ATSC A/110, Section 6.1 and set to 0x20.

srs_bytes—as defined in Section 7.3.

srs_mode—signals the SRS mode to the modulator and shall be as defined in Table 45

private—defined by application tools. If unused, shall be set to 0x00.

TABLE 45
SRS Mode Values

| srs_mode | Meaning |
|---|---|
| 0x00 | No SRS used |
| 0x01 | SRS-10 bytes |
| 0x02 | SRS-15 bytes |
| 0x03 | SRS-20 bytes |
| 0x04 | SRS-26 bytes |
| 0x05-0xFF | ATSC Reserved |

### 8 Turbo Stream

### 8.1 Introduction

Turbo Stream is designed to be backwardly compatible. Turbo Stream is expected to be used in combination with SRS. The Turbo Stream is tolerant of severe signal distortion, enough to support other broadcasting applications. The robust performance is achieved by additional forward error corrections and Outer Interleaver (Bit-by-Bit interleaving), which offers additional time-diversity.

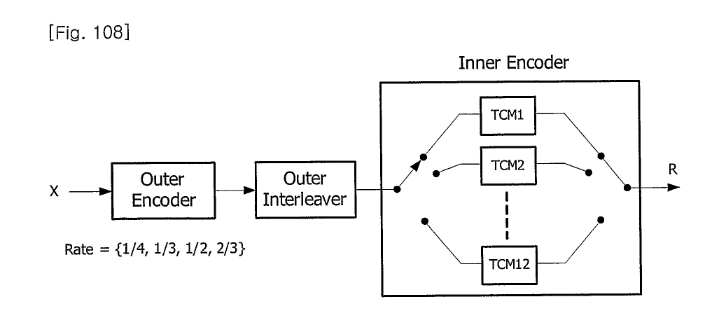

The simplified functional A-VSB Turbo Stream encoding block diagram is shown in FIG. 108. The Turbo Stream data are encoded in the Outer Encoder and bit-wise-interleaved in the Outer Interleaver. The coding rate in the Outer Encoder can be selectable among {1/4, 1/3, 1/2, 2/3} rates. Then, the interleaved data are fed to the Inner Encoder, which has 12-way data splitter for the (12) TCM encoders input, and 12-way data de-splitter at outputs. The (de-)splitter operation is defined in ATSC Standard A/53 part 2.

Since the Outer Encoder is concatenated to the Inner Encoder through the Outer Interleaver, This implements an iteratively decodable serial Turbo Stream encoder. This scheme is unique and ATSC-specific in the sense that the Inner Encoder is already a part of VSB system. The two blocks (the Outer Encoder and the Outer Interleaver) are newly introduced in a Turbo Stream encoder.

### 8.2 Encoder Process

### 8.2.1 System Overview

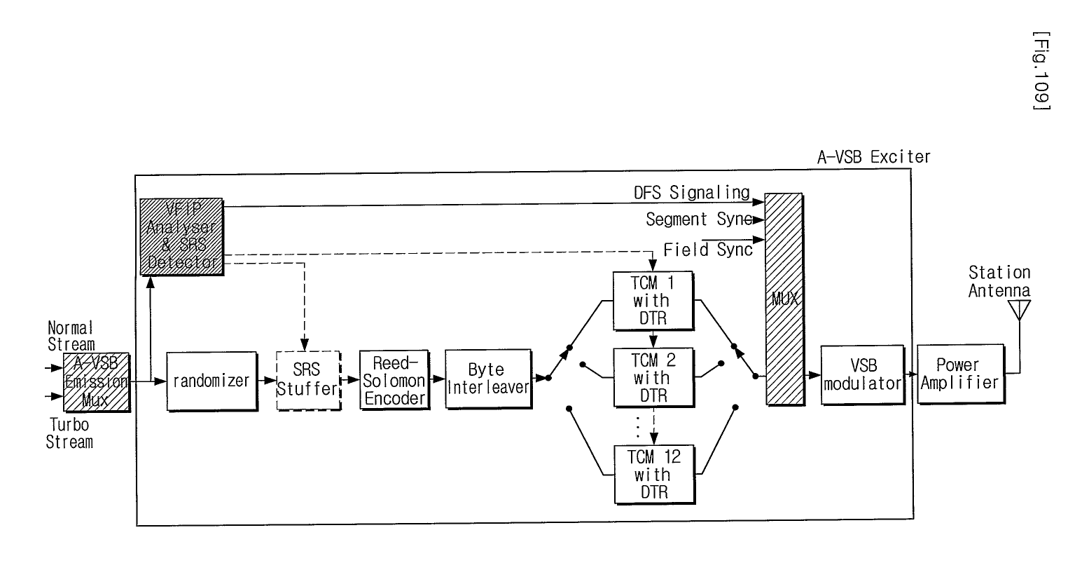

The A-VSB transmitter for Turbo stream is composed of the A-VSB Mux and exciter as shown in FIG. 109. The necessary Turbo coding process is done in the A-VSB Mux and then the coded stream is delivered to the A-VSB exciter.

The A-VSB MUX receives a normal stream and Turbo Stream(s). In The A-VSB Mux, after being pre-processed, each Turbo stream is outer-encoded, outer-interleaved. Then all Turbo streams go through Multi-stream data de-interleaver and they are encapsulated in the adaptation field of the normal stream between ATSC A/53 Randomizer and de-Randomizer.

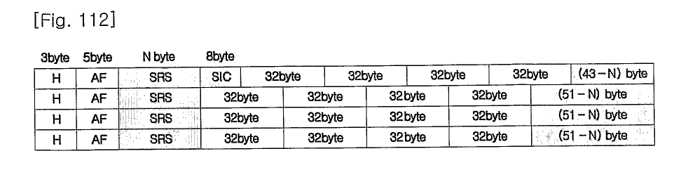

The function of A-VSB exciter for Turbo stream is the same as that of the Normal ATSC A/53 Exciter except DFS signaling. In the A-VSB exciter, an ATSC A/53 Randomizer drops sync bytes of TS packets from a A-VSB Mux and randomizes them. The SRS stuffer in FIG. 112 is active only when SRS is used. The use of SRS with Turbo Stream is considered later. After being encoded in (207, 187) Reed-Solomon code, MPEG data stream are byte-interleaved. The byte interleaved data are then encoded by the TCM encoders.

An A-VSB Multiplexer has to notify the corresponding exciter of the necessary information (DFS signaling). The VFIP (VSB Frame Initialization Packet) includes this information. The information is conveyed to a receiver through the reserved space in the data field sync.

### 8.2.2 A-VSB Multiplexer for Turbo Stream

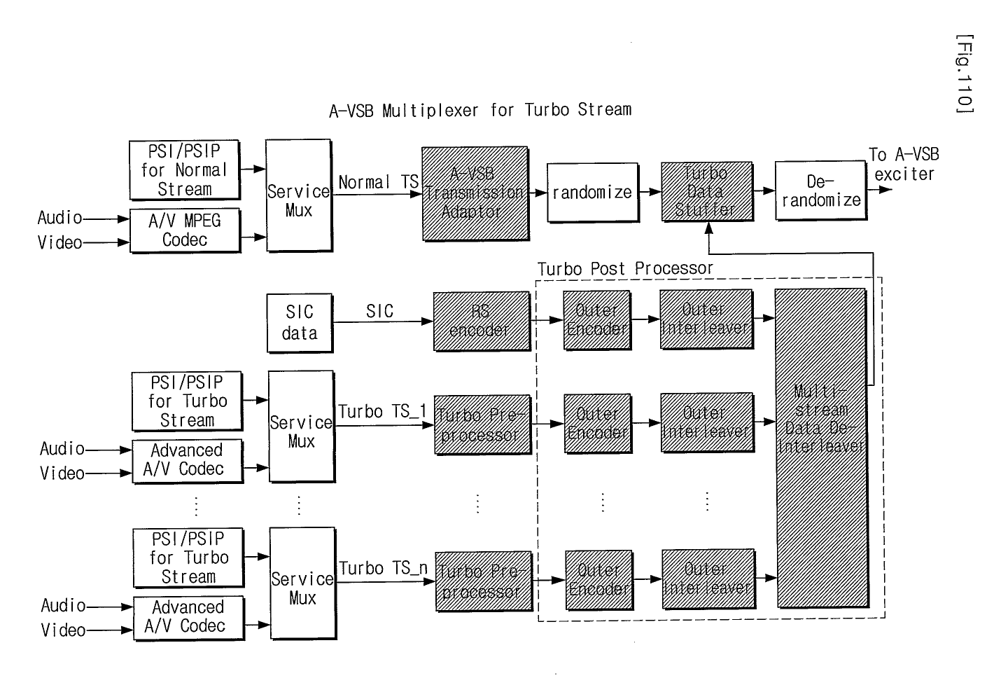

A-VSB Multiplexer for Turbo Stream is shown in FIG. 110. There are new blocks, Transmission Adaptor (TA), Turbo Pre-processor, Outer encoder, Outer interleaver, Multi-stream Data De-interleaver and Turbo-packet Stuffer. An A-VSB Transmission Adaptor recovers all elementary streams from the normal TS and re-packetizes all elementary streams with adaptation fields in every 4th packets, which serves as Turbo stream TS packet placeholders.

In the Turbo pre-processor, the Turbo packets are RS-encoded and Time-interleaved. Then, the time-interleaved data are expanded by the Outer-encoder with a selected code rate and Outer-interleaved.

Multi-stream Data De-interleaver provides a sort of ATSC A/53 Data De-interleaving function for multi-stream. The Turbo data Stuffer simply puts the multi-stream data de-interleaved data into the AF of A/53 Randomized TA output packets. After A/53 De-randomized, the output of Turbo data stuffer results in the output of A-VSB Multiplexer.

### 8.2.2.1 A-VSB Transmission Adaptor (TA)

A Transmission Adaptor (TA) recovers all elementary streams from the normal TS and re-packetizes them with adaptation fields in every 4th packet to be used for placeholders of the SRS, SIC(SIC(System Information Channel) is a kind of Turbo stream to be used for the system information transmission.), and Turbo Stream. The exact behavior of TA depends on the chosen sliver template.

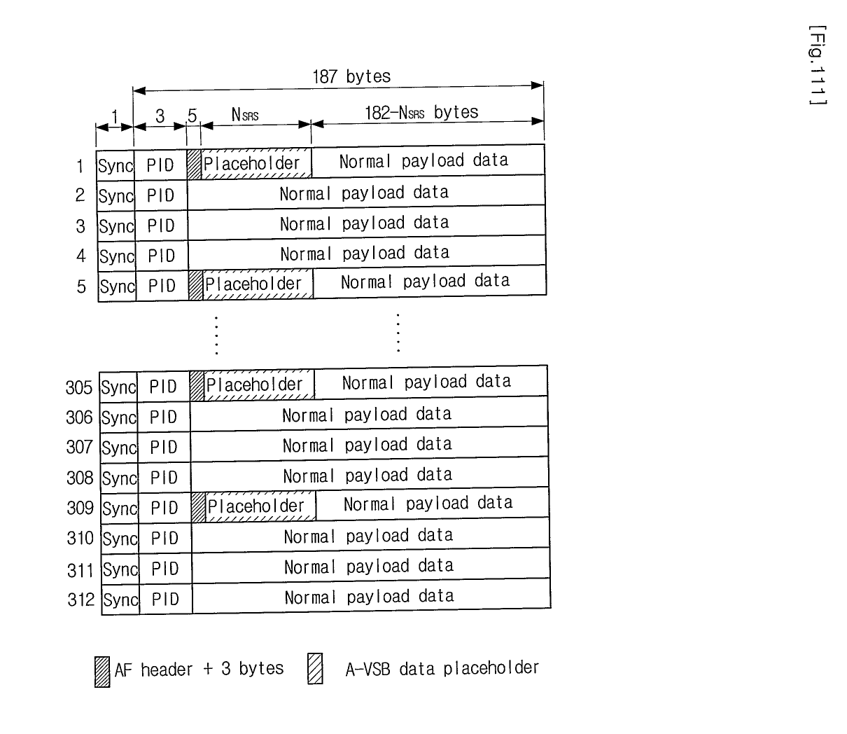

FIG. 111 shows the snapshot of TA output with the adaptation field placed in every 4th packet. Since 1 field contains 312 packets, there are 78 packets which are forced to have AF for A-VSB data placeholders.

### 8.2.2.1.1 Deterministic Sliver Template for Turbo Stream

The reserved unit space in AF for Turbo stream is called Turbo Unit Fragment (TUF) and 32 bytes. There exist 4 or 5 TUF in a normal packet depending on the length of SRS (NSRS). Since the Turbo stream allocation repeats every 4 packets, it suffices to define the Turbo stream allocation within 4 packets. FIG. 112 shows the segmentation of 4 packets with 32 bytes of TUF. Each Turbo stream occupies an integer number {1, 2, 3, 4} of TUF. The number of TUF determines the normal TS overhead for Turbo stream. An outer encoder code rate {1/4, 1/3, 1/2, 2/3} determines the Turbo stream data rate with the number of TUF. When a normal packet is entirely dedicated for A-VSB data (Turbo stream and SRS), a special packet such as a null packet, A/90 data packet, and a packet with a newly defined PID is used to save 2 bytes of AF header and 3 bytes.

Table 46 summarizes the Turbo Stream modes which are defined from the number of Turbo unit fragment (TUF) and a code rate. The length of reserved bytes for Turbo streams (N_{Tstream}) is 32 bytes*TUF and determines the normal TS payload loss. For example, when TUF=4 or equivalently N_{Tstream}=128 bytes, normal TS loss is

$$\frac{128 \cdot 78 \cdot 8 ( bits )}{24.2 ( ms )} = 3.30 Mbps$$

In Table 46 there are many modes defined by an outer encoder code rate and Turbo fragment. The combination of these two parameters is confined to (4) code rates (2/3, 1/2, 1/3, 1/4) and four adaptation field lengths (N_{Tstream}): 32, 64, 96, and 128 bytes. This result in 15 effective Turbo Stream data rates because 128 bytes of a Turbo fragment is excluded in the 2/3 code rate. Including the mode where the Turbo Stream is switched off, there are 16 different modes.

The first byte of the first Turbo Fragment will be synchronized to the first byte in the AF area in a template. The number of encapsulated Turbo TS packets in six slivers (312 normal packets) is the “# of Turbo Packets per 6 slivers” in Table 46.

TABLE 46
Normal TS Loss by Turbo TS Rate and Code Rate (TUF: Turbo Unit Fragment)

| # of Turbo packets | Turbo TS | Normal TS Loss (kbps) | | | | | | | |
|---|---|---|---|---|---|---|---|---|---|
| in 6 slivers (NT) | Rate (kbps) | 2/3 (TUF) | | 1/2 (TUF) | | 1/3 (TUF) | | 1/4 (TUF) | |
| 3 | 186.45 | | | | | | | 825.12 | (1) |
| 4 | 248.60 | | | | | 825.12 | (1) | | |
| 6 | 372.89 | | | 825.12 | (1) | | | 1,650.25 | (2) |
| 8 | 497.19 | 825.12 | (1) | | | 1,650.25 | (2) | | |
| 9 | 559.34 | | | | | | | 2,475.37 | (3) |
| 12 | 745.79 | | | 1,650.25 | (2) | 2,475.37 | (3) | 3,300.50 | (4) |
| 16 | 994.38 | 1,650.25 | (2) | | | 3,300.50 | (4) | | |
| 18 | 1,118.68 | | | 2,475.37 | (3) | | | | |
| 24 | 1,491.57 | 2,475.37 | (3) | 3,300.50 | (4) | | | | |

TABLE 47
Outer Interleaver Block Size by TUF

| # of Turbo Unit | Turbo Fragment | Normal TS | Outer Interleaver |
|---|---|---|---|
| Fragment (TUF) | Bytes per slivers | Loss (Mbps) | Block (L bits) |
| 1 | 2496 | 0.8252 | 3328 |
| 2 | 4992 | 1.6504 | 6656 |
| 3 | 7488 | 2.4757 | 9984 |
| 4 | 9984 | 3.3009 | 13312 |

Similar to the deterministic sliver for SRS, several pieces of information (such as PCR etc.) have to be delivered through the adaptation field along with the Turbo Stream data. In case of SRS, there are 4 fixed packet slots for constraint-free packets. On the contrary, the deterministic sliver for Turbo stream allows more degree of freedom for constraint-free packets location because all packet slots carrying no Turbo stream bytes can be occupied by any form of packets. However, a Turbo stream sliver together with SRS has the same constraints as a SRS sliver.

The parameters for Turbo Stream decoding shall be known to a receiver by the DFS and SIC signaling schemes. They are a TF map, an outer encoder code rate for each Turbo stream.

### 8.2.2.1.2 TF Map

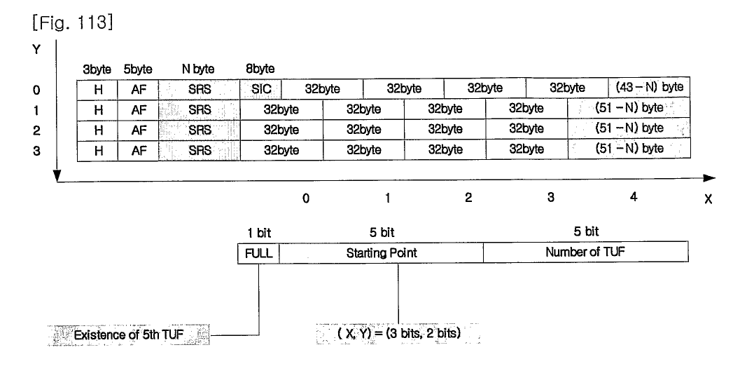

The reserved space in AF for Turbo stream data bytes (Turbo fragment) is represented within 4 packets. The TF map indicates how Turbo stream data are located in the successive 4 packets. This information is delivered through the SIC channel. FIG. 113 shows that 11 bits are used for each Turbo stream TF map. The first flag indicates if the 5th TUF exits or not. The second flag indicates the starting point of the turbo steam with X and Y axis. The last flag indicates the number of TUF reserved for one Turbo stream.

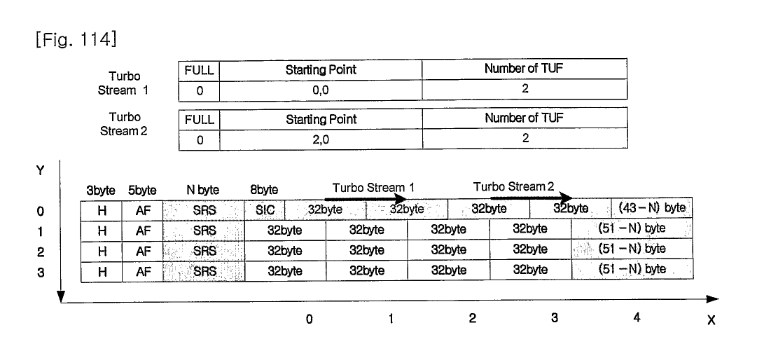

FIG. 114 shows the example of TF map representation.

### 8.2.2.2 Service Multiplexer for Turbo Stream

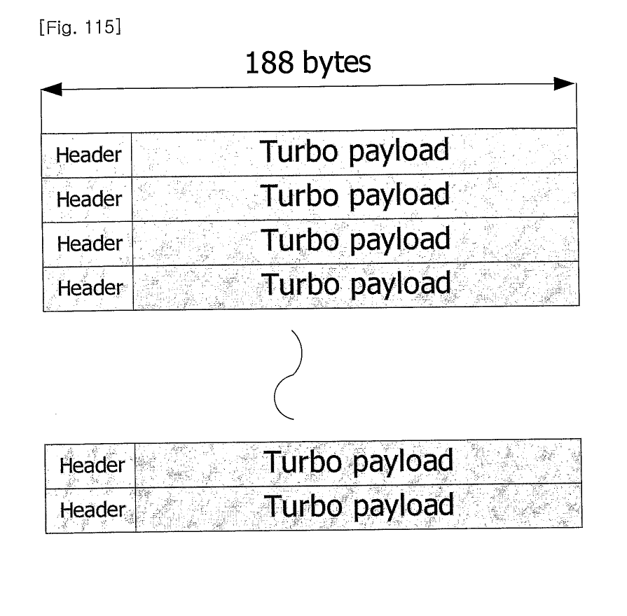

The Service Multiplexer block multiplexes the pure Turbo Stream TS and related PSI/PSIP information. Its behavior is same as the usual ATSC Service Multiplexer. FIG. 115 shows a snapshot of its output stream. A Turbo packet has 188 bytes of length and its detail syntax is defined in ATSC-MCAST.

### 8.2.2.3 Turbo Pre-processor

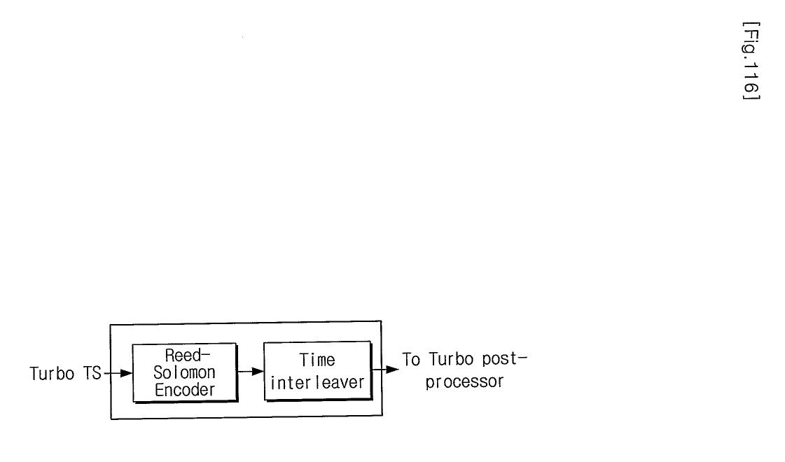

The Turbo Pre-processor block is depicted in FIG. 116. First of all, the Turbo TS packets are encoded by (208, 188) systematic RS encoder and then go thorough time interleaver. The time interleaver spreads the RS encoded packets to improve system performance in the burst noise channel environment.

### 8.2.2.3.1 Reed-Solomon Encoder

The Turbo TS is encoded with the (208, 188) systematic RS code but SIC is also encoded by the (208,188) systematic RS code.

### 8.2.2.3.2 Time Interleaver

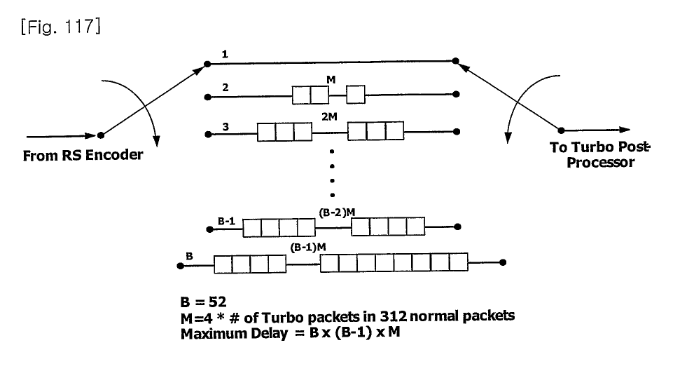

The Time Interleaver in FIG. 117 is a type of the convolutional byte interleaver which is shown in FIG. 117. The number of branches (B) is fixed to 52 while the basic memory size (M) varies with the number of Turbo packets delivered in 312 normal packets, so that the maximum interleaving depth is constant regardless of the number of Turbo packets contained in every 312 normal packets.

The maximum delay is Bx(B-1)xM. Given the number of Turbo packets (NT) per 312 normal packets and the basic memory size (M) equal to NT*4, the maximum delay becomes Bx(B-1)xM=51x208xNT bytes. Since 208xNT bytes are transmitted in each field, the bytes of a Turbo packet is spread over 51 fields in all Turbo stream transmission rates which corresponds to 1.14 second of the interleaving depth.

The Time Interleaver shall be synchronized to the first byte of the data field. The Table 48 shows the basic memory size for the number of packets contained 312 normal packets.

TABLE 48
Basic Memory Size in Time Interleaver

| Data | # of Turbo | Basic | Maximum | Interleaving |
|---|---|---|---|---|
| rate | Packets | Memory size | delay | depth in |
| (Kbps) | per 6 slivers (NT) | (M) | in bytes | field |
| 186.5 | 3 | 12 | 31824 | 51 |
| 248.6 | 4 | 16 | 42432 | 51 |
| 372.9 | 6 | 24 | 63648 | 51 |
| 497.2 | 8 | 32 | 84864 | 51 |
| 559.4 | 9 | 36 | 95472 | 51 |
| 745.9 | 12 | 48 | 127296 | 51 |
| 994.5 | 16 | 64 | 169728 | 51 |
| 1118.0 | 18 | 72 | 190944 | 51 |
| 1491.0 | 24 | 96 | 254592 | 51 |

### 8.2.2.4 Turbo Post-processor

The block diagram of Turbo post-processor is identified in FIG. 110. The one block of the pre-processed Turbo Stream data bytes are collected and then the Outer encoder adds the redundancy bits. Next, the Outer-encoded Turbo Stream data is interleaved in the Outer Interleaver in bit by bit for one block of Turbo post-process. After Multi-stream Data De-interleaved, the resulting data are fed to the Turbo data stuffer which puts the post-processed Turbo Stream data bytes into the AF of A/53 Randomized TA output packets.

### 8.2.2.4.1 Outer Encoder

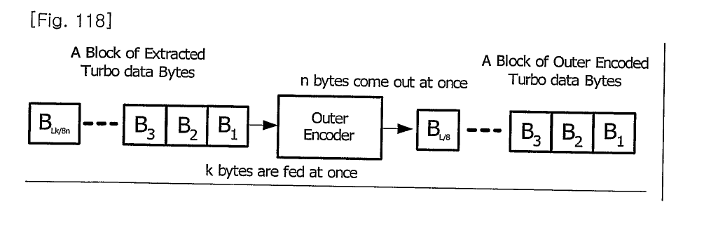

The outer encoder in the Turbo processor is depicted in FIG. 118. It receives a block of Turbo Stream data bytes (L/8 bytes=L bits) and produces a block of outer encoded Turbo Stream data bytes. It operates on a byte basis. So k bytes enter the outer encoder and n bytes come out when the selected code rate is k/n.

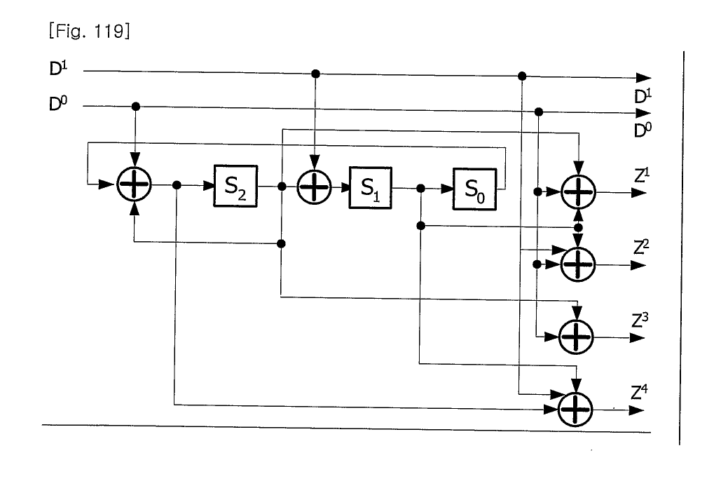

The outer encoder is shown in FIG. 119. It can receive 1 bit (D0) or 2 bit (D1 D0) and produces 3 bits˜6 bits. At the beginning of a new block, the Constituent Encoder state is set to 0. No trellis-terminating bits are appended at the end of a block. Since the block size is relatively long, it doesn't deteriorate the error-correction capability too much. Possible residual errors are corrected by the RS code applied in the Turbo Pre-processor.

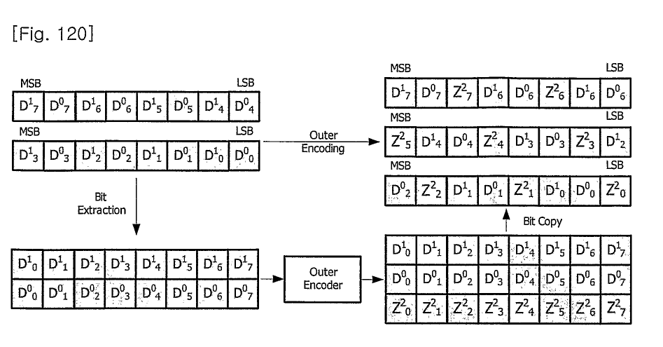

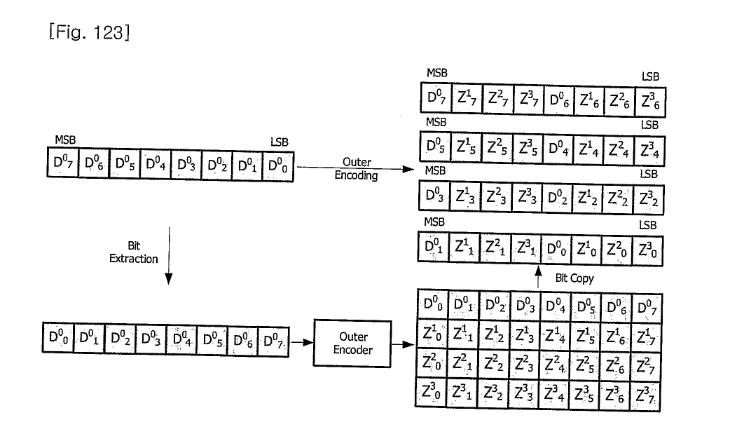

FIG. 120˜FIG. 123 show how to encode. In the 2/3 rate mode, 2 bytes of bits are arranged to be put to the outer encoder and the 3 bytes from (D1, D0, Z2) are organized to produce 3 bytes. In the 1/2 rate mode, 1 byte is put through D0 to the outer encoder and the two bytes obtained from (D0 Z1) are used to produce 2 bytes output. In the 1/3 rate mode, 1 byte is fed to the encoder through D⁰ and 3 bytes are obtained from D⁰, Z¹, Z². In the 1/4 rate mode, 1 byte enter the encoder through D⁰ and 4 bytes are produced from D⁰, Z¹, Z², Z³. The top byte is processed at first and the next top byte is processed as the input to the encoder. Similarly, the top byte precedes the next top byte at the output of the encoder in FIG. 120˜FIG. 123.

### 8.2.2.4.2 Outer Interleaver

The outer bit interleaver scrambles the outer encoder output bits. The bit interleaving rule is defined by a linear congruence expression as follows

Π(i)=(P·i+D_{(i mod 4)})mod L

For a given interleaving length (L), this interleaving rule has 5 parameters (P, D0, D1, D2, D3) which is defined in Table 49.

TABLE 49
Interleaving Rule Parameters (TBD in blanks)

| L | P | D0 | D1 | D2 | D3 |
|---|---|---|---|---|---|
| 13312 | 81 | 0 | 0 | 2916 | 12948 |
| 9984 | | | | | |
| 6656 | 45 | 0 | 0 | 5604 | 5648 |
| 4992 | | | | | |
| 3328 | | | | | |

Each Turbo Stream mode specifies the interleaving length (L) as shown in Table 46. For example, when the interleaving length L=13312 is used, the Outer Interleaver takes Turbo Stream data bytes 13312 bits (L bits) to scramble. Table 10 dictates the parameter set (P, D0, D1, D2, D3)=(81, 0, 0, 2916, 12948). The interleaving rule {Π(0), Π(1), . . . , Π(L−1)} is generated by.

$$\prod ( i ) = \{ \begin{matrix}( 81 \cdot i ) mod 13312 \\ ( 81 \cdot i + 2916 ) mod 13312 \\ ( 81 \cdot i + 12948 ) mod 13312\end{matrix} \begin{matrix}i mod 4 == 0 , 1 \\ i mod 4 == 2 \\ i mod 4 == 3\end{matrix}$$

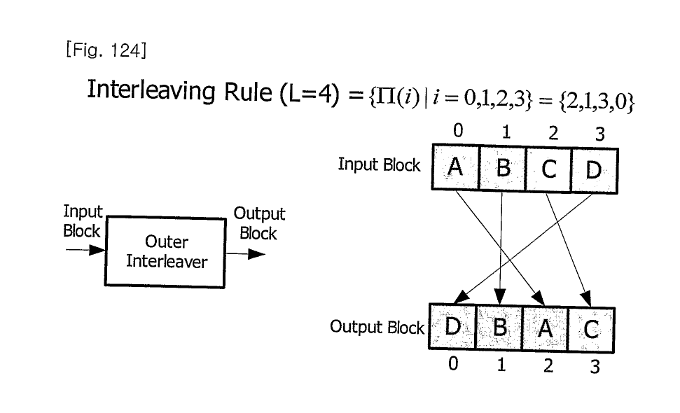

An interleaving rule is interpreted as “The i-th bit in the input block is placed in the Π(i)-the bit in the output block”. FIG. 124 shows an interleaving rule when the length is 4.

### 8.2.2.4.3 Multi-steam Data Deinterleaver

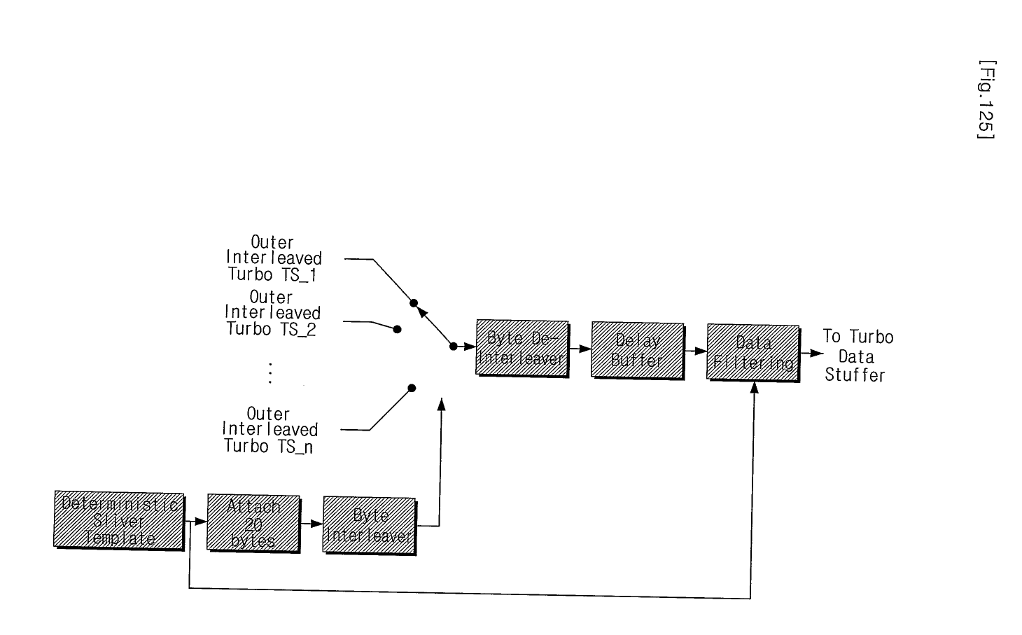

FIG. 125 shows the detail block diagram of Multi-stream data de-interleaver. According to the selected deterministic sliver template, multiplexing information is generated through 20 byte attacher and A/53 byte interleaver. After multiplexing outer interleaved Turbo transport stream bytes, they are A/53 byte de-interleaved. Since ATSC A/53 byte Interleaver has the delay of 52x51x4 and one sliver consists of 207x52 bytes, 52x3=156 bytes of delay buffer is necessary to synchronize to the sliver unit. Finally, the delayed data corresponding to the reserved space in AF of the selected sliver template are output to the next block, Turbo data stuffer.

### 8.2.2.5 Turbo Data Stuffer

The operation of the Turbo data stuffer is to get the output bytes of the Multi Stream Data De-interleaver and put them sequentially in the AF made by TA as is shown in FIG. 111.

8.3 Turbo Stream Combined with SRS Feature

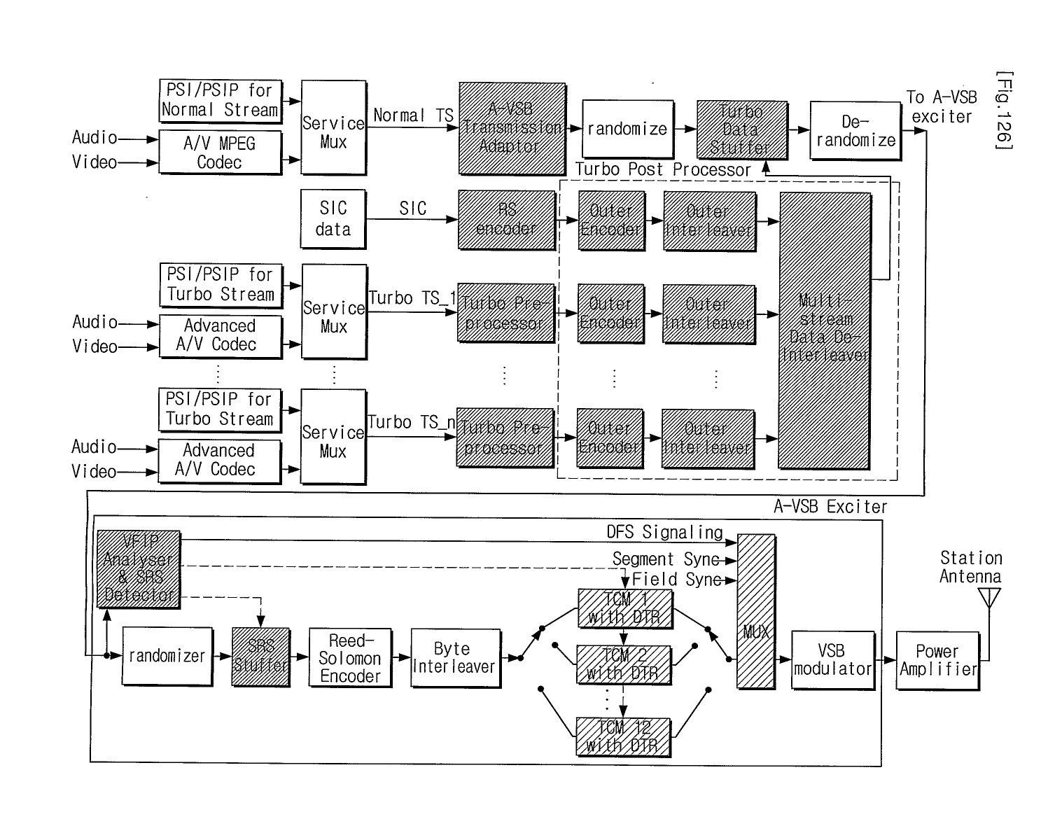

For clarity, the preceding explanation of the construction of the Turbo Stream was as if no SRS was present. However, the use of SRS is recommended. SRS is easily incorporated into Turbo Stream transmission system. FIG. 126 depicts the Turbo Stream in combination with SRS feature. It is just a simple combination of the two sliver templates shown in FIG. 106. The Turbo Fragment always follows the SRS-bytes. The TF map representation also shows the position of SRS in FIG. 112.

### 8.4 Signaling Information

Signaling information that is needed in a receiver must be transmitted. There are two mechanisms for signaling information. One is through Data Field Sync and the other is via SIC (System Information Channel).

Information that is transmitted through Data Field Sync is Tx Version, SRS, and Turbo decoding parameters of Primary Service. The other signaling information will be transmitted through SIC.

Since SIC is a kind of usual Turbo stream, the signaling information in SIC passes through the exciter from an A-VSB Mux. On the other hand, the signaling information in DFS has to be delivered to the exciter from an A-VSB Mux through VFIP packet because a DFS is created while the exciter makes a VSB frame.

8.4.1 DFS Signaling Information through the VFIP

When Turbo Stream bytes are present, the DF-OMP packet shall be extended as defined in Table 50. This is shown with SRS included. If SRS is not included then the srs_mode field is set to zero (private=0x00).

TABLE 50
DF with SRS and Turbo Stream Packet Syntax

| Syntax | # of Bits | mnemonic |
|---|---|---|
| df_srs_turbo_omp_packet( ) { | | |
| transport_packet_header | 32 | bslbf |
| OM_type | 8 | bslbf |
| reserved | 8 | uimsbf |
| srs_bytes | 26 * 8 | uimsbf |
| srs_mode | 8 | uimsbf |
| turbo_stream_mode | 8 | uimsbf |
| private | 154 * 8 | uimsbf |

transport_packet_header—as defined and constrained by ATSC A/110A, Section 6.1.

OM_type—as defined in ATSC A/110, Section 6.1 and set to 0x20.

srs_bytes—as defined in Section 7.3.

srs_mode—signals the SRS mode to the modulator and shall be as defined in Table

turbo_stream_mode—signals the Turbo Stream modes

private—defined by other applications or application tools. If unused, shall be set to 0x00.

### 8.4.2 DFS Signaling Information

### 8.4.2.1 A/53C DFS Signaling (Informative)

The information about the current mode is transmitted on the Reserved (104) symbols of each Data Field Sync. Specifically,

4. Allocate symbols for Mode of each enhancement: 82 symbols

A. 1st˜82 th symbol

5. Enhanced data transmission methods: 10 symbols
A. 83 th˜84 th symbol (2 symbols): reserved
B. 85 th˜92 th symbol (8 symbols): Enhanced data transmission methods
C. On even data fields (negative PN63), the polarities of symbols 83 through 92 shall be inverted from those in the odd data field

6. Pre-code: 12 symbols

Fore more information, refer to “Working Draft Amendment 2 to ATSC Digital Television Standard (A/53C) with Amendment 1 and Corrigendum 1” available at the ATSC website (www.atsc.org).

8.4.2.2 A-VSB DFS Signaling extended from A/53C DFS Signaling

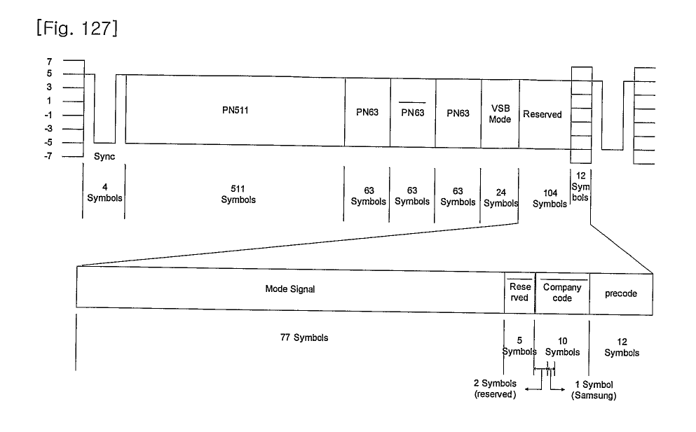

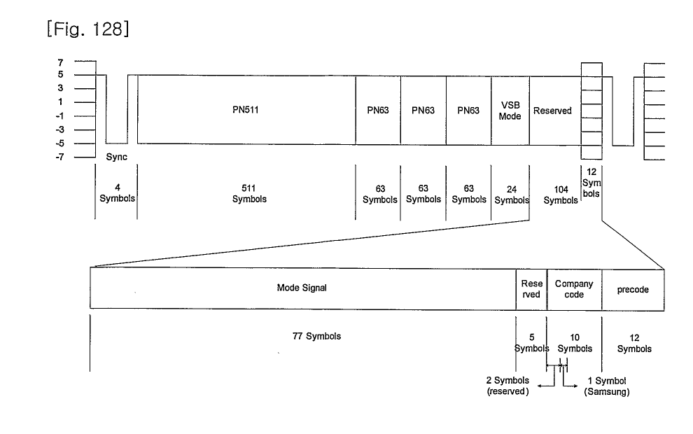

Signaling information is transferred through the reserved area of 2 DFS. 77 Symbols in each DFS amount to 154 Symbols. Signaling information is protected from channel errors by a concatenated code. The DFS structure is depicted in FIG. 127 and FIG. 128.

2) Allocation for A-VSB Mode

The mapping between a Value and an A-VSB mode is as follows.

Tx Version

TABLE 51
Mapping of Tx Mode

| Tx Version | Value |
|---|---|
| Tx Version 1 | 00 |
| Tx Version 2 | 01 |
| Reserved | 10~11 |

Tx Version 1

Information about Tx Mode (2 bits), SRS (3 bits), Primary Service Mode (4 bits) are transmitted at Tx Version 1.

The mapping between a Value and each fragment is as follows.

SRS

TABLE 52
Mapping of SRS

| SRS Bytes per Packet | Value |
|---|---|
| 0 | 000 |
| 10 | 001 |
| 15 | 010 |
| 20 | 011 |
| Reserved | 100~111 |

Mode of Primary Service

TABLE 53
Mapping of Turbo Mode

| | | Turbo | # of | |
|---|---|---|---|---|
| Turbo Data bytes | Turbo | Data Rate | Turbo Packets | |
| In every 4 packets | Code Rate | (kbps) | Per 6 slivers | Value |
| 0 | — | — | | 0000 |
| 32 | ½ | 374 | 6 | 0001 |
| 32 | ⅓ | 249 | 4 | 0010 |
| 32 | ¼ | 186 | 3 | 0011 |
| 64 | ½ | 374 | 12 | 0100 |
| 64 | ⅓ | 249 | 8 | 0101 |
| 64 | ¼ | 186 | 6 | 0110 |
| 96 | ½ | 374 | 18 | 0111 |
| 96 | ⅓ | 249 | 12 | 1000 |
| 96 | ¼ | 186 | 9 | 1001 |
| 128 | ½ | 374 | 24 | 1010 |
| 128 | ⅓ | 249 | 16 | 1011 |
| 128 | ¼ | 186 | 12 | 1100 |

| | |
|---|---|
| Reserved | 1101~1111 |

Tx Mode 2

Information about Tx Mode (2 bits), Training (3 bits), Time Diversity flag (1 bit) are transmitted at Tx Version 2. (FIG. 112)

3) Error Correction Coding for Mode Information

Reception performance of Mode information are ensured using R-S Encoder and Convolutional Encoder.

R-S Encoder

R-S encoded and 2 elements of (6, 4) RS parity are attached to Mode Information.

1/7 rate Tail-biting Convolutional Coding

Encoding R-S encoded bits using 1/7 rate Tail-biting Convolutional Encoder.

Symbol Mapping

The mapping between a Bit and Symbol is as Table 54.

TABLE 54
Symbol Mapping

| Value of Bit | Symbol |
|---|---|
| 0 | −5 |
| 1 | +5 |

Insert mode signaling symbols at Field Sync's Reserved areas

### 8.4.3 System Information Channel (SIC) Signaling

The SIC is identified in. SIC channel information is encoded and delivered through adaptation fields like turbo streams. The reserved area for SIC repeats every 4 packets and occupies 8 bytes in the adaptation fields of the first packet as seen in FIG. 113.

SIC information goes through Turbo pre-processor and then Turbo post processor. In the Turbo pre-processor, SIC information (208,188) RS encoded and then doesn't pass through the time interleaver. 208 bytes of RS encoded bytes are transmitted in one VSB frame that each field has 104 bytes of RS encoded data respectively. When going through post processor, each 104 bytes SIC information block is 1/6-rate outer encoded by repeating twice 1/3 rate outer encoder output. SIC encoding block spans 1 field region whereas Turbo stream data bytes are encoded with 52 segments block size.

The outer coded SIC goes through outer interleaver of 4992 bits length and then is data deinterleaved by Muti-stream data deinterleaver with all turbo data.

Meanwhile, a digital broadcasting receiver according to one embodiment of the present invention may have a constitution, in which implemented in reverse order to the constitution of the transmitting side as explained above. The present invention can thereby receive and process the stream transmitted from the digital broadcasting transmitter as explained above.

The digital broadcasting transmitter may, for example, include a tuner, a demodulator, an equalizer, and a decoding unit. In this case, the decoder may include a trellis decoder, an RS decoding unit, and a deinterleaver. In addition, a range of other constituents, such as a derandomizer and a demultiplexer, having various orders of arrangements, may also be added.

1. (canceled)

2. A digital broadcasting transmitter, comprising:
a deinterleaver which constitutes at least one turbo stream group which is processed to be robust against an error; and
a filtering unit which filters the turbo stream group processed by the deinterleaver in a predetermined format.

3. The digital broadcasting transmitter according to claim 2, further comprising:
an interleaver which generates information to constitute the at least one turbo stream group.

4. The digital broadcasting transmitter according to claim 3, further comprising:
a delay buffer which delays a stream output by the deinterleaver and transmits the delayed stream to the filtering unit.

5. The digital broadcasting transmitter according to claim 4, further comprising:
a stuffer which inserts the filtered turbo stream group into a transport stream.

6. A method for processing a stream in a digital broadcasting transmitter, the method comprising:
performing deinterleaving to constitute at least one turbo stream group which is processed to be robust against an error; and
filtering the turbo stream group in a predetermined format.

7. The method according to claim 6, further comprising:
generating information to constitute the at least one turbo stream group;
delaying the stream processed in the deinterleaving operation; and
inserting the filtered turbo stream group into a transport stream.

8. A digital broadcasting receiver, comprising:
a receiving unit which receives a transport stream comprising a turbo stream group which is processed to be robust against an error;
a demodulator which demodulates the transport stream; and
an equalizer which equalizes the demodulated transport stream,
wherein the transport stream is transmitted from a digital broadcasting transmitter comprising a deinterleaver which constitutes at least one turbo stream group which is processed to be robust against an error, and a filtering unit which filters the turbo stream group processed by the deinterleaver in a predetermined format.

9. A method for processing a stream in a digital broadcasting receiver, the method comprising:
receiving a transport stream comprising a turbo stream group which is processed to be robust against an error;
demodulating the transport stream; and
equalizing the demodulated transport stream,
wherein the transport stream is transmitted from a digital broadcasting transmitter comprising a deinterleaver which constitutes at least one turbo stream group which is processed to be robust against an error, and a filtering unit which filters the turbo stream group processed by the deinterleaver in a predetermined format.
